(19) United States
(12) Patent Application Publication
(10) Pub. No.: US 2009/0185112 A1
(43) Pub. Date: Jul. 23, 2009

(54) POLARIZING PLATE PROTECTIVE FILM AND METHOD FOR MANUFACTURING THE SAME, POLARIZING PLATE AND METHOD FOR MANUFACTURING THE SAME, AND LIQUID CRYSTAL DISPLAY DEVICE

(75) Inventors: Satomi Kawabe, Tokyo (JP); Kazuaki Nakamura, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 12/302,114

(22) PCT Filed: May 21, 2007
(86) PCT No.: PCT/JP2007/060360

§ 371 Date: Nov. 24, 2008

(30) Foreign Application Priority Data
May 31, 2006 (JP) 2006151402

(51) Int. Cl. G02F 1/13363; B29D 11/00; C08B 3/00; C09K 19/54; B32B 37/12; G02B 5/30

(52) U.S. Cl. 349/96; 264/1.6; 536/58; 428/1.31; 156/60; 359/500

(57) ABSTRACT

A protective film for polarizers which comprises a cellulose ester film and which, even when stored for long, suffers no film deformation failures such as ridging and protrusion failures; a process for producing the protective film; a polarizer; a process for producing the polarizer; and a liquid-crystal display employing the polarizer. The process for producing a protective film for polarizers is characterized by forming a melt comprising a cellulose ester and at least one member selected among compounds respectively represented by the following general formulae (1) to (3) into a continuous cellulose ester film by melt casting and winding the film into a roll.

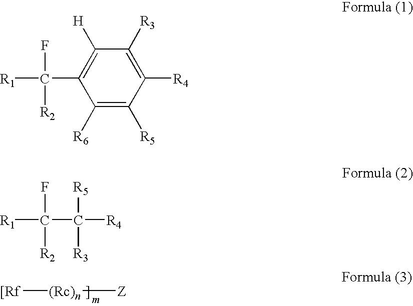

[Chemical formula 1] General formula (1) (In the formula, R₁ to R₅ each represents a substituent.) [Chemical formula 2] General formula (2) (In the formula, R₁ to R₆ each represents a substituent.) [Chemical formula 3] General formula (3) (In the formula, Rf represents perfluoroalkyl, Rc represents alkylene, Z represents a nonionic polar group, n is 0 or 1, and m is an integer of 1-3.)

### TECHNICAL FIELD

The present invention relates to a plasticizer, a cellulose ester optical film, a polarizing plate employing the above cellulose ester film, and a liquid crystal display.

### BACKGROUND

Over recent years, development is proceeding toward reduction of thickness and weight and the realization of larger image screens, as well as formation of highly detailed images for laptop computers. Accordingly, reduction of thickness, the increase of width, and the realization of higher quality have also been increasingly demanded for polarizing plate protective films. Generally, cellulose ester films are widely used for the polarizing plate protective films. Cellulose films are commonly wound around a core as film master rolls, which are stored and transported in this form.

Heretofore, these cellulose ester films have been produced mainly employing a solution-casting method. The solution-casting method, as descried herein, refers to a film forming method in which a solution prepared by dissolving cellulose ester in solvents is cast to form film and solvents are evaporated and dried to produce film. The film which is cast employing the solution-casting method exhibits high flatness, whereby by employing the resulting film, it is possible to produce uniform and high image quality liquid crystal displays.

However, an inherent problem of the solution-casting method is the necessity of a large volume of organic solvents followed by a high environment load. The cellulose ester film is cast employing halogen based solvents which result in a high environment load, due to its solubility characteristics. Consequently, it has particularly demanded to reduce the amount of used solvents, whereby it has been difficult to increase the production of cellulose ester film employing the solution-casting method.

Accordingly, in recent years, experiments have been conducted in which cellulose ester is subjected to melt-casting for the use of silver salt photography and as a polarizer protective film. However, cellulose ester is a polymer which exhibits a very high viscosity when melted and also exhibits a very high glass transition point. As a result, when cellulose ester is melted, extruded from a die and cast onto a cooling drum or belt, it is difficult to achieve leveling, and after extrusion, whereby a major problem has been that optical property and mechanical property of the resulting film is inferior to that of the a solution-casting film (For example, Patent Document 1 and 2).

Methods have been proposed in which a cellulose ester film is produced employing the melt-casting film formation method (for example, refer to Patent Documents 3 and 4). Patent Document 3 has proposed a method in which molten resins are pressed in a circular arc state between a cooling roll, whose temperature is uniformly maintained across the width, and an endless belt to cool down the resins. Patent Document 4 has proposed a method in which molten resins are pressed between two cooling drums to cool down the resins. However, since the heat melted cellulose resins exhibit high viscosity, a film produced by a melt-casting film formation method is inferior in flatness to a film produced by a solution-casting film formation method, and specifically the aforesaid film has shortcomings such that the film tends to exhibit the die line and unevenness in thickness.

Therefore when the film produced by a melt-casting film formation method is stored in a form of film web material on the winding core for an extended period of time, the film web material tends to result in a failure, such as a horseback failure, the deformation failure of film web material near the surface of the winding core caused by transferring the irregularity and wrinkle at the start of winding.

The term “horseback failure” means that a film web material roll is deformed in U-shape like a horseback and exhibits a belt-shaped protrusion near the central part thereof in a pitch of about 2 to 3 cm. The failure leaves a deformation on the film causing a problem that the film surface is observed to be deformed when the film is finished as a polarizing plate, Heretofore, the occurrence of the horseback failure has been reduced by reducing a dynamic friction coefficient between bases or by controlling the height in knurling (embossing) on both edges of the film.

It is known that the film deformation failure caused by transferring the irregularity of the surface of the winding core or the film.

It is also known that the horseback failure is caused by the winding core being deflected by the film load, and it is disclosed that the method for reducing the occurrence of the horseback failure (for example refer to Patent Document 5).

However, a much wider cellulose ester film corresponding to the recent liquid crystal TV has been required, and the above-described technologies are found to be insufficient to meet the requirement. Therefore, further methods have been desired.

Patent Document 1: Japanese Patent Application Publication (hereinafter also referred to as JP-A) No. 6-501040

### Patent Document 2: JP-A No. 2000-352620

### Patent Document 3: JP-A No. 10-10321

### Patent Document 4: JP-A No. 2002-212312

### Patent Document 5: JP-A No. 2002-3083

### DISCLOSURE OF THE INVENTION

### Problems to be Solved by the Present Invention

It is an object to provide a polarizing plate protective film by employing the above cellulose ester film wherein deformation failures of the film web such as a horseback failure or a protrusion failure does not occur despite long-term storage and a method for manufacturing the same, a polarizing plate and a method for manufacturing the same, and a liquid crystal display device by employing the above polarizing plate.

### Means to Solve the Problems

The object of the present invention was achieved via the following constitutions:

1. A method for manufacturing a polarizing plate protective film wherein a cellulose ester and a melt containing at least one type of compound selected from those represented by following Formulas (1)-(3) are used, and a long cellulose ester film is formed via a melt casting method and wound in the form of a roll.

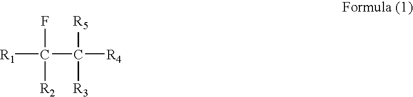

wherein R₁-R₅ represent substituents.

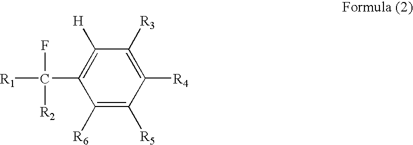

wherein R₁-R₆ represent substituents.

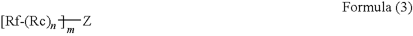

wherein Rf represents a perfluoroalkyl group; Rc represents an alkylene group; Z represents a nonionic polar group; n represents 0 or 1; and m represents an integer of 1-3.

2. The method for manufacturing a polarizing plate protective film, described in item 1, wherein at least one of the substituents represented by R₃-R₅ in Formula (1) is a hydrogen atom.

3. The method for manufacturing a polarizing plate protective film, described in item 1 or 2, wherein at least one of the substituents represented by R₁-R₅ in Formula (1) and the substituents represented by R₃-R₆ in Formula (2) is a hydroxy group or a substituent substituted by a hydroxy group.

4. The method for manufacturing a polarizing plate protective film, described in any one of items 1-3, wherein a cellulose ester film extruded from a casting die during melt casting film formation is pressure-sandwiched between an elastically deformable touch roll and a cooling roll, and wound in the form of a roll.

5. A polarizing plate protective film manufactured via the method for manufacturing a polarizing plate protective film described in any one of items 1-4.

6. A polarizing plate wherein the polarizing plate protective film described in item 5 is provided on at least one side of a polarizer.

7. A method for manufacturing a polarizing plate wherein the polarizing plate protective film described in item 5 is unwound from a wound state and bonded to a polarizer.

8. A liquid crystal display device wherein the polarizing plate described in item 6 or a polarizing plate manufactured via the method for manufacturing a polarizing plate described in item 7 is applied to at least one side of a liquid crystal cell.

### EFFECTS OF THE INVENTION

According to the present invention, there can be provided a polarizing plate protective film employing a cellulose ester film free of deformation defects of a master roll film such as the so-called horseback defect or convex defect even during long-term storage and a manufacturing method thereof; a polarizing plate and a manufacturing method thereof; and a liquid crystal display device employing the polarizing plate.

### BRIEF DESCRIPTION OF THE DRAWINGS

FIG. 1 is a schematic flow sheet representing one embodiment of an apparatus for embodying the manufacturing method of the cellulose ester film as an embodiment of the present invention;

FIG. 2 is an enlarged flow sheet representing the major portion of the manufacturing equipment;

FIG. 3 (a) is an external view of the major portions of the flow casting die;

FIG. 3 (b) is a cross sectional view of the major portions of the flow casting die;

FIG. 4 is a cross sectional view of the first embodiment of the rotary pinch member;

FIG. 5 is a cross sectional view representing the plane surface perpendicular to the rotary axis in the second embodiment of the rotary pinch member;

FIG. 6 is a cross sectional view representing the plane surface including the rotary axis in the second embodiment of the rotary pinch member; and

FIG. 7 is an exploded perspective view schematically representing the structure of the liquid crystal display.

FIG. 8 is a schematic drawing showing the state of storing the web material of the cellulose ester film

### DESCRIPTION OF SYMBOLS

4. flow casting die
5. rotary support member (first cooling roll)
6. rotary pinch member (touch roll)
110. roll shaft body
117. support plate
118. mount
120. web material of cellulose ester film

### BEST MODE TO CARRY OUT THE INVENTION

In view of the above problems, the present inventors conducted diligent investigations, and found that using a cellulose ester and a melt containing at least one type of compound selected from those represented by Formulas (1)-(3), a method for manufacturing a polarizing plate protective film free of deformation defects of a master roll film such as the horseback defect or convex defect even during long-term storage was realized via a method for manufacturing a polarizing plate protective film wherein a long cellulose ester film is formed via a melt casting method and wound in the form of a roll. Thus, the present invention was completed.

The best mode to carry out the present invention will now be detailed. However, the present invention is not limited thereto.

In the method for manufacturing a polarizing plate protective film of the present invention, a compound having a partial structure exhibiting hydrogen bonding capability to a cellulose ester via a fluorine atom is preferably contained.

In the present invention, the compound having a partial structure exhibiting hydrogen bonding capability via a fluorine atom is a compound having a partial structure wherein as described below, the compound having a partial structure exhibiting hydrogen bonding capability of the present invention and a cellulose ester each approach via a hydrogen bond formed between an electrically negative atom (a fluorine atom in the present invention) and a hydrogen atom in the cellulose ester, and further a hydrogen bond is formed between a hydrogen atom adjacent to the fluorine atom and an electrically negative atom (an oxygen atom in the present invention) in the cellulose ester, resulting in arrangement of the molecules.

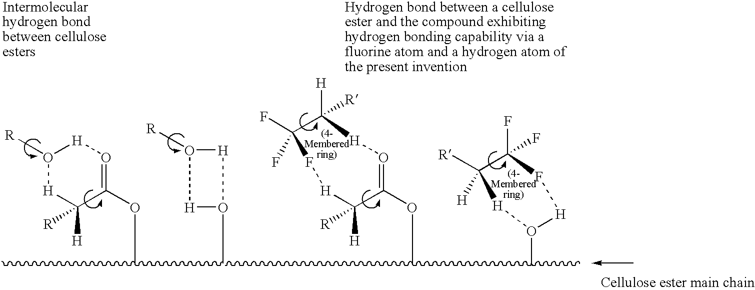

Such a compound is one capable of forming a hydrogen bond to cellulose more strongly than an intermolecular hydrogen bond between cellulose esters. In a melt casting method carried out in the present invention, the melt temperature of a composition can be decreased below the glass transition point of a cellulose ester on its own by adding a hydrogen-bondable compound. Optionally, the viscosity of the composition containing a hydrogen-bondable compound can be decreased below that of the cellulose ester at the same temperature.

It is preferable that with regard to bonding positions of a fluorine atom and a hydrogen atom involved in hydrogen bonds to a cellulose ester, the number of atoms present between these 2 atoms be relatively small, and also the member number of a ring formed with a fluorine atom and a hydrogen atom be relatively small. And further, the carbon-carbon free rotation number is preferably small since a hydrogen bond to a cellulose ester group is readily formed sterically. Specifically, as shown below, preferable is a compound featuring a structure wherein a ring having a ring member number of 4-6 is formed by a fluorine atom and a hydrogen atom.

Example of a compound forming a 5-membered ring between a fluorine atom and a hydrogen atom

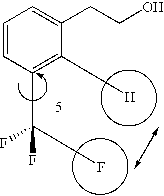

Example of a compound forming a 4-membered ring between a fluorine atom and a hydrogen atom

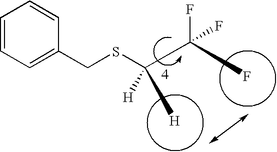

Example of a compound forming a 6-membered ring between a fluorine atom and a hydrogen atom

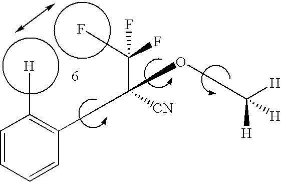

Example of a compound forming a 5-membered and a 6-membered ring between fluorine atoms and hydrogen atoms

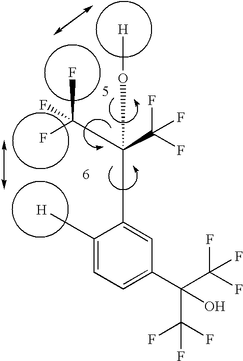

In a method for manufacturing a polarizing plate protective film composed of a long roll cellulose ester film, the method for manufacturing a polarizing plate protective film of the present invention is characterized by the cellulose ester film containing any of the compounds represented by above Formulas (1) (3).

### <<Compounds Represented by Formula (1)>>

In Formula (1), R₁-R₅ represent substituents.

The substituents include a hydrogen atom, a halogen atom (e.g., a fluorine atom and a chlorine atom), an alkyl group (e.g., a methyl group, an ethyl group, an isopropyl group, a hydroxyethyl group, a methoxymethyl group, a trifluoromethyl group, and a t-butyl group), a cycloalkyl group (e.g., a cyclopentyl group and a cyclohexyl group), an aralkyl group (e.g., a benzyl group and a 2-phenetyl group), an aryl group (e.g., a phenyl group, a naphthyl group, a p tolyl group, and a p-chlorophenyl group), an alkoxy group (e.g., a methoxy group, an ethoxy group, an isopropoxy group, and a butoxy group), an aryloxy group (e.g., a phenoxy group) a cyano group, an acylamino group (e.g. r an acetylamino group, a propionylamino group), an alkylthio group (e.g., a methylthio group, an ethylthio group, and a butylthio group), an arylthio group (e.g., a phenylthio group), a sulfonylamino group (e.g., a methanesulfonylamino group and a benzenesulfonylamino group), a ureido group (e.g., a 3-methylureido group, a 3,3-dimethylureido group, and a 1,3-dimethylureido group), a sulfamoylamino group (e.g., a dimethylsulfamoylamino group), a carbamoyl group (e.g., a methylcarbamoyl group, an ethylcarbamoyl group, and a dimethylcarbamoyl group), a sulfamoyl group (e.g., an ethylsulfamoyl group and a dimethylsulfamoyl group), an alkoxycarbonyl group (e.g., a methoxycarbonyl group and an ethoxycarbonyl group), an aryloxycarbonyl group (e.g., a phenoxycarbonyl group), a sulfonyl group (e.g., a methanesulfonyl group, a butanesulfonyl group, and a phenylsulfonyl group), an acyl group (e.g. an acetyl group, a propanoyl group, and a butyroyl group), an amino group (e.g., a methylamino group, an ethylamino group, and a dimethylamino group), a cyano group, a hydroxy group, a nitro group, a nitroso group, an amine oxide group (e.g., a pyridine-oxide group), an imide group (e.g., a phthalimide group), a disulfide group (e.g., a benzenedisulfide group and benzothiazolyl-2-disulfide group), a carboxyl group, a sulfo group, a heterocyclic group (e.g., a pyrrole group, a pyrrolidyl group, a pyrazolyl group, an imidazolyl group, a pyridyl group, a benzimidazolyl group, a benzothiazolyl group, and a benzoxazolyl group).

At least one of R₃-R₅ represents a substituent containing a hydrogen atom. Such a substituent may further be substituted.

At least one of R₃-R₅ is preferably a hydrogen atom. At least one of the substituents represented by R₁-R₅ is more preferably a hydroxy group or a substituent substituted by a hydroxy group due to an enhanced effect to decrease melt viscosity.

### <<Compounds Represented by Formula (2)>>

In above Formula (2), R₁-R₆ represent substituents.

The substituents include a hydrogen atom, a halogen atom (e.g., a fluorine atom and a chlorine atom), an alkyl group (e.g., a methyl group, an ethyl group, an isopropyl group, a hydroxyethyl group, a methoxymethyl group, a trifluoromethyl group, and a t-butyl group), a cycloalkyl group (e.g., a cyclopentyl group and a cyclohexyl group), an aralkyl group (e.g., a benzyl group and a 2-phenetyl group), an aryl group (e.g., a phenyl group, a naphthyl group, a p-tolyl group, and a p-chlorophenyl group), an alkoxy group (e.g., a methoxy group, an ethoxy group, an isopropoxy group, and a butoxy group), an aryloxy group (e.g., a phenoxy group), a cyano group, an acylamino group (e.g., an acetylamino group, a propionylamino group), an alkylthio group (e.g., a methylthio group, an ethylthio group, and a butylthio group), an arylthio group (e.g., a phenylthio group), a sulfonylamino group (e.g., a methanesulfonylamino group and a benzenesulfonylamino group), a ureido group (e.g., a 3-methylureido group, a 3,3-dimethylureido group, and a 1,3-dimethylureido group), a sulfamoylamino group (e.g., a dimethylsulfamoylamino group), a carbamoyl group (e.g., a methylcarbamoyl group, an ethylcarbamoyl group, and a dimethylcarbamoyl group), a sulfamoyl group (e.g., an ethylsulfamoyl group and a dimethylsulfamoyl group), an alkoxycarbonyl group (e.g., a methoxycarbonyl group and an ethoxycarbonyl group), an aryloxycarbonyl group (e.g., a phenoxycarbonyl group), a sulfonyl group (e.g., a methanesulfonyl group, a butanesulfonyl group, and a phenylsulfonyl group), an acyl group (e.g., an acetyl group, a propanoyl group, and a butyroyl group), an amino group (e.g., a methylamino group, an ethylamino group, and a dimethylamino group), a cyano group, a hydroxy group, a nitro group, a nitroso group, an amine oxide group (e.g., a pyridine-oxide group), an imide group (e.g., a phthalimide group), a disulfide group (e.g., a benzenedisulfide group and benzothiazolyl-2-disulfide group), a carboxyl group, a sulfo group, a heterocyclic group (e.g., a pyrrole group, a pyrrolidyl group, a pyrazolyl group, an imidazolyl group, a pyridyl group, a benzimidazolyl group, a benzothiazolyl group, and a benzoxazolyl group).

These substituents may further be substituted. R₁ and R₂, as well as R₃-R₆ each may join to form a ring.

At least one of the substituents represented by R₃—R₆ is preferably a hydroxy group or a substituent substituted by a hydroxy group due to an enhanced effect to decrease melt viscosity.

### <<Compounds Represented by Formula (3)>>

In above Formula (3), Rf represents a perfluoroalkyl group; Rc represents an alkylene group; Z represents a nonionic polar group; n represents 0 or 1; and m represents an integer of 1-3.

Rf preferably represents a perfluoroalkyl group having a carbon number of 3-20. Examples thereof include C₃F₇— group, C₄F₉— group, C₆F₁₃— group, C₈F₁₇— group, C₁₂F₂₅— group, and C₁₆F₃₃— group) In Formula (3), Rf may be either a mixture of plural compounds featuring perfluoroalkyl groups of different chain lengths or a single compound featuring a perfluoroalkyl group. When Rf is a mixture of plural compounds featuring perfluoroalkyl groups of different chain lengths, the average value of the chain lengths of the perfluoroalkyl groups is preferably 4-10, specifically preferably 4-9 in terms of carbon number.

In Formula (3), Rc represents an alkylene group. The carbon number of the alkylene group is commonly at least 1, preferably at least 2; however, being preferably at most 20. Specifically, there can be listed a methylene group, an ethylene group, a 1,2-propylene group, a 1,3-propylene group, a 1,2-butylene group, a 1,4-butylene group, a 1,6-hexylene group, and a 1,2-octylene group.

The symbol n represents an integer of 0 or 1, preferably 1; and m represents an integer of 1-3, but m is preferably 1.

Z represents a nonionic group required to provide surface activity. When this group is contained, a manner to join Rc is not specifically limited.

Such a nonionic group required to provide surface activity includes a polyoxyalkylene group and a polyhydric alcohol group, preferably a polyoxyalkylene group such as polyethylene glycol or polypropylene glycol. However, any terminal of these groups may be a group other than a hydrogen atom, being, for example, an alkyl group.

In Formula (3), Rf is preferably a perfluoroalkyl group having a carbon number of 4-16, more preferably a perfluoroalkyl group having a carbon number of 6-16. Rc is preferably an unsubstituted alkylene group having a carbon number of 2-16, more preferably an unsubstituted alkylene group having a carbon number of 2-8, and specifically preferably an ethylene group. In Z, any bond between the Rc group and a group required to provide surface activity may be formed, including a direct bond, as well as, for example, a bond via a alkylene chain or an arylene, and these groups may have a substituent. Further, these groups may contain, in the main chain or side chains thereof, an oxy group, a thio group, a sulfonyl group, a sulfoxide group, a sulfoneamide group, an amide group, an amino group, or a carbonyl group.

It is known that fluorine-based surfactants are used in melt casting film formation. These are used to improve peelability from a casting die, and to decrease surface tension, and also as coating agents in organic solvents or for antistatic purposes. However, the present invention is not suggested thereby.

Specific examples of the compounds represented by Formulas (1)-(3) will now be listed that by no means limit the scope of the present invention.

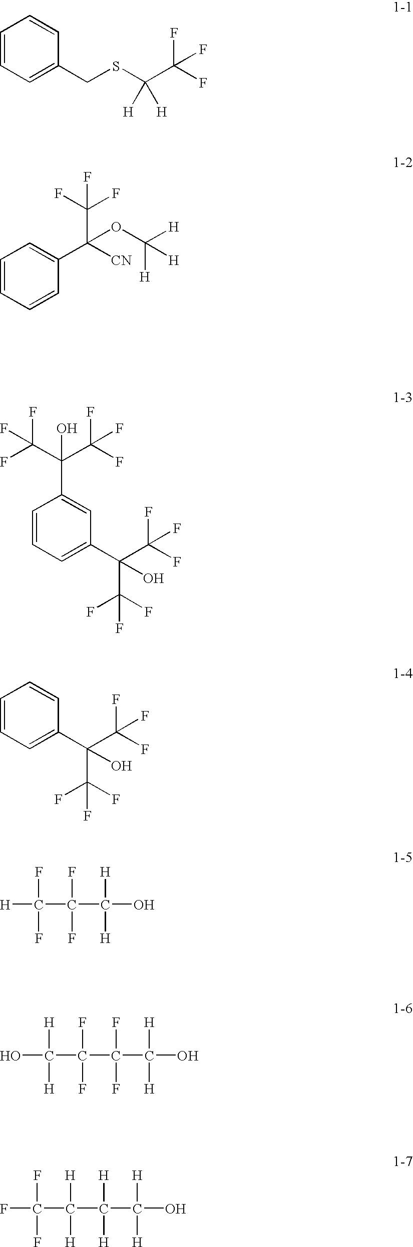

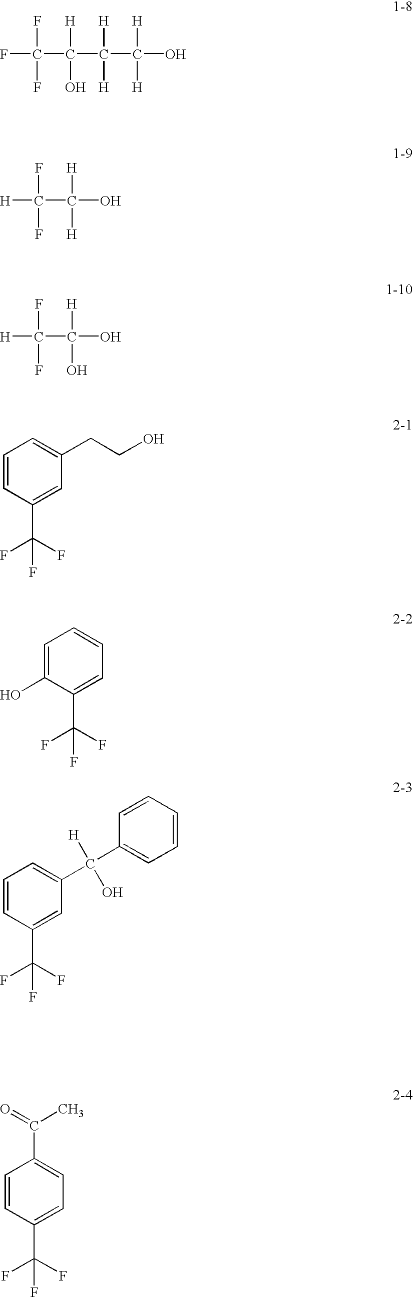

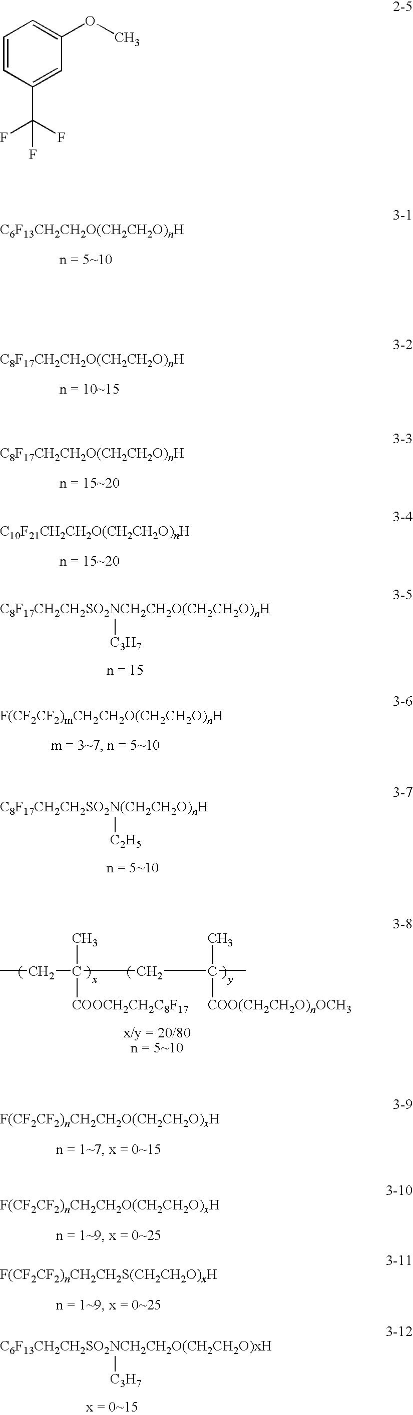

The added amount of any of the compounds represented by Formulas (1)-(3) is preferably 0.1-10% by mass, more preferably 0.2-5% by mass, and still more preferably 0.5-2% by mass.

The compounds represented by Formulas (1)-(3) may be used individually or in combinations of at least 2 types

### (Cellulose Ester)

The cellulose ester employed in the present invention will now be detailed.

The cellulose ester film of the present invention is produced employing a melt-casting method. The melt-casting method is a method of producing a film by heating and melting a cellulose ester to become fluid and by casting fluid cellulose ester (melt) onto the support. The melt-casting method makes it possible to significantly decrease the used amount of organic solvents during film production, whereby it is possible to produce films which are friendlier to the environment compared to the conventional solution-casting method which employs a large amount of organic solvents. Therefore it is preferable to produce the cellulose ester film by employing a melt-casting method.

“Melt-casting”, as described in the present invention, refers to a method in which without substantially using solvents, cellulose ester is heat-melted to the temperature to result in fluidity and casting is performed employing the resulting melt, via, for example, a method in which fluid cellulose ester is extruded from a die to result in casting. Solvents may be employed during some of the processes to prepare melted cellulose ester, but in the melt-casting process which results in film molding, the molding is performed with substantially no solvents.

Cellulose esters which constitute optical film are not particularly limited as long as they enable melt-casting, and for example, aromatic carboxylic acid esters are employed. However, in view of characteristics of film capable of achieving specified optical characteristics, it is preferable to use lower fatty acid esters of cellulose. The lower fatty acids in the lower fatty acid esters of cellulose in the present invention refer to fatty acids having at most 5 carbon atoms and examples of preferred ones include lower fatty acid esters such as cellulose acetate, cellulose propionate, cellulose butyrate, or cellulose pivarate. Cellulose esters substituted with fatty acids having at least 6 carbon atoms exhibit desired melt-casting properties. However, the resulting film exhibits insufficient dynamic characteristics, and it is difficult to use them as an optical film. In order to cope with both dynamic characteristics and melt-casting properties, employed may be mixed fatty acid esters such as cellulose acetate propionate or cellulose acetate propionate. Incidentally, the decomposition temperature of triacetyl cellulose, which is the cellulose ester commonly employed in the solution-casting, is higher than its melting temperature, whereby it is not possible to apply it to melt-casting.

In the present invention, the cellulose ester constituting a cellulose ester film is preferably a cellulose ester having an aliphatic acyl group having a number of carbon of 2 or more, and the acyl group total carbon number of the cellulose acylate is from 6.2 to 7.5. The acyl group total carbon number of the cellulose ester is preferably from 6.5 to 7.2, and more preferably from 6.7 to 7.1. The term “acyl group total carbon number” means that the sum of the products of the substitution degree of each acyl group substituted into a glucose unit in the cellulose ester and the number of carbons. Further, the carbon number of an aliphatic acyl group is, from views of productivity and a production cost of the cellulose synthesis, preferably from 2 to 6. Positions not substituted with an acyl group usually exist as a hydroxyl group. These can be synthesized via commonly known methods.

Examples of the acyl group include an acetyl group, a propionyl group, a butyryl group, a pentanate group, and hexanate group, and examples of cellulose ester include a cellulose propionate, a cellulose butylate, and a cellulose pentanate. Moreover, as long as the above-mentioned side chain carbon number is satisfied, a mixed fatty acid ester such as a cellulose acetate propionate, a cellulose acetate butylate, and a cellulose acetate pentanate may be employed. Of these, in particular, a cellulose acetate propionate and a cellulose acetate butylate are preferable. However a triacetyl cellulose and a diacetyl cellulose which is generally used as a cellulose ester of a solution casting method is not included, because it does not satisfy the condition of carbon number of the side chain.

Generally there exist a trade-off relation between the mechanical physical and saponification properties of the cellulose ester film and the melt film formation properties of the cellulose ester. For example, in the cellulose acetate propionate, an increase in the total number of carbon atoms contained in the acyl group improves the melt film formation properties, but decreases the mechanical properties, and thus, compatibility is difficult to achieve. However, inventors found that, in the present invention, compatibility among the film mechanical physical properties, saponification properties and melt film formation properties can be ensured by setting an acyl group total carbon number to be from 6.5 to 7.2. Although the details of the mechanism are not very clear, it is assumed that the number of carbon atoms contained in the acyl group has a differing effect on each of the film mechanical physical properties, saponification properties, and melt film formation properties. More specifically, a longer-chained acyl group such as a propionyl group, and a butyryl group, rather than the acetyl group, provides a higher degree of hydrophobicity, provided that the total substitution degree of the acyl group of the above groups are the same, to result in improved melt film formation properties. Thus, it is assumed that, in a case where the same level of melt film formation properties are achieved, the substitution degree of the long-chained acyl group such as a propionyl group, and a butyryl group is lowered than that of the acetyl group, and the total substitution degree is also lowered, whereby reduction in the mechanical physical properties and saponification properties is suppressed.

The ratio of weight average molecular weight Mw/number average molecular weight Mn, of cellulose esters employed in the present invention is commonly 1.0-5.5, is preferably 1.4-5.0, but is most preferably 2.0-3.0. Further, Mw of the used cellulose esters is commonly 100,000-500,000 but is preferably 150,000-300,000.

It is possible to determine the average molecular weight and molecular weight distribution of cellulose esters employing the methods known in the art which employ high speed liquid chromatography. Measurement conditions for the above are as follows.
Solvent: methylene chloride
Column: Shodex K806, K805, and K803 (produced by Showa Denko K.K., these columns were used upon being connected)
Column temperature: 25° C.
Sample concentration: 0.1 percent by weight
Detector: RI Model 504 (produced by GL Science Co.)
Pump: L6000 (produced by Hitachi, Ltd.)
Flow rate: 1.0 ml/minute
Calibration curve: The used calibration curve was prepared employing 13 samples of Standard Polystyrene STK, polystyrene (produced by Tosoh Corp.) of 500-1,000,000 Mw. It is preferable that the above 13 samples are selected to result in approximately equal intervals.

Raw cellulose materials of the cellulose esters employed in the present invention may be either wood pulp or cotton linter. Wood pulp may be made from either conifers or broad-leaved trees, but coniferous pulp is more preferred.

However, in view of peeling properties during casting, cotton linters are preferably employed. Celluloses esters prepared employing these materials may be employed individually or in appropriate combinations.

For example, the following ratios are possible: cellulose ester derived from cotton linter: cellulose ester derived from wood pulp (conifers): cellulose ester derived from wood pulp (broad-leaved trees) is 100:0:0, 90:10:0, 85:15:0, 50:50:0, 20:80:0, 10:90:0, 0:100:0, 0:0:100, 80:10:10, 85:0:15, and 40:30:30.

It is possible to prepare cellulose esters by replacing the hydroxyl group of cellulose raw materials with an acetyl group, an propionyl group, and/or a butyl group, employing acetic anhydride, propionic anhydride, and/or butyric anhydride based on conventional methods. Synthesis methods of such cellulose esters are not particularly limited, and it is possible to synthesize them with reference to, for example, JP-A No. 10-45804 or JP-A (under PCT Application) No. 6-501040.

It is possible to determine the degree of substitution of the acetyl group; propionyl group; and butyl group based on ASTM-D817-96.

Further, cellulose esters are industrially synthesized employing sulfuric acid as a catalyst, however the above sulfuric acid is not easily completely removed. The residual sulfuric acid undergoes various types of decomposition reactions to result in adverse effects to product quality of the resulting cellulose ester films. Consequently, it is desirable to control the residual sulfuric acid in the cellulose esters employed in the present invention within the range of 0.1-40 ppm in terms of sulfur element. It is assumed that these acids are incorporated in the form of salts. It is not preferable that the content of the residual sulfuric acid exceeds 40 ppm, because adhering materials on die lips increase during heat melting. Further, it is preferable that the content is relatively small. However, it is not preferable that content is at most 0.1, because achieving at most 0.1 results in excessively large load for the washing process of cellulose resins and further on the contrary, breakage tends to occur during or after heat stretching. It is assumed that an increase in washing frequency adversely affects the resins, but the reasons for this are not well understood. The content of the residual sulfuric acid is more preferably in the range of 0.1-30 ppm. It is also possible to determine the content of the residual sulfuric acid based on ASTM-DS17-96.

The total residual acid (such as acetic acid or others) is preferably less than 1000 ppm, more preferably less than 500 ppm, and still more preferably less than 100 ppm.

By further sufficiently washing synthesized cellulose compared to the case in which the solution-casting method is employed, it is possible to achieve the desired content of residual sulfuric acid to be within the above range. Thus, during production of film employing the melt-casting method, adhesion to the lip portions is reduced to produce films of excellent flatness, whereby it is possible to produce films which exhibit excellent dimensional stability, mechanical strength, transparency, and water vapor transmitting resistance, as well as the desired Rt and Ro values. Further, in washing of the cellulose ester, there can be used, in addition to water, a poor solvent such as methanol or ethanol, or a mixed solvent of a poor solvent and a good solvent if resulting in a poor solvent. Thereby, inorganic substances and low molecular organic impurities other than remaining acids can be removed. Still further, the cellulose ester is preferably washed in the presence of an antioxidant such as a hindered amine or a phosphorous acid ester to enhance the heat resistance and film forming stability of the cellulose ester.

Further, to enhance the heat resistance, mechanical properties, and optical properties of the cellulose ester, the cellulose ester is dissolved in a good solvent and then reprecipitated in a poor solvent to remove low molecular weight components of the cellulose ester and other impurities. At this time, such treatment is preferably carried out in the presence of an antioxidant in the same manner as in washing of the cellulose ester described above.

Still further, after reprecipitation of the cellulose ester, another polymer or a low molecular compound may be added.

Further, the limiting viscosity of cellulose resins is preferably 1.5-1.75 g/cm³, but is more preferably 1.53-1.63 g/cm³.

Still further, it is preferable that when the cellulose esters employed in the present invention are converted to a film, the resulting film produces minimal foreign matter bright spots. “Foreign matter bright spots” refers to the following type of spots. A cellulose ester film is placed between two polarizing plates arranged at right angles (crossed Nicols) and light is exposed on one side while the other side is viewed. When foreign matter is present, light leaks through the film and a phenomenon occurs in which foreign matter particles are seen as bright spots. During this operation, the polarizing plate, which is employed for evaluation, is composed of a protective film without any foreign matter bright spots, whereby a glass plate is preferably employed to protect polarizers. It is assumed that one of the causes of foreign matter bright spots is the presence of cellulose which has undergone no acetylation or only a low degree of acetylation. It is necessary to employ cellulose esters (or employing cellulose esters exhibiting a degree of uniform substitution). Further, it is possible to remove foreign matter bright spots in such a manner that melted cellulose esters are filtered, or during either the latter half of the synthesis process of the cellulose esters, or during the process to form precipitates, a solution is temporarily prepared and is filtered via a filtration process. Since melted resins exhibit high viscosity, the latter method is more efficient.

It is likely that as the film thickness decreases, the number of foreign matter bright spots per unit area decreases, and similarly, as the content of cellulose ester incorporated in films decreases, foreign matter bright spots decreases. The number of at least 0.01 mm foreign matter bright spots is preferably at most 200, is more preferably at most 100, is still more preferably at most 50, is still more preferably at most 30, is yet more preferably at most 10, but is most preferably of course zero.

In cases in which bright spot foreign matter is removed via melt-filtration, it is preferable to filter the melted composition composed of cellulose esters, plasticizers, degradation resistant agents, and antioxidants, rather than to filter melted individual cellulose ester, whereby bright spot foreign matter is efficiently removed. Of course, bright spot foreign matter may be reduced in such a manner that during synthesis of cellulose ester, the resulting cellulose ester is dissolved in solvents and then filtered. It is possible to filter compositions which appropriately incorporate UV absorbers and other additives. The viscosity of the melt, incorporating cellulose esters, which is to be filtered, is preferably at most 10,000 P, is more preferably at most 5,000 P, is still more preferably at most 1,000 P, but is most preferably at most 500 P. Preferably employed as filters are those known in the art, such as glass fibers, cellulose fibers, paper filters, or fluorine resins such as tetrafluoroethylene. However, ceramic and metal filters are particularly preferably employed. The absolute filtrations accuracy of employed filters is preferably at most 50 μm, is more preferably at most 30 μm, is still more preferably at most 10 μm, but is most preferably at most 5 μm. It is possible to employ them in suitable combinations. Employed as a filter, may be either a surface type or a depth type. The depth type is more preferably employed since it is relatively more free from clogging.

In another embodiment, employed as raw cellulose ester materials may be those which are dissolved in solvents at least ounce, and then dried to remove the solvents. In this case, cellulose ester is dissolved in solvents together with at least one of a plasticizer, an UV absorber, a degradation resistant agent, an antioxidant, and a matting agent. Thereafter, the mixture is dried and then used as a cellulose ester composition. Employed as solvents may be good solvents, such as methylene chloride, methyl acetate, dioxolan, which are employed in the solution-casting method, while poor solvents such as methanol, ethanol, or butanol may also be simultaneously employed. In the dissolving process, cooling may be performed to −20° C. or lower, or heated to 80° C. or higher. By employing such cellulose ester, it is possible to uniformly mix each of the additives in a melted state and, it is occasionally possible to make the resulting optical characteristic very uniform.

The method for producing the polarizing plate protective film of the present invention may use polymer which is formed by suitably blending polymer components other than cellulose esters. Polymers to be blended are preferably those which are highly compatible with cellulose esters When converted to a film, the resulting transmittance is preferably at least 80 percent, is more preferable at least 90 percent, but is still more preferably at least 92 percents.

### (Antioxidants)

Since decomposition of cellulose esters is accelerated not only by heat but also by oxygen at the high temperature at which melt-casting is performed, it is preferable that antioxidants are incorporated as a stabilizer into the optical film of the present invention.

Especially, under a high temperature ambience such that melt film formation is carried out, an antioxidant is preferably contained since decomposition of a cellulose ester film-forming material via heat or oxygen is promoted.

Further, in the present invention, a cellulose ester is also preferably subjected to suspension washing in the presence of an antioxidant using a poor solvent to the cellulose ester. As the antioxidant used, any compound can be employed, with no specific limitation, which deactivates radicals generated in the cellulose ester or inhibits deterioration of the cellulose ester resulting from addition of oxygen to radicals generated therein.

An antioxidant used for suspension washing of a cellulose ester may remain in the cellulose ester after washing. The remaining amount thereof is preferably 0.01-2000 ppm, more preferably 0.05-1000 ppm, and still more preferably 0.1-100 ppm.

Antioxidants which are used as a useful antioxidant in the present invention are not particularly limited as long as they are compounds which retard degradation of melt-molded materials via the presence of oxygen. Useful antioxidants include phenol based antioxidants, hindered amine based antioxidants, phosphorous based antioxidants, benzofuranone based antioxidants, heat resistant process stabilizing agents, and oxygen scavengers. Of these, particularly preferred are phenol based antioxidants, hindered amine based antioxidants and phosphorous based antioxidants, benzofuranone based antioxidants. By blending these antioxidants, it is possible to minimize coloration and strength degradation of molded products due to heat, as well as thermal oxidation degradation during melt molding. These antioxidants may be employed individually or in combinations of at least two types.

### (Phenol Based Antioxidants)

The phenol based antioxidants are prior art compounds, which are described, for example, in column 12-14 of U.S. Pat. No. 4,839,405, including 2,6-dialkyl phenol derivatives. Of such compounds, included as preferable compounds are those represented by following Formula (A).

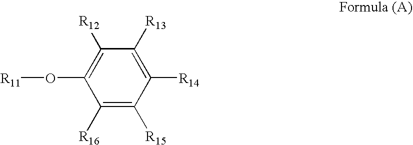

wherein R₁₁-R₁₆ represent substituents. The substituents include a hydrogen atom, a halogen atom (e.g., a fluorine atom and a chlorine atom), an alkyl group (e.g., a methyl group, an ethyl group, an isopropyl group, a hydroxyethyl group, a methoxymethyl group, a trifluoromethyl group, and a t-butyl group), a cycloalkyl group (e.g., a cyclopentyl group and a cyclohexyl group), an aralkyl group (e.g., a benzyl group and a 2-phenetyl group), an aryl group (e.g., a phenyl group, a naphthyl group, a p-tolyl group, and a p-chlorophenyl group), an alkoxy group (e.g., a methoxy group, an ethoxy group, an isopropoxy group, and a butoxy group), an aryloxy group (e.g., a phenoxy group), a cyano group, an acylamino group (e.g., an acetylamino group, a propionylamino group), an alkylthio group (e.g., a methylthio group, an ethylthio group, and a butylthio group), an arylthio group (e.g., a phenylthio group), a sulfonylamino group (e.g., a methanesulfonylamino group and a benzenesulfonylamino group), a ureido group (e.g., a 3-methylureido group, a 3,3-dimethylureido group, and a 1,3-dimethylureido group), a sulfamoylamino group (e.g., a dimethylsulfamoylamino group), a carbamoyl group (e.g., a methylcarbamoyl group, an ethylcarbamoyl group, and a dimethylcarbamoyl group), a sulfamoyl group (e.g., an ethylsulfamoyl group and a dimethylsulfamoyl group), an alkoxycarbonyl group (e.g., a methoxycarbonyl group and an ethoxycarbonyl group), an aryloxycarbonyl group (e.g., a phenoxycarbonyl group), a sulfonyl group (e.g., a methanesulfonyl group, a butanesulfonyl group, and a phenylsulfonyl group), an acyl group (e.g., an acetyl group, a propanoyl group, and a butyroyl group), an amino group (e.g., a methylamino group, an ethylamino group, and a dimethylamino group), a cyano group, a hydroxy group, a nitro group, a nitroso group, an amine oxide group (e.g., a pyridine-oxide group), an imide group (e.g., a phthalimide group), a disulfide group (e.g., a benzenedisulfide group and benzothiazolyl-2-disulfide group), a carboxyl group, a sulfo group, a heterocyclic group (e.g., a pyrrole group, a pyrrolidyl group, a pyrazolyl group, an imidazolyl group, a pyridyl group, a benzimidazolyl group, a benzothiazolyl group, and a benzoxazolyl group), These substituent may be further substituted.

R₁₁ is preferably a hydrogen atom and R₁₂ and R₁₆ is preferably a phenol compound having t-butyl group. Specific examples of the phenol compound include n-octadyl 3-(3,5-di-t-butyl-4-hydroxyphenyl)-propionate, n-octadyl 3-(3,5-di-t-butyl-4-hydroxyphenyl)-acetate, n-octadecyl 315-di-t-butyl-4-hydroxybenzoate, n-hexyl 3,5-di-t-butyl-4-hydroxyphenylbenzoate, n-dodecyl 3,5-di-t-butyl-4-hydroxyphenylbenzoate, neo-dodecyl 3-(3,5-di-t-butyl-4-hydroxyphenyl)propionate, dodecyl β(3,5-di-t-butyl-4-hydroxyphenyl)propionate, ethyl α-(4-hydroxy 3,5-di-t-butylphenyl)isobutyrate, octadecyl α-(4-hydroxy 3,5-di-t-butylphenyl)isobutyrate, octadecyl α-(4-hydroxy 3,5-di-t-butyl-4-hydroxyphenyl)propionate, 2-(n-octylthio) ethyl 3,5-di-t-butyl-4-hydroxy-benzoate, 2-(n-octyl thio) ethyl 3,5-di-t-butyl-4-hydroxy-phenyl acetate, 2-(n-octadecyl thio) ethyl 3,5-di-t-butyl-4-hydroxy-phenyl-acetate, 2-(n-octadecyl thio)ethyl 3,5-di-t-butyl-4-hydroxy-benzoate, 2-(2-hydroxy ethyl thio)ethyl 3, S-di-t-butyl-4-hydroxy-benzoate, diethyl glycol bis(3,5-di-t-butyl-4-hydroxy-phenyl)propionate, 2-(n-octadecyl thio) ethyl 3-(3,5-di-t-butyl-4-hydroxy-phenyl)propionate, stearamide N,N-bis-[ethylene 3-(3,5-di-t-butyl-4-hydroxy-phenyl)propionate], n butyl imino N,N-bis-[ethylene 3-(3,5-di-t-butyl-4-hydroxy-phenyl)propionate], 2-(2 stearoyloxyethylthio)ethyl 3,5-di-t-butyl-4-hydroxy benzoate, 2-(2-stearoyloxyethylthio)ethyl 7-(3-methyl-5-t-butyl-4-hydroxy-phenyl)heptanoate, 1,2-propylene glycol bis-[3 (3,5-di-t-butyl-4-hydroxy-phenyl)propionate], ethylene glycol bis-[3-(3,5-di-t-butyl-4-hydroxy-phenyl)propionate], neopentyl glycol bis-[3-(3,5-di-t-butyl-4-hydroxy-phenyl)propionate], ethylene glycol bis-(3,5-di-t-butyl-4-hydroxy-phenyl acetate), glycerine-1-n-octadecanoate-2,3-bis-(3,5-di-t-butyl-4-hydroxyphenyl acetate), pentaerythritol-tetrakis[3-(31,5′-di-t-butyl-4′-hydroxy-phenyl)propionate], 1,1,1-trimethyrol ethane tris[3-(3,5-di-t-butyl-4-hydroxy-phenyl)propionate], sortitol hexa-[3-(3,5-di-t-butyl-4-hydroxy-phenyl)propionate], 2-hydroxyyethyl 7-(3-methyl-5-t-butyl-4-hydroxy-phenyl)propionate, 2-stearoyloxyethyl 7-(3-methyl-5-t-butyl-4-hydroxy-phenyl) heptanoate, 1,6-n-hexane diole bis[(3′,5′-di-t-butyl-4-hydroxy-phenyl)propionate], pentaerythritol-tetrakis (3,5-di-t-butyl-4-hydroxy hydroxinamate). The phenol compounds of the type listed above are commercially available as “Irganox 1076” and “Irganox 1010” manufactured by Ciba Specialty Chemicals.

### (Hindered Amine-Based Compounds)

As one of the antioxidants useful for the present invention, a hindered amine-based compound represented by following Formula (B) is preferable.

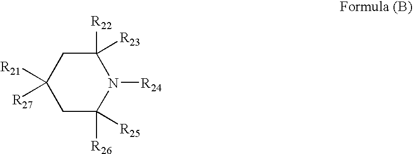

wherein R₂₁-R₂₇ represent substituents. The substituents are identical to the substituents defined by R₁₁-R₁₆ in Formula (A). R₂₄ is preferably a hydrogen atom or a methyl group. R₂₇ is preferably a hydrogen atom, and R₂₂, R₂₃, R₂₅, and R₂₆ is preferably a methyl group.

Specific examples of the hindered amine-based compound include bis(2,2,6,6-tetramethyl-4-piperidyl)sebacate, bis(2,2,6,6-tetramethyl-4-piperidyl)succinate, bis (1,2,2,6,6-pentamethyl-4-piperidyl)sebacate, bis(N-octoxy-2,2,6,6-tetramethyl-4-piperidyl)sebacate, bis(N-benzyloxy-2,2,6,6-tetramethyl-4-piperildyl)sebacate, bis(N-cyclohexyloxy-2,2,6,6-tetramethyl-4-piperidyl)sebacate, bis(1,2,2,6,6-pentamethyl-4-piperidyl) 2-(3,5-di-t-butyl-4-hydroxybenzyl)-2-butyl malonate, bis(1-acroyl-2,2,6,6-tetramethyl-4-piperidyl)2,2-bis(3,5-di-t-butyl-4-hydroxybenzyl)-2-butyl malonate, bis(1,2,2,6,6-pentamethyl-4-piperidyl decanedioate, 2,2,6,6-tetramethyl-4-piperidyl methacrylate, 4-[3-(3,5-di-t-butyl-4-hydroxyphenyl)propionyloxy]-1-[2-(3-(3,5-di-t-butyl-4-hydroxyphenyl)propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propionamide, tetrakis(2,2,6,6-tetramethyl-4-piperidyl)1,2,3,4-butanetetracarboxylate, and tetrakis(1,2,2,6,6-pentamethyl-4-piperidyl)1,2,3,4-butanetetracarboxylate.

Further, a polymer-type compound is employable. Specific examples thereof include a high molecular weight HALS wherein plural piperidine rings join each other via a triazine skeleton such as N,N′,N″,N′″-tetrakis-[4,6-bis-[butyl-(N-methyl-2,2,6,6-tetramethylpiperidine-4-yl)amino]-triazine-2-yl]-triazine-2-yl]-4,7-diazadecane-1,10-diamine, a polycondensate of dibutylamine, 1,3,5-triazine-N,N′-bis(2,2,6,6-tetramethyl-4-piperidyl-1,6-hexamethylenediamine, and N-(2,2,6,6-tetramethyl-4-piperidyl)butylamine, a polycondensate of dibutylamine, 1,3,5-triazine, and N,N′-bis(2,2,6,6-tetramethyl-4-piperidyl)butylamine, poly[1{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}], a polycondensate of 1,6-hexanediamine-N,N′-bis(2,2,6,6-tetramethyl-4-piperidyl), and morpholine-2,4,6-trichloro-1,3,5-triazine, or poly[(6-morpholino-s-triazine-2,4-diyl)[(2,2,6,6-tetramethyl-4-piperidyl)imino]-hexamethylene[(2,2,6,6-tetramethyl-4-piperidyl)imino]3; and a compound wherein a piperidine ring is bonded via an ester bond such as a polymer of a polymer of dimethyl succinate and 4-hydroxy-2,2,6,6-tetramethyl-1-piperidine ethanol or a mixed esterified compound of 1,2,3,4-butanetetracarboxylic acid, 1,2,2,6,6-pentamethyl-4-piperidynol, and 3,9-bis(2-hydroxy-1,1-dimethylethyl)-2,4,8,10-tetraoxaspiro[5,5]undecane. However, the present invention is not limited thereto.

Of these, preferable are those, featuring a number average molecular weight (Mn) of 2,000-5,000 such as a polycondensate of dibutylamine, 1,3,5-tritriazine, and N,N′-bis(2,2,6,6-tetramethyl-4-piperidyl)butylamine, poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}], or a polymer of dimethyl succinate and 4-hydroxy-2,2,6,6-tetramethyl-1-piperidine ethanol.

Hindered phenol compounds of the above types are commercially available as “TINUVIN144” and “TINUVIN770” from Ciba Specialty Chemicals, Ltd., as well as “ADK STAB LA-52” from Asahi Denka Rogyo K.K. under the trade names.

### (Phosphor-Based Compounds)

AS one of the antioxidants useful for the present invention, preferable is a compound having a partial structure represented by following Formula (C-1), (C-2), (C-3), (C-4), or (C-5) in the molecule thereof.

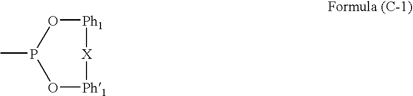

wherein Ph₁ and Ph′₁ represent substituents. The substituents include a phenylene group and an alkylene group which each may have a substituent, or those prepared in combination of these substituents. Ph₁ and Ph′₁ preferably represent a phenylene group. Any hydrogen atom of the phenylene group may be substituted by a phenyl group, an alkyl group having a carbon number of 1-8, a cycloalkyl group having a carbon number of 5-8, an alkylcycloalkyl group having a carbon number of 6-12, or an aralkyl group having a carbon number of 7-12. Ph₁ and Ph′₁ each may be the same or different. X represents a single bond, a sulfur atom, or —CHR₆— group. R₆ represents a hydrogen atom, an alkyl group having a carbon number of 1-8, or a cycloalkyl group having a carbon number of 5-8. Further, these may be substituted by a substituent identical to any of the substituents represented by R₁₁-R₁₆ in above Formula (A).

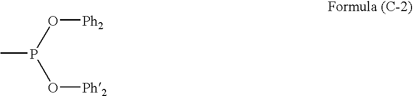

wherein Ph₂ and Ph′₂ represent substituents. The substituents are identical to the substituents represented by R₁₁-R₁₆ in Formula (A). Ph₂ and Ph′₂ preferably represent a phenyl group or a biphenyl group. Any hydrogen atom of the phenyl group or the biphenyl group may be substituted by an alkyl group having a carbon number of 1-8, a cycloalkyl group having a carbon number of 5-8, an alkylcycloalkyl group having a carbon number of 6-12, or an aralkyl group having a carbon number of 7-12. Ph₂ and Ph′₂ each may be the same or different. Further, these may be substituted by a substituent identical to any of the substituents represented by R₁₁-R₁₆ in Formula (A).

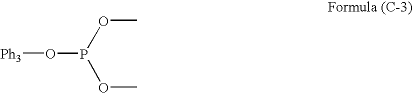

wherein Ph₃ represents a substituent. The substituent is identical to any of the substituents represented by R₁₁-R₁₆ in Formula (A). Ph₃ preferably represents a phenyl group or a biphenyl group. Any hydrogen atom of the phenyl group or the biphenyl group may be substituted by an alkyl group having a carbon number of 1-8, a cycloalkyl group having a carbon number of 5-8, an alkylcycloalkyl group having a carbon number of 6-12, or an aralkyl group having a carbon number of 7-12. Further, these may be substituted by a substituent identical to any of the substituents represented by R₁₁-R₁₆ in Formula (A).

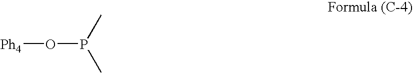

wherein Ph₄ represents a substituent. The substituent is identical to any of the substituents represented by R₁₁-R₁₆ in Formula (A). Ph₄ preferably represents an alkyl group having a carbon number of 1-20 or a phenyl group. The alkyl group or the biphenyl group may be substituted by a substituent identical to any of the substituents represented by R₁₁-R₁₆ in Formula (A).

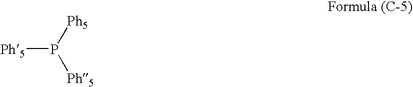

wherein Ph₅, Ph′₅, and Ph″₅, represent substituents. The substituents are identical to the substituents represented by R₁₁-R₁₆ in Formula (A). Ph₅, Ph′₅, and Ph″₅ preferably represent an alkyl group having a carbon number of 1-20 or a phenyl group. The alkyl group or the phenyl group may be substituted by a substituent identical to any of the substituents represented by R₁₁-R₁₆ in Formula (A).

Specific examples of the phosphor-based compounds include a monophosphite-based compound such as triphenyl phosphite, diphenylisodecyl phosphite, phenyldiisodecyl phosphite, tris(nonylphenyl)phosphite, tris(dinonylphenyl)phosphite, tris(2,4-di-t-butylphenyl)phosphite, 10-(3,5-di-t-butyl-4-hydroxybenzyl)-9,10-dihydro-9-oxa-10-phosphaphenanthrene-10-oxide, 6-[3-(3-t-butyl-4-hydroxy-5-methylphenyl)propoxy]-2,4,8,10-tetra-t-butyldibenz[d,f][1.3.2]dioxaphosphepin; a diphosphite-based compound such as 4,4′-butylydene-bis(3-methyl-6-t-butylphenyl-di-tridecyl phosphite), or 4,4′-isopropylydene-bis(phenyl-di-alkyl(C12-C15) phosphite); a phosphonite-based compound such as triphenylphosphonite, tetrakis(2,4-di-tert-butylphenyl)[1,1-biphenyl]-4,4′-diylbisphosphonite, or tetrakis(2,4-di-tert-butyl-5-methylphenyl)[1,1-biphenyl]-4,4′-diylbisphosphonite; a phosphinite-based compound such as triphenylphosphinite or 2,6-dimethylphenyldiphenylphosphinite; and a phosphine-based compound such as triphenylphosphine or tris(2,6-dimethoxyphenyl)phosphine.

Phosphor-based compounds of the above types are commercially available, for example, as “Sumilizer GP” from Sumitomo Chemical Co., Ltd.; “ADk STAB PEP-24G”, “ADK STAB PEP-36”, and “ADK STAB 3010” from Asahi Denka Kogyo K.K.; “IRGAFOS P-EPQ” from Ciba Specialty Chemicals, LTD.; and “GSY-P101” from Sakai Chemical Industry Co., Ltd. under the trade names.

Further, the following compounds can be listed:

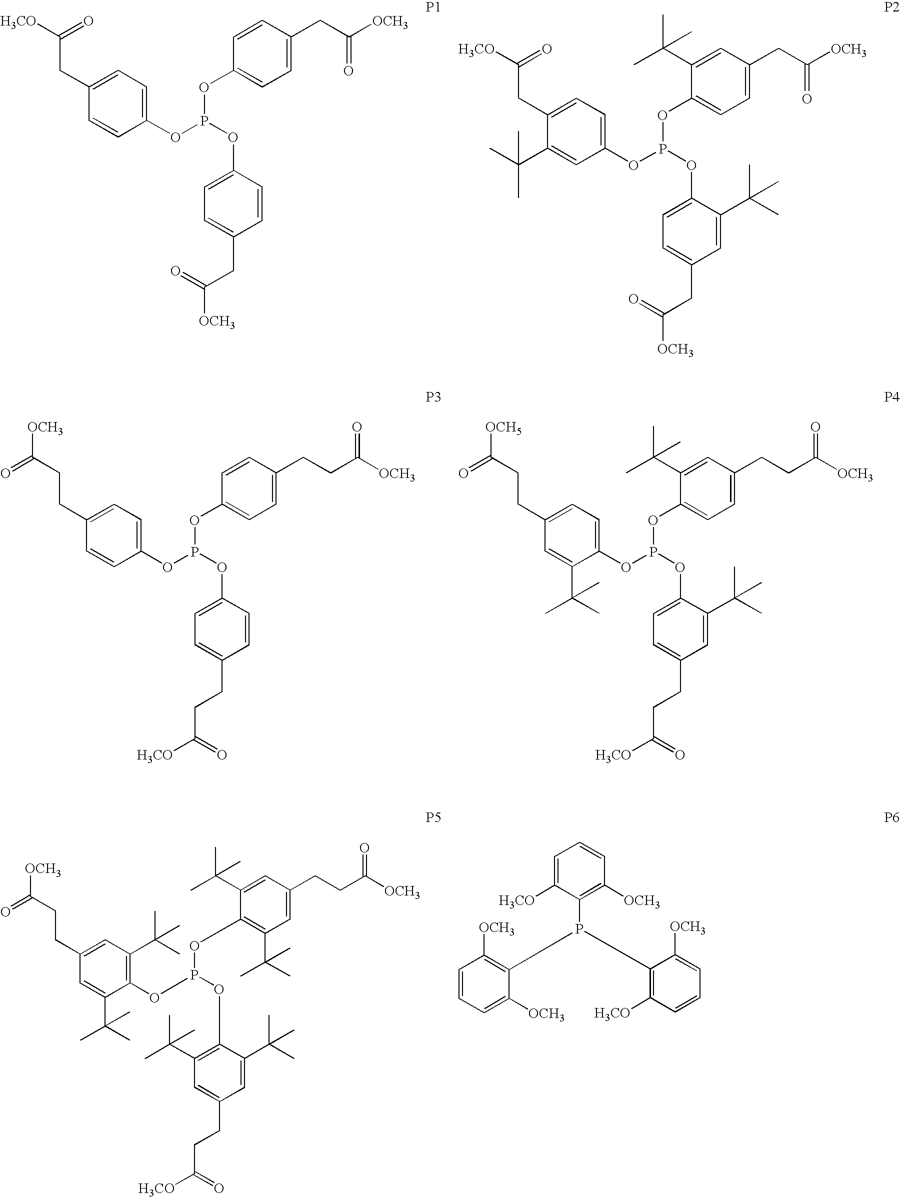

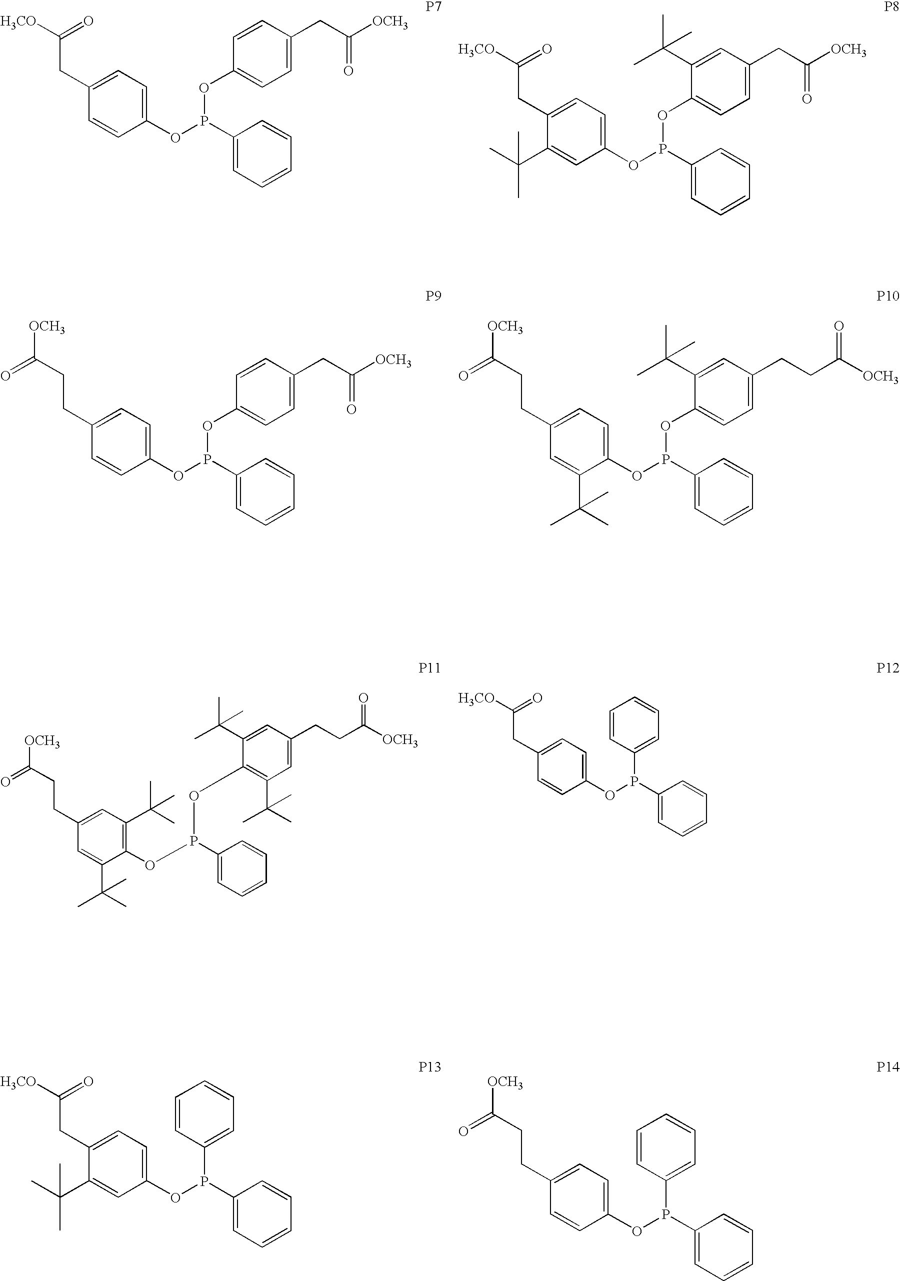

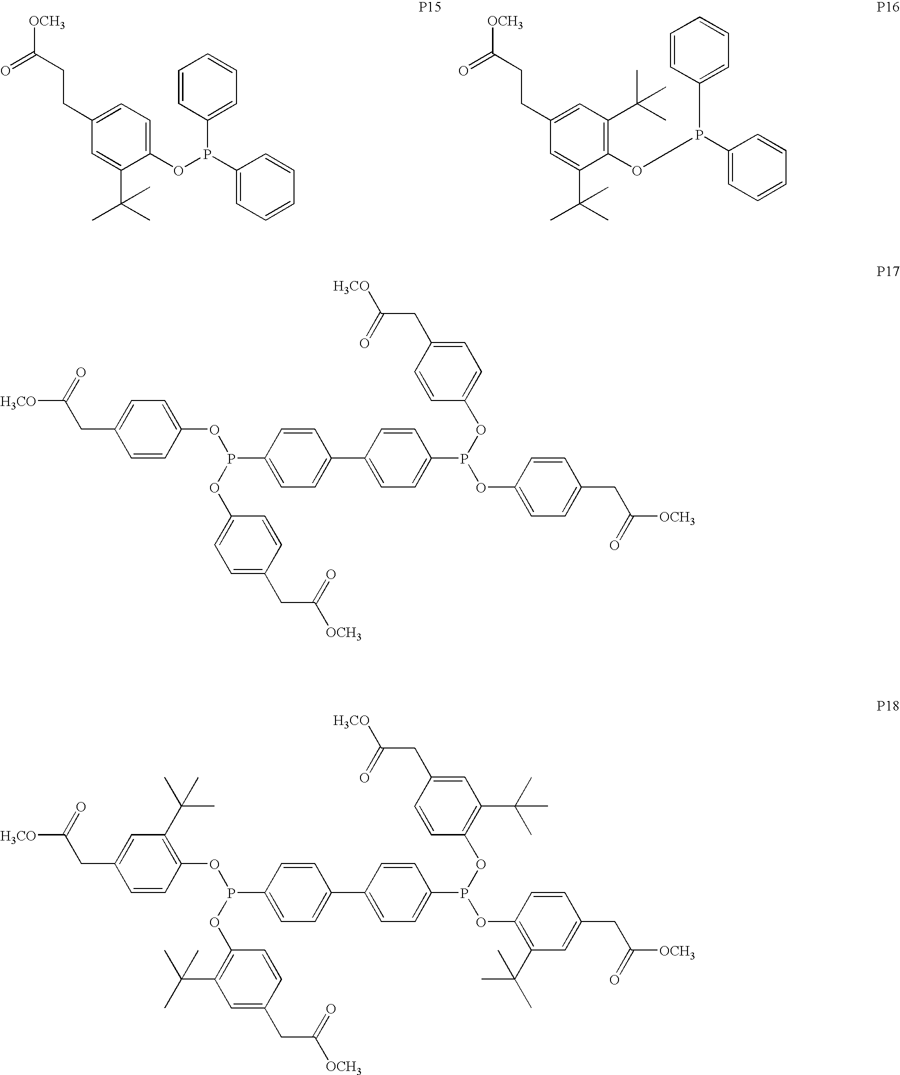

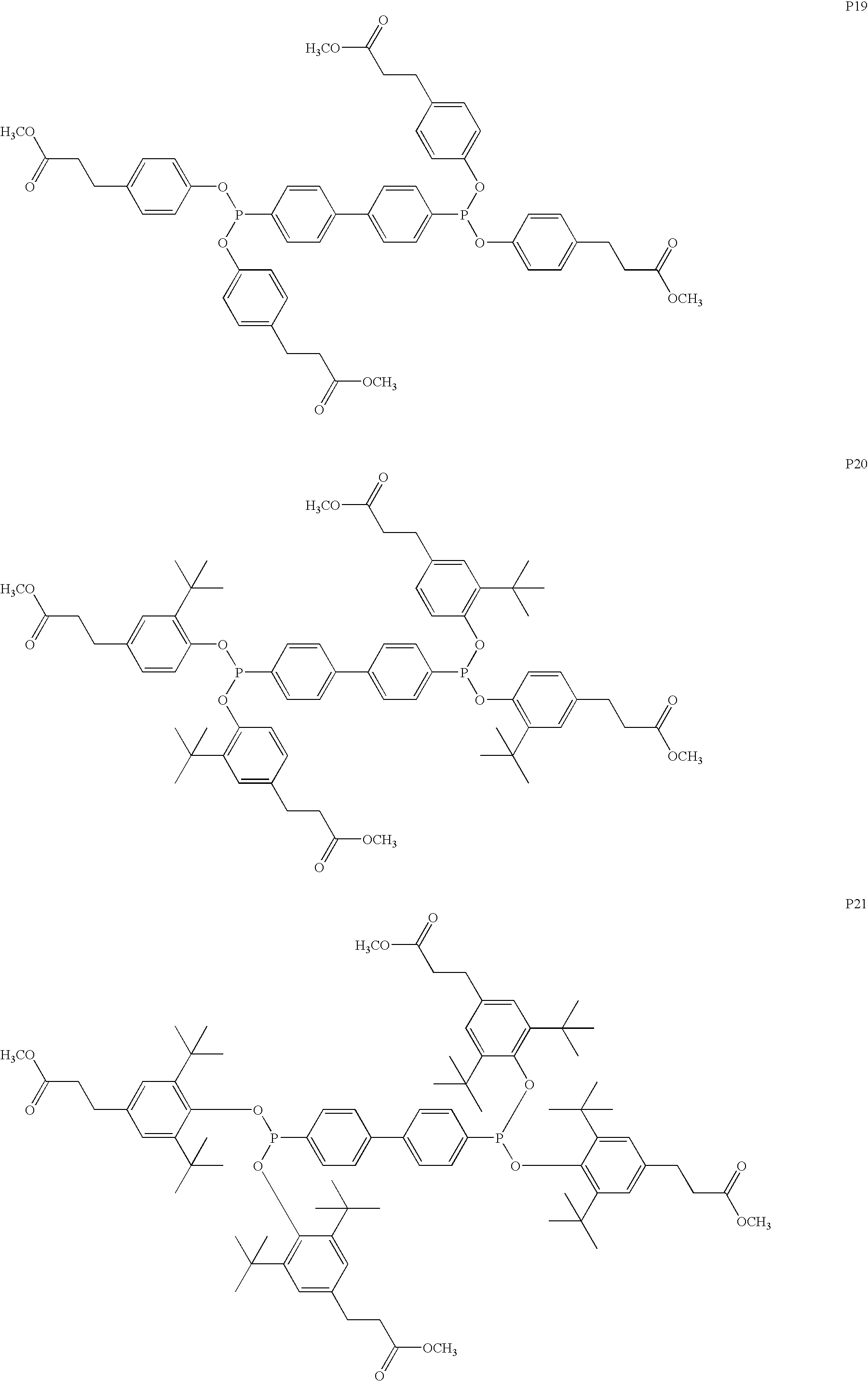

### (Sulfur-Based Compounds)

As one of the antioxidants useful for the present invention, a sulfur-based compound represented by following Formula (D) is preferable.

R₃₁—S—R₃₂ Formula (D)

wherein R₃₁ and R₃₂ represent substituents. The substituents are identical to the substituents represented by R₁₁-R₁₆ in above Formula (A).

Specific examples of the sulfur-based compounds include dilauryl 3,3-thiodipropionate, dimyristyl 3,3-thiodipropionate, distearyl 3,3-thiodipropionate, laurylstearyl 3,3-thiodipropionate, pentaerythritol-tetrakis-(β-lauryl-thio-propionate), and 3,9-bis(2-dodecylthioethyl)-2,4,8,10-tetraoxaspiro[5,5]undecane.

Sulfur-based compounds of the above types are commercially available, for example, as “Sumilizer TPL-R” and “Sumilizer TP-D” from Sumitomo Chemical Co., Ltd. under the trade names.

Further, as one of the antioxidants useful for the present invention, a benzofuran-based compound, as described in Japanese Patent Publication Open to Public Inspection Nos. 7-233160 and 7-247278, is preferable. Specific examples of the benzofuran-based compound include 5,7-di-tert-Bu-3-(2,5-dimethylphenyl)-3H-benzofuran-2-on, 3-(3,4-dimethylphenyl)-5,7-di-tert-Bu-3H-benzofuran-2-on, 5,7-di-tert-Bu-3-(4-ethylphenyl)-3H-benzofuran-2-on, 5,7-di-tert-Bu-3-(2,3,4,5,6-pentamethylphenyl)-3H-benzofuran-2-on, 5,7-di-tert-Bu-3-(4-methylthiophenyl)-3H-benzofuran-2-on, and 5,7-di-tert-Bu-3-(4-methylphenyl)-3H-benzofuran-2 on.

Heat-resistant processing stabilizers include, for example, 2-t-butyl-6-(3-t-butyl-2-hydroxy-5-methylbenzyl)-4-methylphenyl acrylate and 2-[1-(2-hydroxy-3,5-di-t-pentylphenyl)ethyl]-4,6-di-t-pentylphenyl acrylate. Heat-resistant processing stabilizers of the above types are commercially available as “Sumilizer GM” and “Sumilizer GS” from Sumitomo Chemical Co., Ltd. under the trade names.

Any impurities such as remaining acids, inorganic salts, or organic low molecular compounds carried over from during production or generated during storage are preferably removed from an antioxidant, similarly to the above cellulose ester, and the purity of the antioxidant is preferably at least 99%. The remaining acids and water are preferably in the range of 0.01-100 ppm, whereby in melt film formation using a cellulose ester, heat deterioration is inhibited, and film forming stability, and optical and mechanical properties of the film are enhanced.

The addition amount of antioxidants is preferably 0.1-10 percent by weight, is more preferably 0.2-5 percent by weight, but is still more preferably 0.5-2 percent by weight. These may be employed in combinations of at least two types.

When the amount of an antioxidant added is excessively small, stabilizing action is expressed low during dissolution, resulting in no effects; and in contrast, when the added amount is excessively large, the decrease of transparency of a film results and the film tends to become fragile from the viewpoint of compatibility with a cellulose ester, which is unfavorable.

### (Acid Scavengers)

At the relatively high temperature at which melt-casting is performed, decomposition of cellulose esters is also accelerated by the presence of acids, whereby it is preferable that the polarizing plate protective film of the present invention incorporates acid scavengers as a stabilizer. Acid scavengers in the present invention may be employed without any limitation, as long as they are compounds which react with acids to inactivate them. Of such compounds, preferred are compounds having an epoxy group, as described in U.S. Pat. No. 4,137,201. Epoxy compounds as such an acid scavenger are known in this technical field, and include diglycidyl ethers of various polyglycols, especially, polyglycols which are derived by condensation of ethylene oxides in an amount of about 8-about 40 mol per mol of polyglycol, metal epoxy compounds (for example, those which have conventionally been employed together with vinyl chloride polymer compositions in vinyl chloride polymer compositions), epoxidized ether condensation products, diglycidyl ethers (namely, 4,4′-dihydroxydiphenyldimethylmethane) of bisphenol A, epoxidized unsaturated fatty acid esters (particularly, alkyl esters (for example, butyl epoxystearate) having about 2-about 4 carbon atoms of fat acids having 2-22 carbon atoms), epoxidized plant oils which can be represented and exemplified by compositions of various epoxidized long chain fatty acid triglycerides (for example, epoxidized soybean oil and epoxidized linseed oil and other unsaturated natural oils (these are occasionally called epoxidized natural glycerides or unsaturated fatty acid and these fatty acid have 12-22 carbon atoms). Further, preferably employed as commercially available epoxy group incorporating epoxide resinous compounds may be EPSON 815C and other epoxidized ether oligomer condensation products represented by Formula (E).

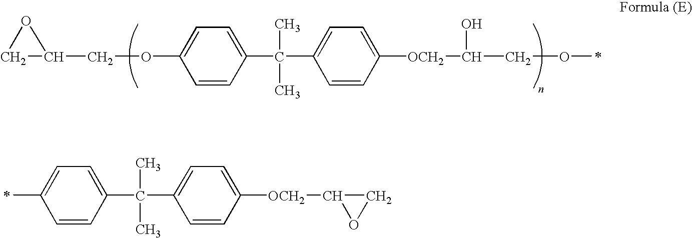

wherein n represent an integer of 0-12. Other usable acid scavengers include those described in paragraphs 87-105 of JP-A No. 5-194788.

The added amount of acid scavengers is preferably 0.1-10 percent by weight, more preferably 0.2-5 percent by weight, but is more preferably 0.5-2 percent by weight. These may be employed in combinations of at least two types.

Further, acid scavengers may also be called acid trapping agent and acid catchers, but in the present invention, it is possible to use-them regardless name.

### (UV Absorbers)

In view of minimizing degradation of polarizers and display units due to ultraviolet radiation, UV absorbers, which absorb ultraviolet radiation of a wavelength of at most 370 nm, are preferred, while in view of liquid crystal display properties, UV absorbers, which minimize absorption of visible light of a wavelength of at least 400 nm, are preferred. Examples of UV absorbers employed in the present invention include oxybenzophenone based compounds, benzotriazole based compounds, salicylic acid ester based compounds, benzophenone based compounds, cyanoacrylate based compounds, nickel complex based compounds, and triazine based compounds. Of these, preferred are benzophenone based compounds, as well as benzotriazole based compounds and triazine compounds which result in minimal coloration. Further, employed may be UV absorbers described in JP-A Nos. 10-182621 and 8-337574, as well as polymer UV absorbers described in JP-A Nos. 6-148430 and 2003-113317.

Specific examples of benzotriazole UV absorbers include, but are not limited to, 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylenebis(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, and 2-(2H-benzotriazole-2-yl)-6-(straight chain and branched chain dodecyl)-4-methylphenol, as well as a mixture of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate.

Listed as such commercially available products are TINUvIN 171, TINUVIN 234, TINUVIN 360, TINUVIN 900, TINUVIN 928, all produced by Ciba Specialty Chemicals Co.) and LA 31 (produced by Asahidenka CO. Ltd.).

Specific examples of benzophenone compounds include, but are not limited to, 2,4-dihydroxybenzophenone, 2,2′-dihydroxy-4-methoxybenzopheneone, 2-hydroxy-4-methoxy-5-sulfobenzophenone, and bis(2-methoxy-4-hydroxy-5-benzoylphenylmethane).

In the present invention, the added amount of UV absorbers is preferably 0.1-5 percent by weight, is more preferably 0.2-3 percent by weight, but is still more preferably 0.5-2 percent by weight. These may be employed in combinations. Further, these benzotriazole structure and benzophenone structure may be hung to a portion of polymers, or regularly to polymers and may further be incorporated into a part of the molecular structure of other additives such as plasticizers, antioxidants, or acid scavengers.

### <<Plasticizers>>

In the method for manufacturing a cellulose ester film of the present invention, at least one type of plasticizer is preferably added in a film forming material.

Plasticizers, as described herein, commonly refer to additives which decrease brittleness and result in enhanced flexibility upon being incorporated in polymers. In the present invention, plasticizers are added so that the melting temperature of a cellulose ester resin is lowered, and at the same temperature, the melt viscosity of a cellulose ester resin is lower than that of film constituting materials incorporating plasticizers. Further, addition is performed to enhance hydrophilicity of cellulose ester so that the water vapor permeability of cellulose ester films is improved. Therefore, the plasticizers of the present invention have a property of decreasing a water vapor permeability.

The melting temperature of film constituting materials, as described herein, refers to the temperature at which the above materials are heated to result in a state of fluidity. In order that cellulose ester results in melt fluidity, it is necessary to heat cellulose ester to a temperature which is at least higher than the glass transition temperature. At or above the glass transition temperature, the elastic modulus or viscosity decreases due to heat absorption, whereby fluidity results. However, at higher temperatures, cellulose ester melts and simultaneously undergoes thermal decomposition to result in a decrease in the molecular weight of the cellulose ester, whereby the dynamical characteristics of the resulting film may be adversely affected. Consequently, it is necessary to melt cellulose ester at a temperature as low as possible. Lowering the melting temperature of film constituting materials is achieved by the addition of plasticizers, which exhibit a melting point which is equal to or lower than the glass transition temperature.

The cellulose ester film of the present invention is characterized in incorporating, as a plasticizer in an amount of 1-25 percent by weight, ester compounds having a structure which is formed by condensing organic acids represented by following Formula (F), and polyhydric alcohols having 3 OH groups or more in the molecule. When the above amount is at most 1 percent by weight, no advantageous effects to improve flatness result, while when it exceeds 25 percent by weight, bleeding-out tends to occur to degrade storage stability of the film, both neither of which are desired. The cellulose ester film is more preferred which incorporates the plasticizers in an amount of 3-20 percent by weight, and is still more preferred which incorporates the plasticizers in an amount of 5-15 percent by weight.

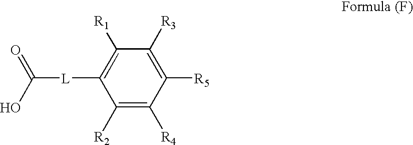

wherein R₁ to R₅ are each independently represent a hydrogen atom, a cycloalkyl group, an aralkyl group, an alkoxy group, a cycloalkoxy group, an aryloxy group, an aralkyloxy group, an acyl group, a carbonyloxyl group, an oxycarbonyl group or an oxycarbonyloxy group, provided that R₁ to R₅ may have further a substituent. L is a single bond or a linking group selected from the group consisting of a alkylene group which may have a substituent or a non-substituted and an oxygen atom.

Also preferred as the cycloalkyl group represented by R₁-R₅ is a cycloalkyl group having 3-8 carbon atoms, and specific examples include cycloproyl, cyclopentyl and cyclohexyl groups. These groups may be substituted. Listed as preferred substituents are a halogen atom such as a chlorine atom or a bromine atom, a hydroxyl group, an alkyl group, an alkoxy group, an aralkyl group (this phenyl group may further be substituted with a halogen atom), a vinyl group, an alkenyl group such as an aryl group, a phenyl group (this phenyl group may further be substituted with an alkyl group, or a halogen atom), a phenoxy group (this phenyl group may further be substituted with an alkyl group or a halogen atom), an acetyl group, an acyl group having 2-8 carbon atoms such as a propionyl group, an acetyloxy group, or a non-substituted carbonyloxy group having 2-8 carbon atoms such a propionyloxy group.

The aralkyl group represented by R₁-R₅ includes a benzyl group, a phenetyl group, and a γ-phenylpropyl group, which may be substituted. Listed as the preferred substituents may be those which may be substituted for the above cycloalkyl group.

The alkoxy group represented by R₁-R₅ include an alkoxy group having 1-8 carbon atoms. The specific examples include an methoxy group, an ethoxy group, an n-propoxy group, an n-butoxy group, an n-octyloxy group, an isopropoxy group, an isobutoxy group, a 2-ethylhexyloxy group, or a t-butoxy group, which may be substituted. Listed as preferred substituents may, for example, be a chlorine atom, a bromine atom, a fluorine atom, a hydroxyl group, an alkoxy group, a cycloalkoxy group, an aralkyl group (this phenyl group may be substituted with an alkyl group or a halogen atom), an alkenyl group, a phenyl group (this phenyl group may further be substituted with an alkyl group or a halogen atom), an aryloxy group (for example, a phenoxy group (this phenyl group may further be substituted with an alkyl group or a halogen atom)), an acetyl group, an acyl group such as a propionyl group, an acyloxy group such as a propionyloxy group having 2-8 carbon atoms, or an arylcarbonyloxy group such as a benzoyloxy group.

The cycloalkoxy groups represented by R₁-R₅ include a cycloalkoxy group having 1-8 carbon atoms as an unsubstituted cycloalkoxy group. Specific examples include a cyclopropyloxy, cyclopentyloxy and cyclohexyloxy group, which may be substituted. Listed as the preferred substituents may be those may be substituted to the above cycloalkyl group.

The aryloxy groups represented by R₁-R₅ include a phenoxy group having 1-8 carbon atoms as an unsubstituted cycloalkoxy group. This phenyl group may be substituted with the substituent listed as a substituent such as an alkyl group or a halogen atom which may substitute to the above cycloalkyl group.

The aralkyloxy group represented by R₁-R₅ includes a benzoyloxy group, which may further be substituted. Listed as the preferred substituents may be those which may be substituted for the above cycloalkyl group.

The acyl group represented by R₁-R₅ includes an unsubstituted acyl group having 1-3 carbon atoms such as an acetyl group (an alkyl, alkenyl, or alkynyl group is included as a hydrocarbon group of the acyl group), which may further be substituted. Listed as the preferred substituents may be those which may be substituted for the above cycloalkyl group.

The carbonyloxy group represented by R₁-R₅ includes an unsubstituted acyloxy group (an alkyl, alkenyl, or alkynyl group is included as a hydrocarbon group of the acyl group) having 2-8 carbon atoms such as an acetyloxy group or an arylcarbonyloxy group such as a benzoyloxy group, which may be substituted with the group which may be substituted for the above cycloalkyl group.

The oxycarbonyl group represented by R₁-R₅ includes an alkoxycarbonyl group such as a methoxycarbonyl group, an ethoxycarbonyl group, or a propyloxycarbonyl group, which may further be substituted. Listed as the preferred substituents may be those which may be substituted for the above cycloalkyl group.

The oxycarbonyloxy group represented by R₁-R₅ includes an alkoxycarbonyloxy group such as a methoxycarbonyloxy group, which may further be substituted. Listed as the preferred substituents may be those which may be substituted for the above cycloalkyl group.

Further, some of R₁-R₅ may link to each other to form a ring structure.

Further, the linking group represented by L includes a substituted or unsubstituted alkylene group, an oxygen atom, or a direct bond. The alkylene group includes a methylene group, an ethylene group, and a propylene group, which may be substituted with the substituent which is substituted for the group represented by above R₁R₅.

Of these, one which is particularly preferred as the linking group is the direct bond which is an aromatic carboxylic acid.

Further, preferred as the organic acids represented by above Formula (1), which constitute ester compounds which are plasticizers in the present invention, and are those in which all of R₁-R₅ are hydrogen atoms, or which posses the above alkoxy group, acyl group, oxycarbonyl group, carbonyloxy group or oxycarbonyloxy group at least in one of R₁, R₂ and R₄.

Further, the organic acids represented by above Formula (1) may contain a plurality of substituents.

In the present invention, organic acids which substitute the hydroxyl group of polyhydric alcohol having 3 OH groups or more in the molecule may be either a single kind or a plurality of them.

In the present invention, as polyhydric compounds which react with the organic acid represented by above Formula (F) to form polyhydric alcohol esters are preferably aliphatic polyhydric alcohols such as alcohols having 3 to 20 hydroxyl groups in the molecule. In the present invention, preferred as alcohols having 3 hydroxyl groups or more are those represented by Formula (H) below.

R″—(OH)ₘ Formula (H)

wherein R′ represents a m-valent organic group, m represents an integer at least 3, and the OH group represents a hydroxyl group. Particularly preferred are polyhydric alcohols of m of 3 or 4.

Examples of preferred polyhydric alcohols include, but are not limited to, adonitol, arabitol, 1,2,4-butanetriol, 1,2,3-hexanetriol, 1,2,6-hexanetriol, glycerin, diglycerin, erythritol, pentaerythritol, dipentaerythritol, tripentaerythritol, galactitol, glucose, cellobiose, inositol, mannitol, 3-methylpentane-1,3,5-triol, pinacol, sorbitol, trimethylolpropane, trimethylolethane, and xylitol. Particularly preferred are glycerin, trimethylolethane, trimethylolpropane, and pentaerythritol.

It is possible to synthesize esters of the organic acid represented by Formula (F) and polyhydric alcohol having 3 OH groups or more in the molecule, employing methods known in the art. A representative synthesis example is shown in the examples. One method is in which the organic acid represented by the above Formula (F) and polyhydric alcohol undergo etherification via condensation in the presence of, for example, acids, and another method is in which organic acid is converted to acid chloride or acid anhydride which is allowed to react with polyhydric alcohol, and still another method is in which the phenyl ester of organic acid is allowed to react with polyhydric alcohol. Depending on the targeted ester compound, it is preferable to select an appropriate method which results in a high yield.

The plasticizer represented by Formula (F) is preferably represented by Formula (G) below.

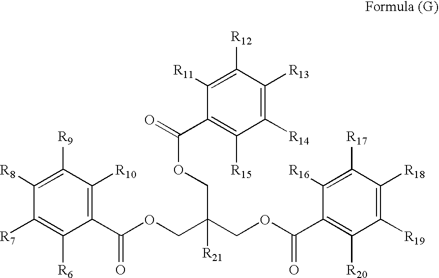

wherein R₆ to R₂₀ are each independently represent a hydrogen atom, a cycloalkyl group, an aralkyl group, an alkoxy group, a cycloalkoxy group, an aryloxy group, an aralkyloxy group, an acyl group, a carbonyloxyl group, an oxycarbonyl group or an oxycarbonyloxy group, provided that R₆ to R₂₀ may have further a substituent. R₂₁ represents a hydrogen atom or an alkyl group.

The above described cycloalkyl group, aralkyl group, alkoxy group, cycloalkoxy group, aryloxy group, aralkyloxy group, acyl group, carbonyloxyl group, oxycarbonyl group and oxycarbonyloxy group represented by R₆ to R₂₀ indicate the same as groups of R₁ to R₅ in Formula (1).

The molecular weight of the polyhydric alcohol esters prepared as above is not particularly limited, but is preferably 300-1,500, but is more preferably 400-1,000. A greater molecular weight is preferred due to reduced volatility, while a smaller molecular weight is preferred in view of the resulting water vapor permeability and compatibility with cellulose ester.

Specific compounds of polyhydric alcohol esters according to the present invention will now be exemplified.

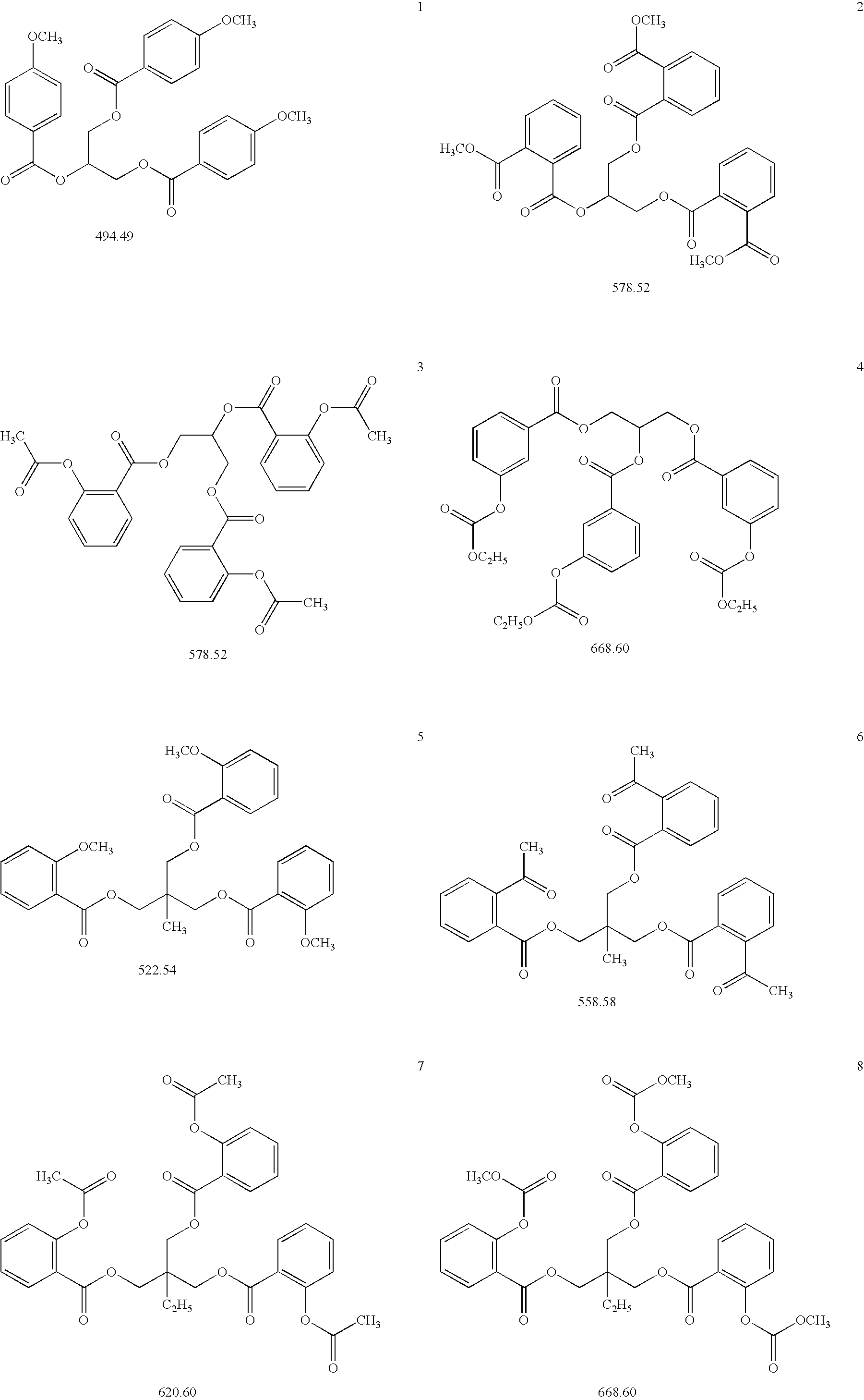

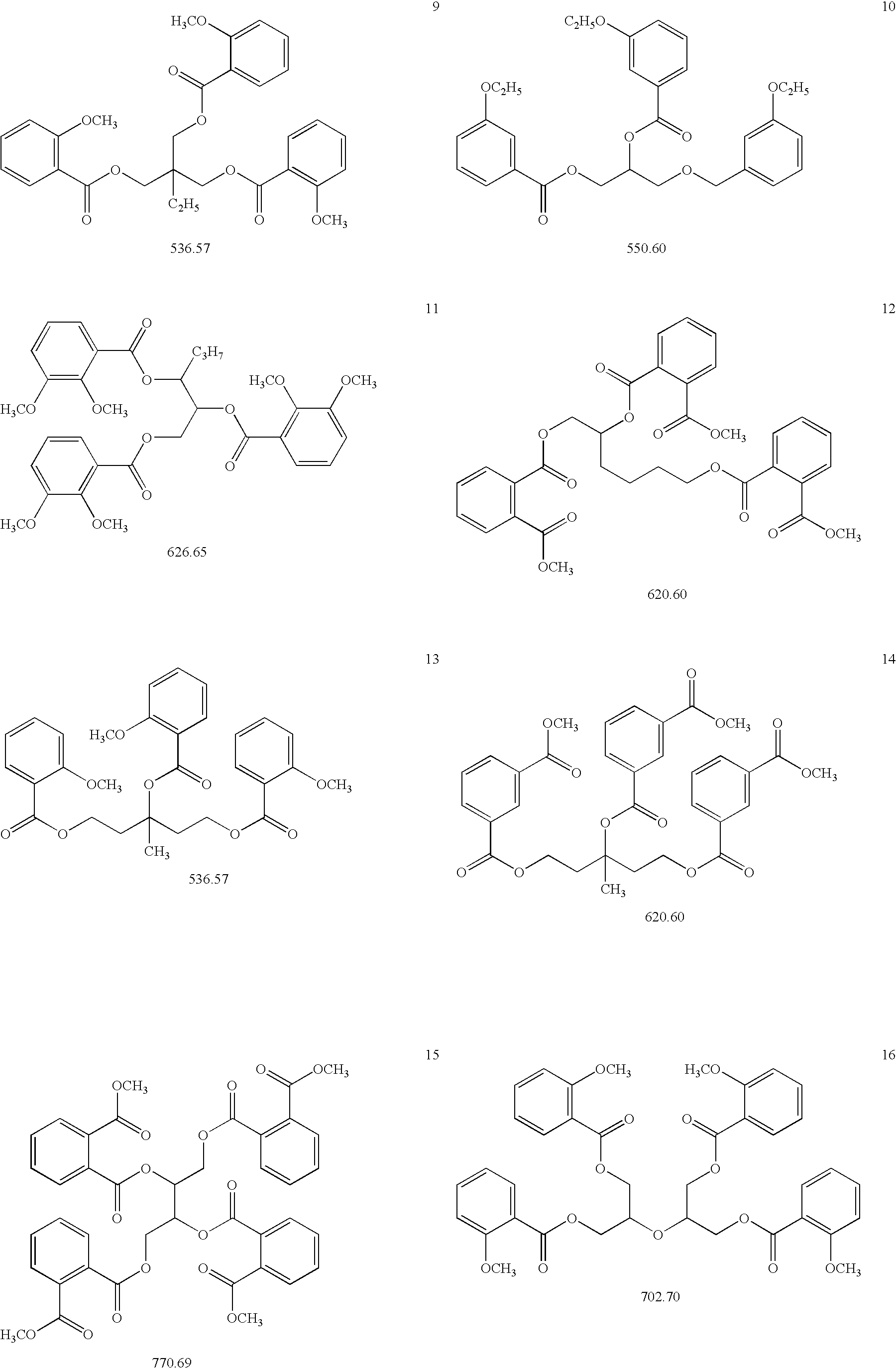

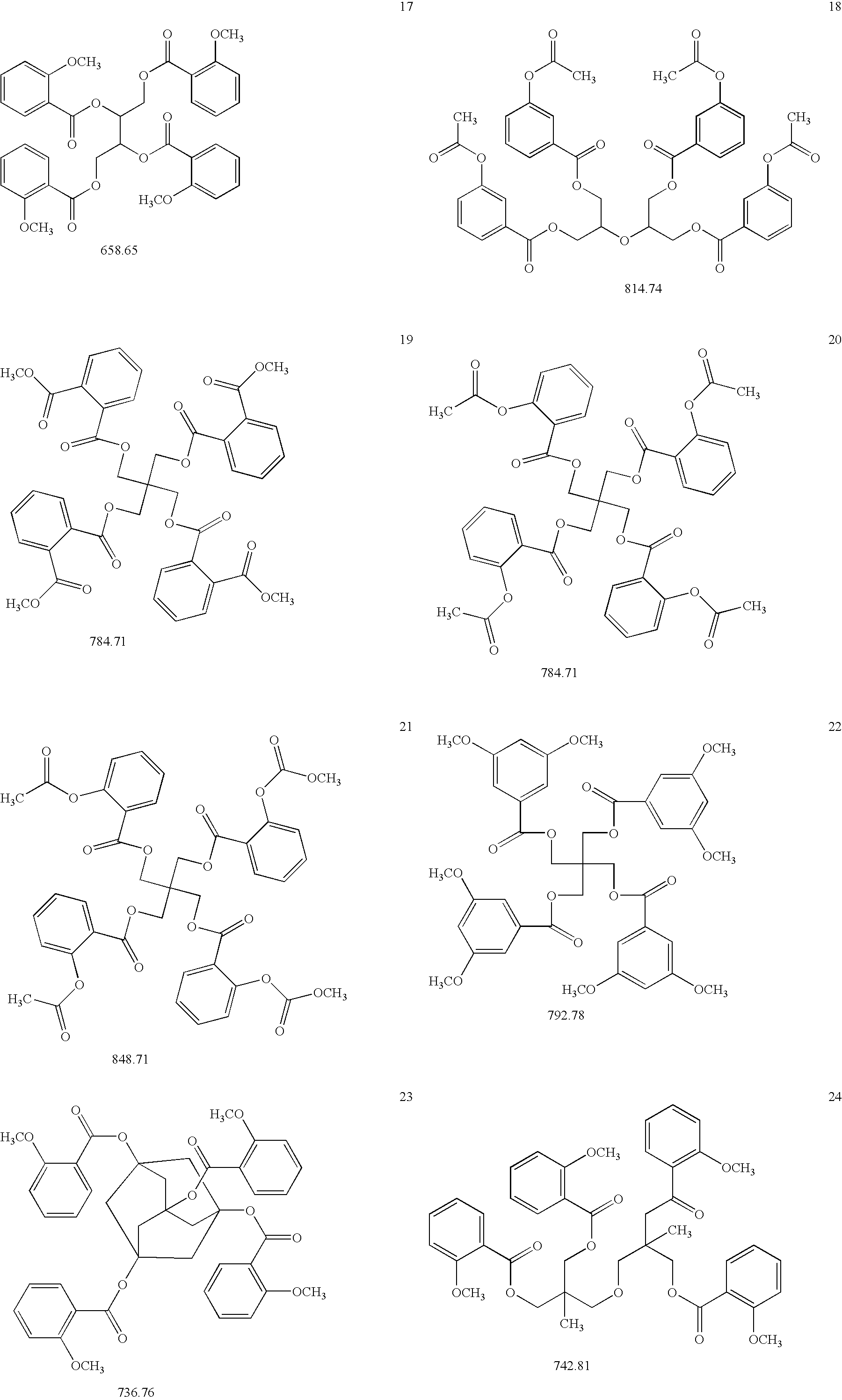

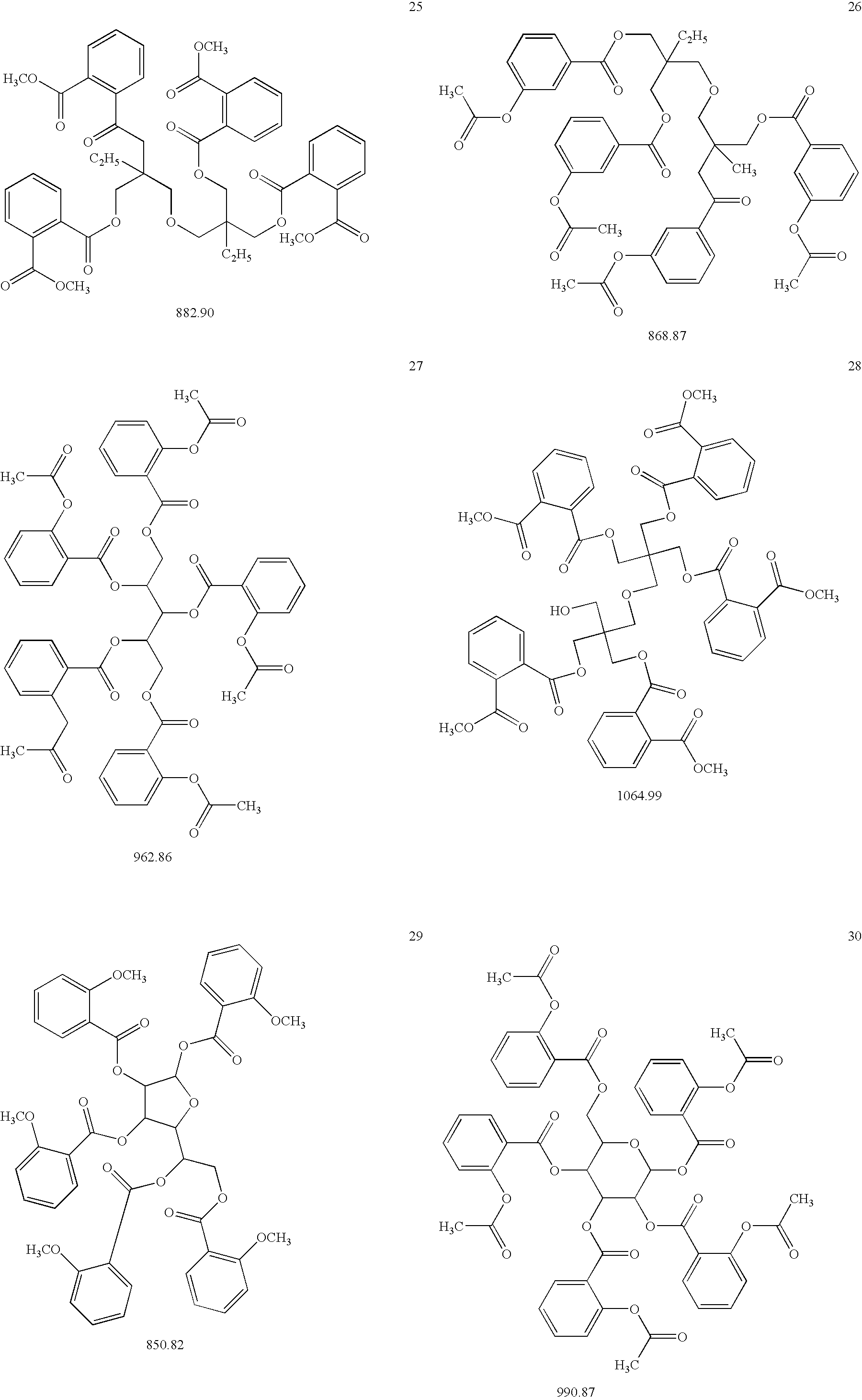

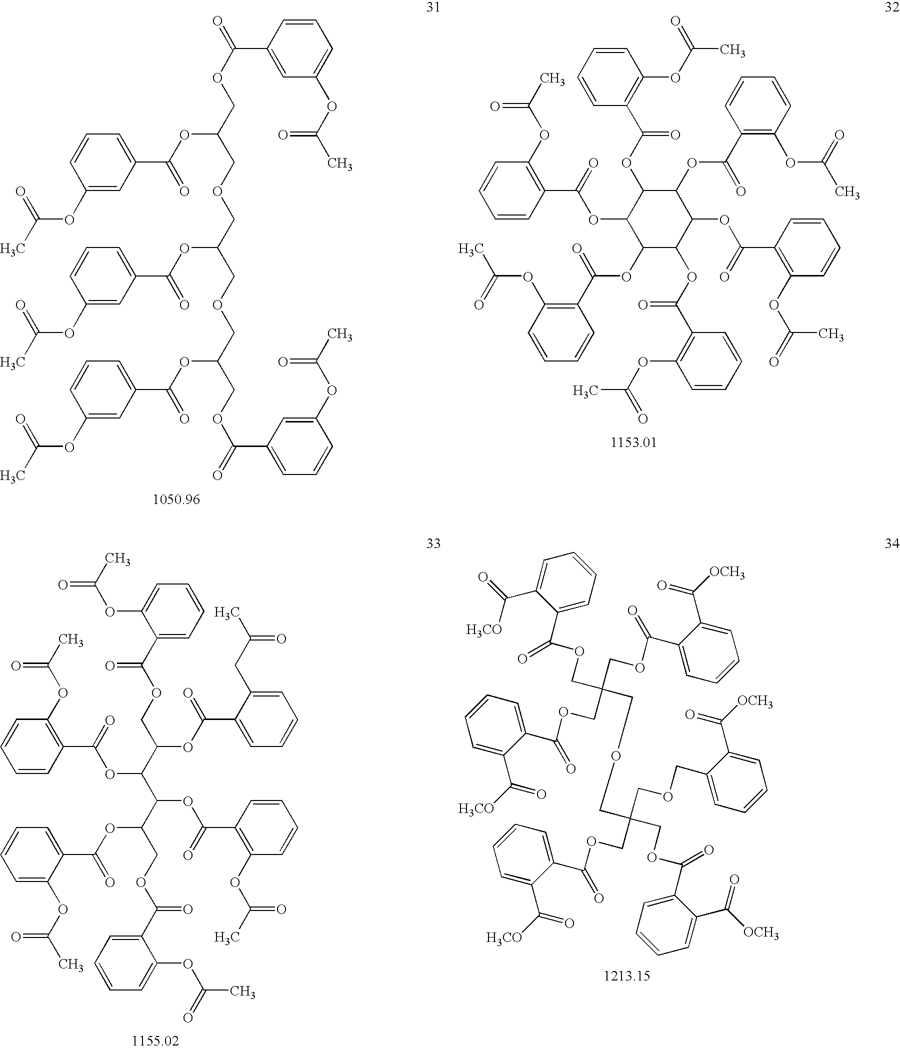

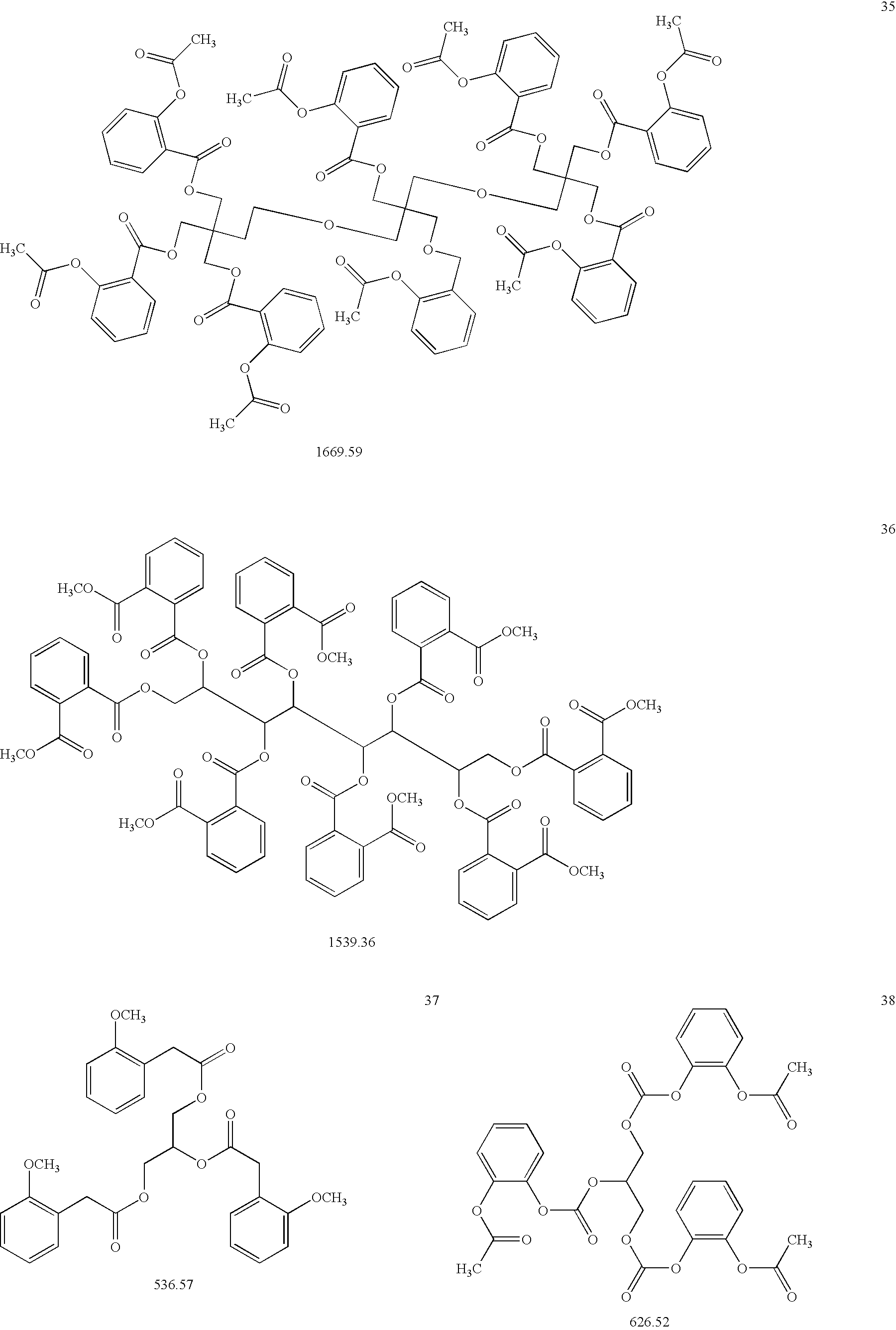

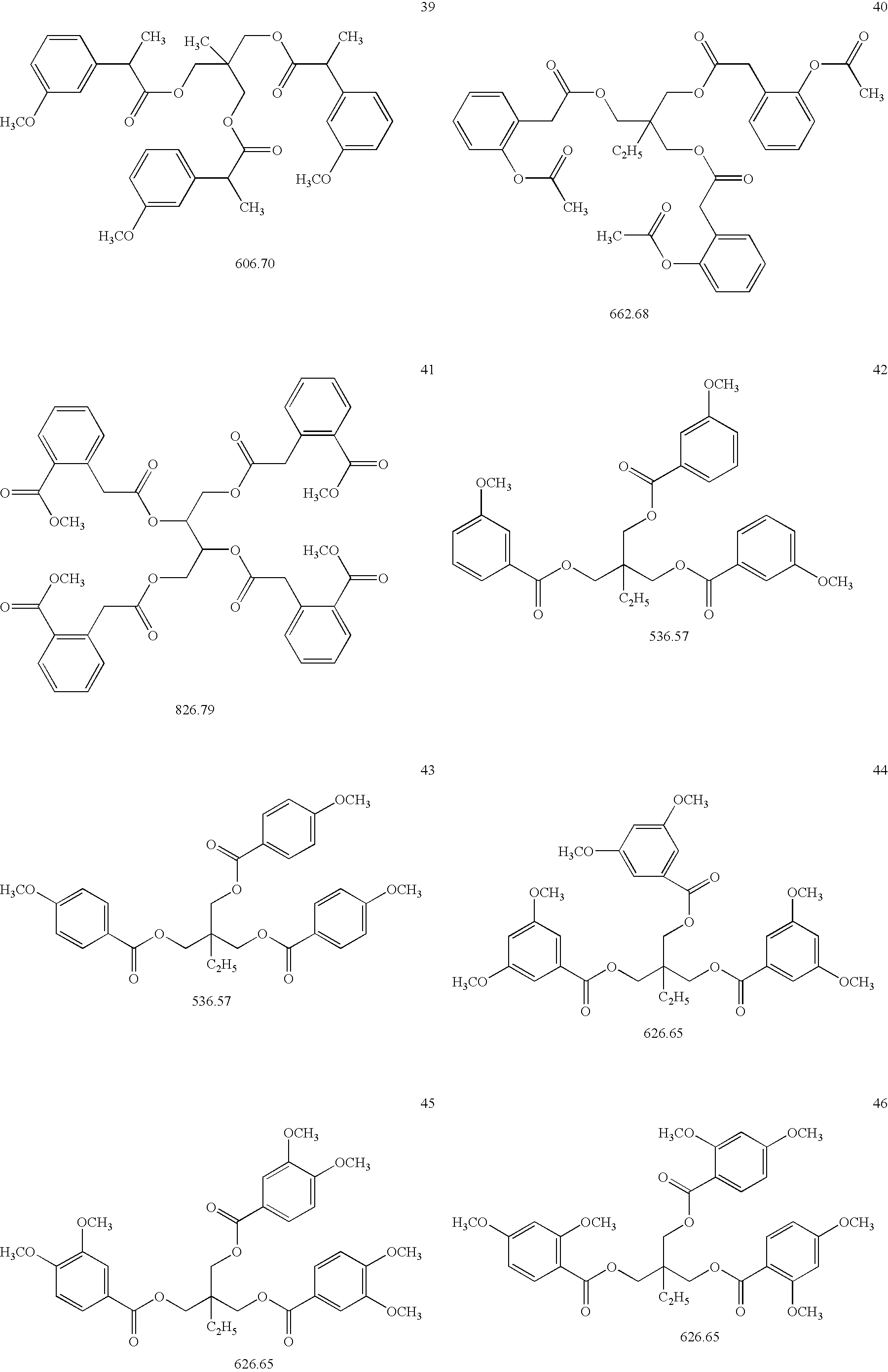

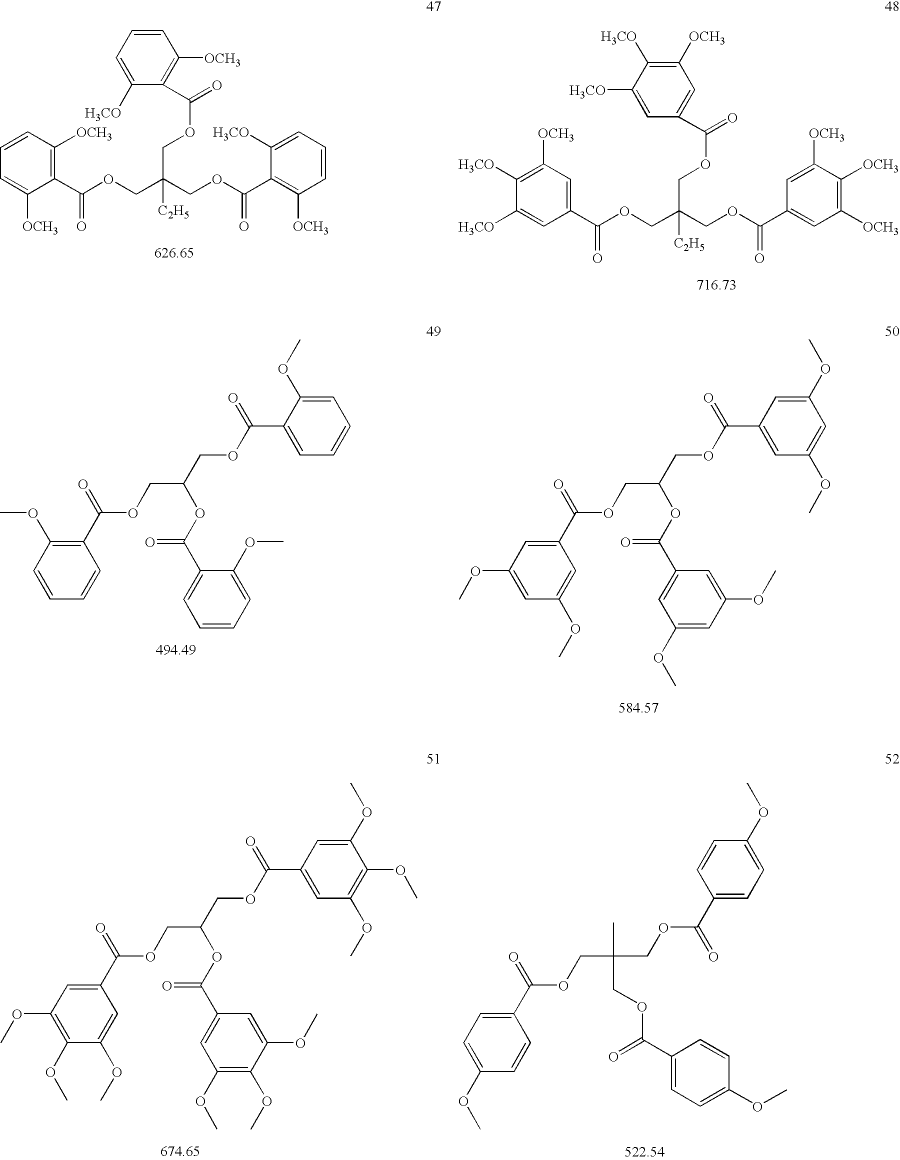

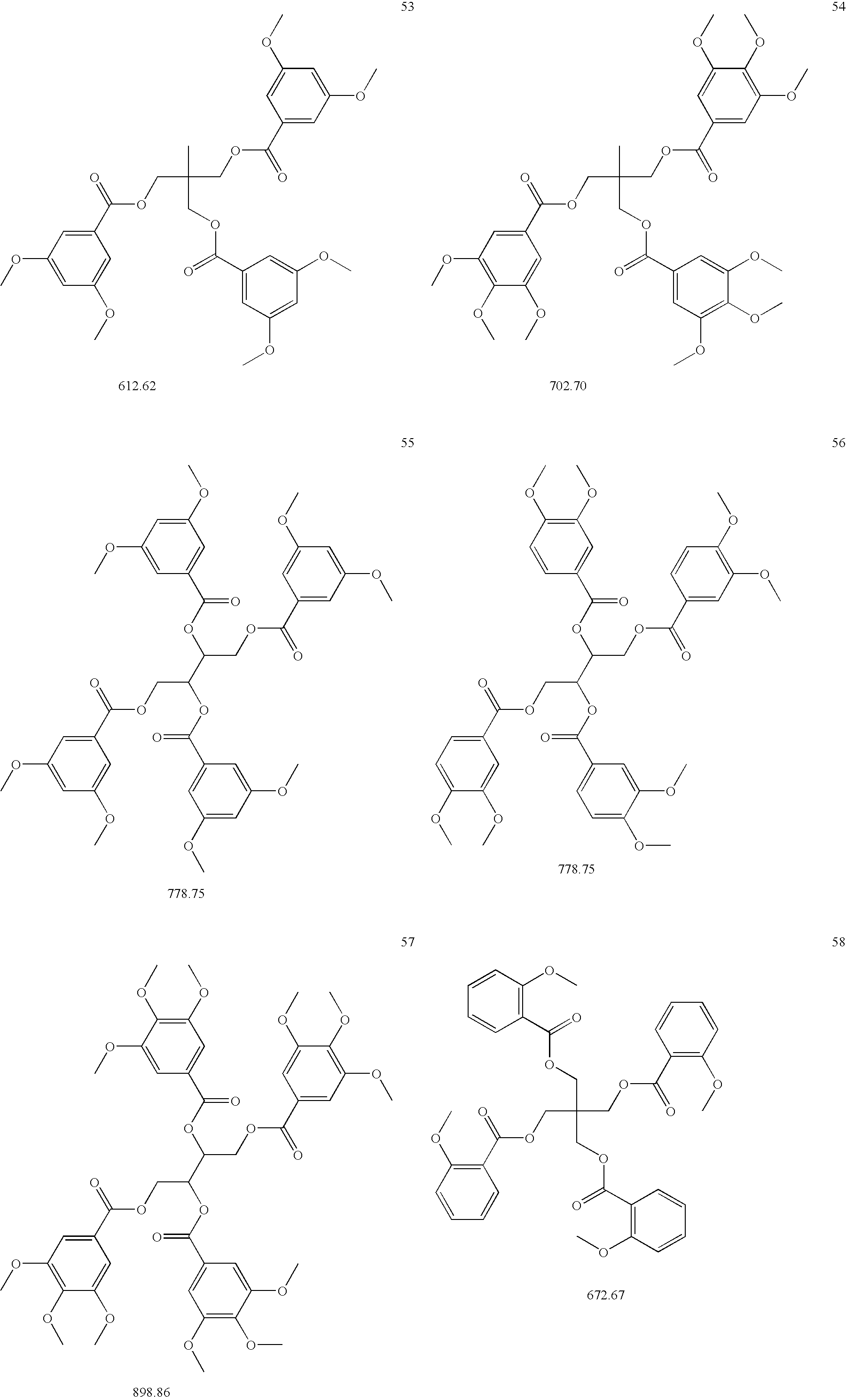

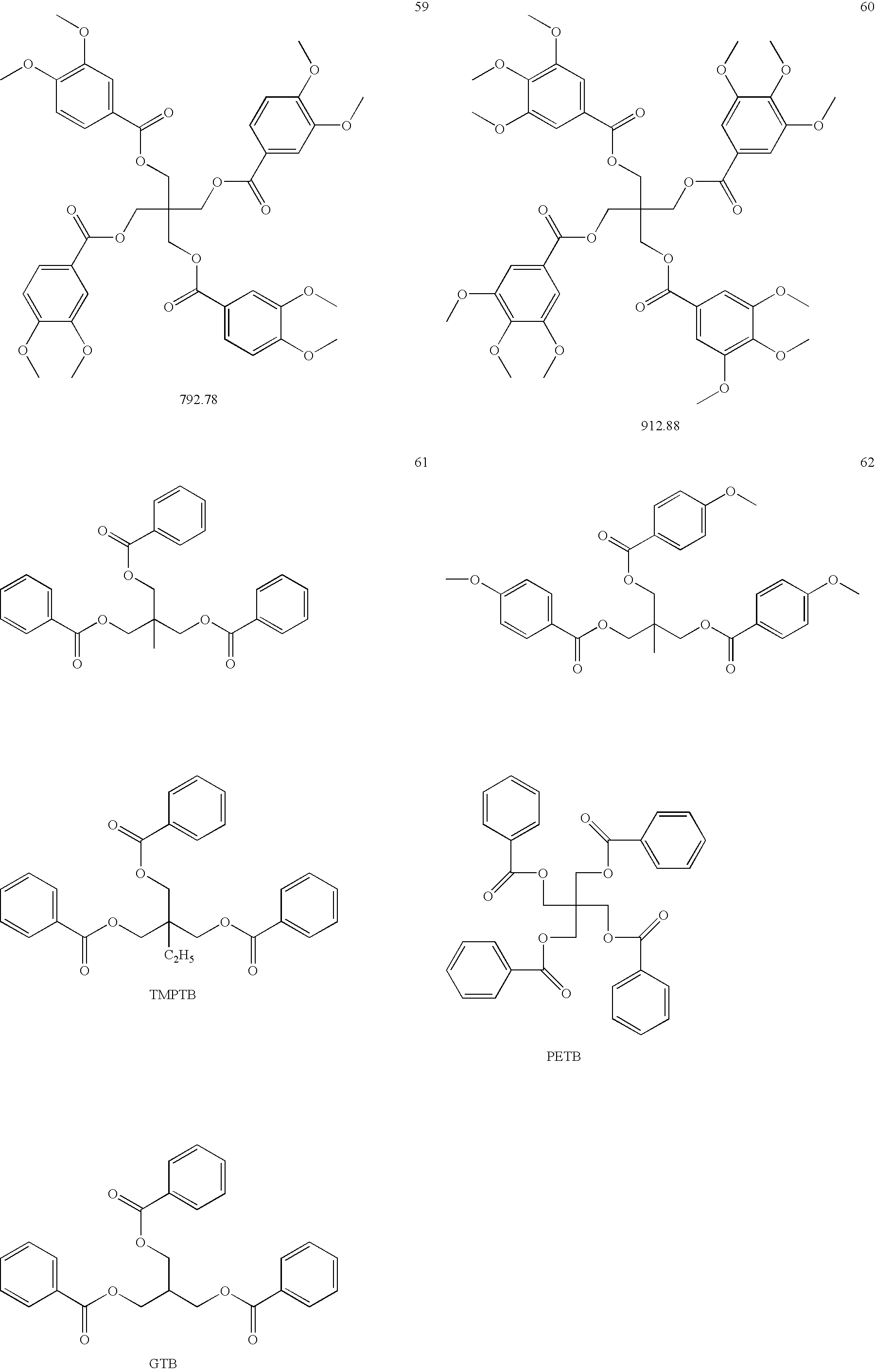

The cellulose ester film employed in the present invention incorporates in an amount of 1-25 percent by weight, as a plasticizer, at least one of the ester compounds which is produced employing the organic acid represented by above Formula (F) according to the present invention and a polyhydric alcohol having at least 3 OH groups in the molecule, but may simultaneously incorporate plasticizers other than the above.

Cellulose ester compounds composed of the organic acids represented by above Formula (F) of the plasticizers according to the present invention and polyhydric alcohol exhibit the feature of being capable of adding at a high addition rate due to its high compatibility with cellulose ester Consequently, no bleeding-out results by a combination of other plasticizers and additives, whereby, if desired, it is possible to simultaneously and easily employ other plasticizers and additives.

Further, when other plasticizers are simultaneously employed, the ratio of the incorporated plasticizers of the present invention is preferably at least 50 percent by weight with respect to the all the plasticizers, is more preferably at least 70 percent, but is still more preferably at least 80 percent. When the plasticizers of the present invention are employed in the above range, it is possible to achieve definite effects in which it is possible to enhance the flatness of cellulose ester film during melt-casting under simultaneous use of other plasticizers.

Other plasticizers which are simultaneously employed include aliphatic carboxylic acid-polyhydric alcohol based plasticizers, unsubstituted aromatic carboxylic acid or cycloalkylcaroboxylic acid-polyhydric alcohol based plasticizers described in paragraphs 30-33 of JP-A No. 2003-12823, or dioctyl adipate, dicyclohexyl adipate, diphenyl succinate, di-2-naphthyl-1,4-cyclohexane dicarboxylate, tricyclohexyl tricarbamate, tetra-3-methylphenyltetrahydrofurane-2,3,4,5-tetracarboxylate, tetrabutyl-1,2,3,4-cyclopentane teracarboxylate, triphenyl-1,3,5-cyclohexyl tricarboxylate, triphenylbenzne-1,3,5-etracarboxylate, multivalent carboxylates such as phthalic acid based plasticizers (for example, diethyl phthalate, dimethoxyethyl phthalate, dimethyl phthalate, dioctyl phthalate, dibutyl phthalate, di-2-ethylhexyl phthalate, dioctyl phthalate, dicyclohexyl phthalate, dicyclohexyl terephthalate, methylphthalyl methyl glycolate, ethylphthalyl ethyl glycolate, propylphthalyl propyl glycolate, and butylphthalyl butyl glycolate), citric acid based plasticizers (acetyltrimethyl citrate, acetyltriethyl citrate, and acetylbutyl citrate), phosphoric acid ester based plasticizers such as triphenyl phosphate, biphenyl diphenyl phosphate, butylenebis(diethyl phosphate), ethylenebis(diphenyl phosphate), phenylenebis(dibutyl phosphate), phenylenebis(diphenyl phosphate) (ADEKASTAB PFR, produced by Asahi Denka Kogyo K.K.), phenylenebis(dixylenyl phosphate) (ADEKASTAB FP500, produced by Asahi Denka Kogyo K.K.), bisphenol A diphenyl phosphate (ADEKASTAB FP600, produced by Asahi Denka Kogyo K.K.), and polyether based plasticizers such as the polymer polyesters described, for example, in paragraphs 49-56 of JP-A No. 2002-22956.

Of these, as noted above, the use of phosphoric acid ester based plasticizers during melt-casting tends to result in promoting hydrolysis of plasticizer itself or cellulose ester by strong acid generated from hydrolysis of plasticizers. Consequently, it is preferable to employ phthalic acid ester based plasticizers, multivalent carboxylic acid ester based plasticizers, citric acid ester based plasticizers, polyester based plasticizers, and polyether based plasticizers.

Further, coloration of the cellulose ester film of the present invention results in adverse optical effects. Consequently, the degree of yellow (Yellow Index YI) is preferably at most 3.0, but is more preferably at most 1.0. It is possible to determine the Yellow Index value based on JIS K 7103.

### (Matting Agents)

In order to provide aimed slip properties, as well as to optical and mechanical functions, it is possible to incorporate matting agents into the cellulose ester film of the present invention. Listed as such matting agents are minute particles of inorganic or organic compounds.

Preferably employed matting agents are spherical, rod-shaped, acicular, layered and tabular, Listed as matting agents are, for example, metal oxides such as silicon dioxide, titanium dioxide, aluminum oxide, zirconium oxide, calcium carbonate, kaolin, talc, calcined calcium silicate, hydrated calcium silicate, aluminum silicate, magnesium silicate, or calcium phosphate; minute inorganic particles composed of phosphoric acid salts, silicic acid salts, or carbonic acid salts; and minute crosslinking polymer particles. Of these, silicon dioxide is preferred due to a resulting decrease in film haze. It is preferable that these minute particles are subjected to a surface treatment, since it is possible to lower the film haze.

It is preferable to carry out the above surface treatment employing halosilanes, alkoxysilanes, silazane, or siloxane. As the average diameter of minute particles increases, slipping effects are enhanced. On the other hand, as it decreases, the resulting transparency increases. Further, the average diameter of the primary particles of the minute particles is customarily in the range of 0.01-1.0 μm, is preferably 5-50 nm, but is more preferably 7-14 nm. These minute particles are preferably employed to result in unevenness of 0.01-1.0 μm of the cellulose ester film surface.

Listed as minute silicon dioxide particles are AEROSIL 200, 200V, 300, R972, R972V, R974, R202, R812, OX50, TT600, and NAX50, all produced by Nihon Aerosil Corp. and KE-P10, KE-P30, KE-P100, and KE-P150, all produced by NIPPON SHOKUBAI Co. Of these, preferred are AEROSIL 2000V, R972, R972V, R974, R202, and R812.

When two types of the above are employed in combination, they may be mixed at an optional ratio and then employed. It is possible to use minute particles which differ in their average particle diameter and materials, such as AEROSIL 200V and R972V at a ratio of 0.1:99.9, in terms of weight ratio.

These matting agents are added employing a method in which they are kneaded. Another method is that matting agents are previously dispersed and the resulting dispersion is blended with cellulose ester and/or plasticizers and/or UV absorbers. Thereafter, the resulting mixture is dispersed and subsequently solids are obtained by vaporizing the solvents or by performing precipitation. The resulting product is preferably employed in the production process of a cellulose ester melt since it is possible to uniformly disperse the matting agents into cellulose resins.

It is possible to incorporate the above matting agents to improve mechanical, electrical, and optical characteristics.

As the added amount of these minute particles increases, the slipping properties of the resultant cellulose ester film are enhanced, while haze increases. The content is preferably 0.001-5 percent by weight, is more preferably 0.005-1 percent by weight, but is still more preferably 0.01-0.5 percent by weight.

The haze value of the cellulose ester film of the present invention is preferably at most 1.0 percent, but is more preferably at most 0.5 percent, since optical materials at a haze value of at least 1.0 percent result in adverse effects. It is possible to determine the haze value based on JIS K 7136.

In the melting and film making process, the film constituting material is required to produce only a small amount of volatile component or no volatile component at all. This is intended to reduce or avoid the possibility of foaming at the time of heating and melting, thereby causing a defect inside the film or deterioration in the flatness on the film surface.

When the film constituting material is melted, the percentage of the volatile component content is 1 percent by mass or less, preferably 0.5 percent by mass or less, more preferably 0.2 percent by mass or less, still more preferably 0.1 percent by mass or less. In the embodiment of the present invention, reduction in heating from 30° C. to 250° C. is measured and calculated using a differential thermogravimetric analyzer (TG/DTA200 by Seiko Electronic Industry Co., Ltd.). This amount is used to represent the amount of the volatile component contained.

Before film formation or at the time of heating, the aforementioned moisture and volatile component represented by the aforementioned solvent is preferably removed from the film constituting material to be used. It can be removed according to a known drying technique. Heating technique, reduced pressure technique or heating/pressure reduction technique can be utilized. The removing operation can be done in the air or under the atmosphere where nitrogen is used as an inert gas. When the aforementioned known drying technique is used, the temperature should be in such a range that the film constituting material is not decomposed. This is preferred to maintain satisfactory film quality.

Drying before formation of a film reduces the possibility of volatile components being generated. It is possible to dry the resin singly or to dry after separation into a mixture or compatible substance between the resin and at least one of the film constituting materials other than resin. The drying temperature is preferably 100° C. or more. If the material to be dried contains a substance having a glass transition temperature, the material may be welded and may become difficult to handle when heated to the drying temperature higher than the glass transition temperature thereof. Thus, the drying temperature is preferably below the glass transition temperature. If a plurality of substances have glass transition temperatures, the lower glass transition temperature is used as a standard. This temperature is preferably 70° C. or more without exceeding (glass transition temperature −5)° C., more preferably 110° C. or more without exceeding (glass transition temperature −20)° C. The drying time is preferably 0.5 through 24 hours, more preferably 1 through 18 hours, still more preferably 15 through 12 hours. If the drying temperature is too low, the volatile component removal rate will be reduced and the drying time will be prolonged. Further, the drying process can be divided into two steps. For example, the drying process may contain the steps; a preliminary drying step for material storage and an immediately preceding drying step to be implemented immediately before film formation through one week before film formation.

### <The Melt-Casting Film Forming Method>

The cellulose ester film of the present invention is preferably formed by the melt-casting film forming method.

The melt-casting film forming method by heating and melting without using solvent as a solution-casting method (for example methylene chloride) can be classified to a melt extrusion molding method, a press molding method, an inflation method, an injection molding method, a blow molding method and an orientation molding method. Of these, the melt extrusion method is preferred in order to ensure the polarizing plate protective film characterized by excellent mechanical strength and surface accuracy.

The following describes the film manufacturing method as an embodiment of the present invention with reference to the melt extrusion method.

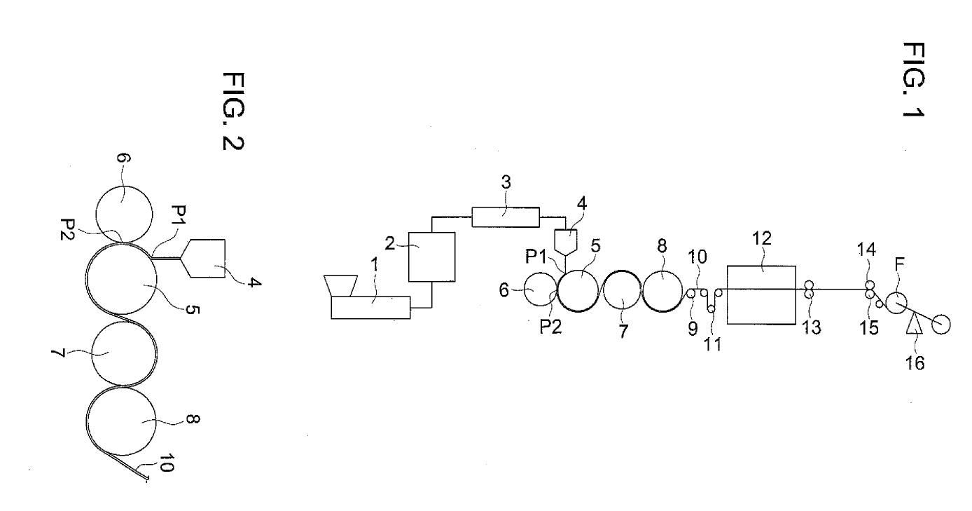

FIG. 1 is a schematic flow sheet representing one embodiment of an apparatus for embodying the manufacturing method of the optical film as an embodiment of the present invention, FIG. 2 is an enlarged flow sheet representing the portion from flow casting die to the cooling roll.

In the film manufacturing method as an embodiment of the present invention shown in FIGS. 1 and 2, the film material such as a cellulose resin is mixed and then melt welding is performed by the extruder 1 from a flow casting die 4 to a first cooling roll 5 so as to circumscribe the material with the first cooling roll 5. Further, the material is cooled and solidified through sequential circumscription with a total of three cooling rolls including the second cooling roll 7, third cooling roll 8, whereby a film 10 is produced. Then both ends of the film 10 separated by the separation roll 9 are sandwiched by the orientation apparatus 12 and this film is oriented across the width. After that, the film is wound by a winding apparatus 16. Further, to improve the flatness, a touch roll 6 is provided to press (pinch) the melted film against a surface of a first cooling roll 5. The surface of this touch roll 6 is elastic and a nip is formed between this roll and the first cooling roll 5. The details of the touch roll 6 will be discussed later.

In the cellulose ester film manufacturing method as an embodiment of the present invention, melt extrusion conditions can be the same as those used for the thermoplastic resin including other polyesters. In this case, the material is preferably dried in advance. A vacuum or pressure reduced dryer and a dehumidified hot air dryer is preferably used to dry so that the moisture will be 1000 ppm or less, more preferably 200 ppm or less.

For example, the cellulose ester based resin dried by hot air, under vacuum or under reduced pressure is extruded by an extruder 1, and is melted at an extrusion temperature of about 200 through 300° C. This material is then filtered by a leaf disk type filter 2 or the like to remove foreign substances.

When the material is introduced from the supply hopper (not illustrated) to the extruder 1, it is preferred to create a vacuum, pressure reduced environment or inert gas atmosphere, thereby preventing decomposition by oxidation.

If such additive as a plasticizer is not mixed in advance, it can be added and kneaded during the extrusion process in the extruder. A mixing apparatus such as a static mixer 3 is preferably used to ensure uniform addition.

In the embodiment of the present invention, the cellulose resin and the additives such as a stabilizer to be added as required are mixed preferably before melting. The cellulose resin and stabilizer are more preferably mixed first. A mixer may be used for mixing. Alternatively, mixing may be done in the cellulose resin preparation process, as described above. When the mixer is used, it is possible to use a general mixer such as a V-type mixer, conical screw type mixer, horizontal cylindrical type mixer, Henschel mixer and ribbon mixer.

As described above, after the film constituting material has been mixed, the mixture can be directly melted by the extruder 1, thereby forming a film. It is also possible to make such arrangements that, after the film constituting material has been pelletized, the aforementioned pellets are melted by the extruder 1, thereby forming a film. Further, when the film constituting material contains a plurality of materials having different melting points, melting is performed at the temperature where only the material of lower melting point can be melted, thereby producing a patchy (spongy) half-melt. This half-melt is put into the extruder 1, whereby a film is formed. When the film constituting material contains the material that is easily subjected to thermal decomposition, it is preferred to use the method of creating a film directly without producing pellets for the purpose of reducing the number of melting, or the method of producing a patchy half-melt followed by the step of forming a film, as described above.

Various types of extruders sold on the market can be used as the extruder 1, and a melting and kneading extruder is preferably used. Either the single-screw extruder or twin screw extruder may be utilized. If a film is produced directly from the film constituting material without manufacturing the pellet, an adequate degree of kneading is required. Accordingly, use of the twin screw extruder is preferred. However, the single-screw extruder can be used when the form of the screw is modified into that of the kneading type screw such as a Maddox type, Unimelt type and Dulmage type, because this modification provides adequate kneading. When the pellet and patchy half-melt is used as a film constituting material, either the single-screw extruder and twin screw extruder can be used.

In the process of cooling inside the extruder 1 or subsequent to extrusion, the density of oxygen is preferably reduced by replacement with such an inert gas as nitrogen gas or by pressure reduction.

The desirable conditions for the melting temperature of the film constituting material inside the extruder 1 differ depending on the viscosity of the film constituting material and the discharge rate or the thickness of the sheet to be produced. Generally, the melting temperature is Tg or more without exceeding Tg+100° C. with respect to the glass transition temperature Tg of the film, preferably Tg+10° C. or more without exceeding Tg+90° C. The melting viscosity at the time of extrusion is 10 through 100000 poises, preferably 100 through 10,000 poises, Further, the film constituting material retention time in the extruder 1 is preferably shorter. This time is within 5 minutes, preferably within 3 minutes, more preferably within 2 minutes, The retention time depends on the type of the extruder 1 and conditions for extrusion, but can be reduced by adjusting the amount of the material supplied, and L/D, screw speed, and depth of the screw groove.

The shape and speed of the screw of the extruder 1 are adequately selected according to the viscosity of the film constituting material and discharge rate. In the embodiment of the present invention, the shear rate of the extruder 1 is 1/sec through 10,000/sec, preferably 5/sec through 1000/sec, more preferably 10/sec through 100/sec.

The extruder 1 in the embodiment of the present invention can generally be obtained as a plastic molding machine.

The film constituting material extruded from the extruder 1 is sent to the flow casting die 4 and is extruded from the slit of the flow casting die 4 in the form of a film. There is no restriction to the flow casting die 4 if it can be used to manufacture a sheet and film. The material of the flow casting die 4 is exemplified by hard chromium, chromium carbide, chromium nitride, titanium carbide, titanium carbonitride, titanium nitride, cemented carbide and ceramics (e.g., tungsten carbide, aluminum oxide, chromium oxide), which are sprayed or plated, and are subjected to surface treatment by buffing, lapping with a grinding wheel having a count 1000 and after, plane cutting with a diamond wheel having a count 1000 (cutting in the direction perpendicular to the resin flow), electrolytic polishing, and composite electrolytic polishing. The preferred material of the lip of the flow casting die 4 is the same as that of the flow casting die 4. The surface accuracy of the lip is preferably 0.5 S or less, more preferably 0.2 S or less.

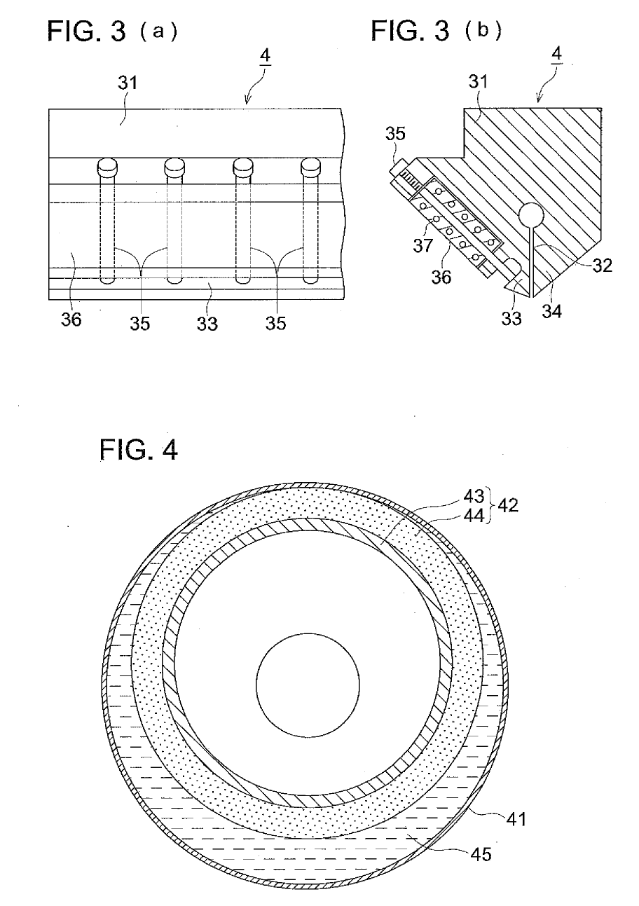

The slit of this flow casting die 4 is constructed so that the gap can be adjusted. This is illustrated in FIG. 3. One of a pair of lips constituting the slit 32 of the flow casting die 4 is a flexible lip 33 which is less rigid and more likely to deform. The other is a stationary lip 34. A great many heat bolts 35 are arranged at a predetermined pitch across the width of the flow casting die 4, namely, along the length of the slit 32. Each of the heat bolts 35 is provided with a block 36, which is equipped with an embedded electric heater 37 and coolant passage. Each of the heat bolts 35 is led through each of the blocks 36 in the longitudinal direction. The base of the heat bolt 35 is secured to the die body 31, and the tip end is engaged with the external surface of the flexible lip 33. While the block 36 is air-cooled at all times, the input of the embedded electric heater 37 is adjusted, and the temperature of the block 36 is also adjusted. This procedure provides thermal extension and contraction of the heat bolt 35, and displaces the flexible lip 33, whereby the thickness of the film is adjusted. A thickness gauge is arranged at required positions in the wake of the die. The information on web thickness having been detected by this gauge is fed back to the control apparatus. The information on the thickness is compared with the preset thickness information by a control apparatus, and the power or on-rate of the heat generating member of the heat bolt can be controlled in response to the signal of correction control amount coming from this apparatus. The heat bolt preferably has a length of 20 through 40 cm and a diameter of 7 through 14 mm. A plurality of heat bolts (e.g., scores of heat bolts) are arranged preferably at a pitch of 20 through 40 mm. Instead of the heat bolt, it is possible to provide a gap adjusting member mainly made up of a bolt that adjusts the slip gap by manual movement in the longitudinal direction along the axis. The slit gap adjusted by the gap adjusting member is normally 200 through 1,000 μm, preferably 300 through 800 μm, more preferably 400 through 600 μm.

The first through third cooling rolls are seamless steel tubes having a wall thickness of about 20 through 30 mm, and the surfaces thereof are mirror-finished. A tube is provided inside to allow coolant to flow, and the heat from the film on the roll is absorbed by the coolant flowing through the tube. Of these first through third cooling rolls, the first cooling roll 5 corresponds to the rotary support member of the present invention.

In the meantime, the surface of the touch roll 6 engaged with the first cooling roll 5 is elastic and is deformed along the surface of the first cooling roll 5 by the pressure applied to the first cooling roll 5, whereby a nip is formed between the touch roll 6 and the first roll 5. To be more specific, the touch roll 6 corresponds to the rotary pinch member of the present invention.

FIG. 4 is a schematic cross sectional view of an equipment (hereinafter referred to as “touch roll A”) of the touch roll 6. As illustrated, the touch roll A is made up of an elastic roller 42 arranged inside the flexible metallic sleeve 41.

The metallic sleeve 41 is made of stainless steel having a thickness of 0.3 mm, and is flexible. If the metallic sleeve 41 is too thin, the strength will be insufficient. If the thickness is excessive, elasticity will be insufficient. This signifies that the thickness of the metallic sleeve 41 is preferably 0.1 mm or more without exceeding 1.5 mm. To be more specific, if the thickness of the metallic sleeve 41 is below 0.1 mm, the strength becomes insufficient, and the sleeve breaks after a short-term use. In the meantime, if the thickness of the metallic sleeve 41 is above 1.5 mm, elasticity is insufficient, and this prevents deformation from occurring along the surface of the first cooling roll 5. The elastic roller 42 is structured in such a way that a rubber 44 is arranged on the surface of the metallic inner cylinder 43 which is freely rotated through the bearing, and is shaped into a roll. When the touch roll A is pressed against the first cooling roll 5, the elastic roller 42 causes the metallic sleeve 41 to be pressed against the first cooling roll 5. The metallic sleeve 41 and elastic rollers 42 are deformed in conformity to the shape of the first cooling roll 5, whereby a nip is formed between this roll and the first cooling roll. Coolant 45 flows through the space formed between the metallic sleeve 41 and the elastic roller 42.

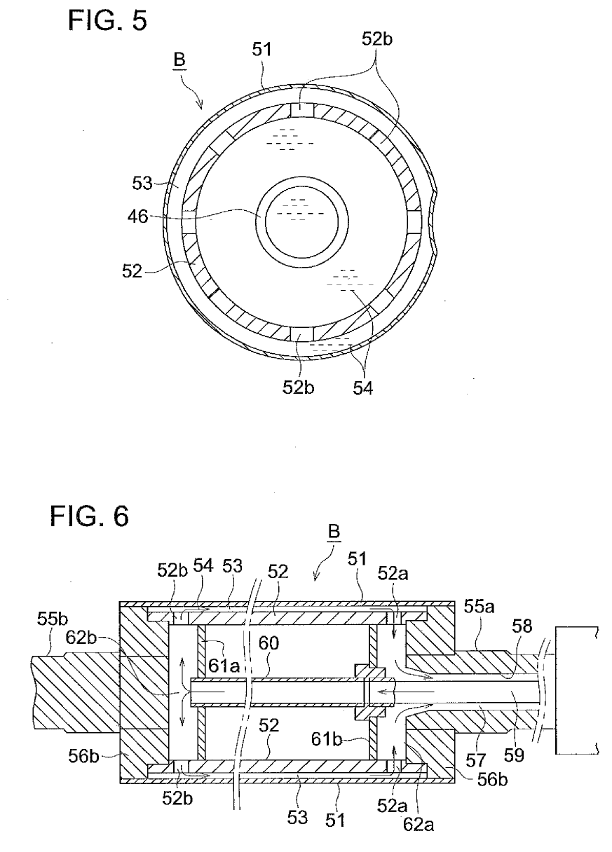

FIGS. 5 and 6 show a touch roll B as another embodiment of the rotary pinch member. The touch roll B approximately includes an outer cylinder 51 made of a flexible and seamless stainless steel tube (thickness: 4 mm), and a highly rigid metallic inner cylinder 52 arranged on the same axial form inside this outer cylinder 51. Coolant 54 flows through the space 53 between the outer cylinder 51 and the inner cylinder 52. To put it in greater details, the touch roll B is constructed in such way that the rotary shafts 55a and 55b on both ends are provided with outer cylinder support flanges 56a and 56b, and a thin metallic outer cylinder 51 is mounted between the outer peripheral portions on both of these outer cylinder support flanges 56a and 56b. A fluid supply tube 59 is arranged in the same axial form in the fluid outlet 58 which is formed on the axial portion of the rotary shaft 55a to form a fluid return passage 57. This fluid supply tube 59 is fixed by connection with the fluid bush 60 arranged on the axial portion inside the thin metallic outer cylinder 51. Both ends of this fluid bush 60 are provided, respectively with the inner cylinder support flanges 61a and 61b. A metallic inner cylinder 52 having a thickness of about 15 through 20 mm is mounted over the distance from between the outer peripheral portions of these inner cylinder support flanges 61a and 61b to the outer cylinder support flange 56b on the other end. A coolant flow space 53 of about 10 mm is formed between this metallic inner cylinder 52 and thin metallic outer cylinder 51. An outlet 52a and inlet 52b for communicating with the flow space 53 and intermediate passages 62a and 62b outside the inner cylinder support flanges 61a and 61b are formed in the vicinity of both ends of the metallic inner cylinder 52, respectively.

To provide softness, flexibility and stability comparable to that of rubber elasticity, the outer cylinder 51 is made as thin as possible to the extent to which the thin cylinder theory of elastodynamics is applicable. The flexibility evaluated according to the thin cylinder theory is expressed in terms of wall thickness t/roll radius r. The smaller the t/r, the higher the flexibility. The optimum flexibility of the touch roll 8 is achieved when t/r≦0.03. Normally, a commonly used touch roll is long from side to side, with a roll diameter R of 200 through 500 mm (roll radius r=R/2), a roll effective width L of 500 through 1200 mm, wherein r/L<1. As shown in FIG. 6, when the roll diameter R is 300 mm and the roll effective width L is 1200 mm, the wall thickness t is applicable to 150×0.03=4.5 mm or less. When pressure is applied to the melted sheet width of 1300 mm at the average linear pressure of 98 N/cm, the wall thickness of the outer cylinder 51 is 3 mm as compared with the rubber roll of the same profile. Thus, approximately the same value as the nip width of 12 mm of this rubber roll is recorded when the equivalent spring constant is the same and the nip width k between the outer cylinder 51 and cooling roll is also about 9 mm. Thus, it is apparent that pressure can be applied under the same conditions. It should be noted that deflection is about 0.05 through 0.1 mm at the aforementioned nip width k.

In the above description, t/r≦0.03 is assumed as constituting the optimum condition. In the case of a general roll diameter R of 200 through 500 mm, especially in the range of 2 mm≦t≦5 mm, sufficient flexibility is ensured, and the thickness can be easily reduced by machining. This provides a very practical range. If the wall thickness is 2 mm or less, high-precision machining will be disabled by elastic deformation at the time of machining, and manufacturing will be difficult.

The equivalent of the aforementioned 2 mm≦t≦5 mm is 0.008≦t/r≦0.05 for a common roll diameter. For practical purposes, the wall thickness should be increased in proportion to the roll diameter when the t/r≈ is 0.03. For example, the range is t=2 through 3 mm when the roll diameter R is 200, and t=4 through 5 mm when roll diameter R is 500.

The aforementioned touch rolls A and B are energized in the direction of the first cooling roll by the energizing device (not illustrated). The value F/W (linear pressure) obtained by dividing the energizing force F of the energizing device by width W of the film in the nip along the rotary shaft of the first cooling roll 5 is set at 9.8 to 147 N/cm. According to the present embodiment, a nip is formed between the touch rolls A and B, and the first cooling roll 5. Flatness can be corrected while the nip passes through the aforementioned nip. Accordingly, as compared to the case where the touch roll is made up of a rigid body without a nip being formed between this roll and the first cooling roll, the film is pressed at a smaller linear pressure for a longer time. This arrangement ensures more reliable correction of the flatness. To be more specific, if the linear pressure is smaller than 9.8 N/cm, the die line cannot sufficiently be removed. Conversely, of the linear pressure is greater than 147 N/cm, the film cannot pass through the nip, with the result that irregularity will be produced.

Further, because the surfaces of the touch rolls A and B are made of metal, they can be made smoother than when the surfaces of the touch rolls are made of rubber, so that a very smooth film can be produced. Ethylene propylene rubber, neoprene rubber and silicon rubber can be used to manufacture the elastic body 44 of the elastic roller 42.

To ensure effective removal of the die line by the touch roll 6, it is important that the viscosity of the film sandwiched and pressed by the touch roll 6 should be within a pertinent range. Further, the cellulose resin is known to be subjected to a greater change in the viscosity by temperature. Thus, in order to ensure that the viscosity of the cellulose film sandwiched and pressed by the touch roll 6 is set in a pertinent range, the temperature of the cellulose film sandwiched and pressed by the touch roll 6 should be set in a pertinent range. The present inventors have found out that, when the glass transition temperature of the cellulose ester film is assumed as Tg, the film temperature T immediately before the film is sandwiched and pressed by the touch roll 6 should be set so as to meet Tg<T<Tg+110° C. If the film temperature T is lower than Tg, film viscosity will be too high to correct the die line. Conversely, if the film temperature T is higher than Tg+110° C., uniform adhesion between the film surface and roll cannot be achieved, with the result that the die line cannot be corrected. This temperature is preferably Tg+10° C.<T<Tg+90° C., more preferably Tg+20° C.<T<Tg+70° C. The temperature of the cellulose ester film sandwiched and pressed by the touch roll 6 can be set to a pertinent range by adjusting the length L from the nip between the first cooling roll 5 and touch roll 6, along the rotational direction of the first cooling roll 5, to the position P1 wherein the melt extruded from the flow casting die 4 is brought in contact with the first cooling roll 5.

In the embodiment of the present invention, carbon steel, stainless steel and resin are preferably used as a material of the first roll 5 and second roll 6. Further, the surface accuracy is preferably improved. The surface roughness is preferably 0.3 S or less, more preferably 0.01 S or less.

In the embodiment of the present invention, it has been found out that, if the pressure is reduced to 70 kPa or less in the portion from the opening (lip) of the flow casting die 4 to the first roll 5, the aforementioned die line can be effectively corrected. In this case, this pressure is preferably reduced to 50 kPa or more without exceeding 70 kPa. There is no restriction to the method for ensuring that the pressure in the portion from the opening (lip) of the flow casting die 4 to the first roll 5 is kept at 70 kPa or less. For example, it is possible to reduce the pressure if the portion around the roll from the flow casting die 4 is covered with a pressure resistant member. In this case, a suction apparatus is preferably heated by a heater so that a sublimate is not deposited on the apparatus per se. In the embodiment of the present invention, if the suction pressure is too small, a sublime cannot be effectively sucked. This requires an appropriate suction pressure to be selected.

In the embodiment of the present invention, while the melted film-like cellulose ester-based resin coming from the flow casting die 4 is conveyed by sequential contact with the first roll (the first cooling roll) 5, second cooling roll 7 and third cooling roll 8, the resin is cooled and solidified, whereby an unoriented cellulose ester based resin film 10 is obtained.

In the embodiment of the present invention shown in FIG. 1, the film 10 which is separated from the third cooling roll 8 by the separation roll 9 and is cooled, solidified and unoriented is led to the drawing machine 12 through the dancer roll (film tension adjusting roll) 11. The film 10 is drawn in the lateral direction (across the width) by this drawing machine. This process of drawing causes the molecules to be oriented in the film.

A known tenter can be preferably used to draw the film across the width. Particularly, drawing the film across the width allows the lamination with the polarizing film to be implemented in the form of a roll. Drawing across the width ensures that the low axis of the optical film made up of the cellulose ester based resin film is oriented across the width.

The transmission axis of the polarizing film is usually oriented across the width too. The polarizing plate, which is laminated in such a way that the transmission axis of the polarizing film and the low axis of the optical film is parallel to each other, is incorporated into the liquid crystal display, this arrangement improves the display contrast of the liquid crystal display, and provides an excellent viewing angle.

The glass transition temperature Tg of the film constituting material can be controlled when the types of the materials constituting the film and the proportion of the constituting materials are made different. When the phase difference film is manufactured as a cellulose ester film, it is preferable that Tg is 120° C. or more, preferably 135° C. or more. In the liquid crystal display, the film temperature environment is changed in the image display mode by the temperature rise of the apparatus per se, for example, by the temperature rise caused by a light source. In this case, if the Tg of the film is lower than the film working environment temperature, a big change will occur to the retardation value and film geometry resulting from the orientation status of the molecules fixed inside the film by drawing. If the Tg of the film is too high, temperature is raised when the film constituting material is formed into a film. This will increase the amount of energy consumed for heating. Further, the material may be decomposed at the time of forming a film, and this may cause coloring. Thus, Tg is preferably kept at 250° C. or less.

The process of cooling and relaxation under known thermal setting conditions can be applied in the drawing process. Appropriate adjustment should be made to obtain the characteristics required of the intended optical film.

The aforementioned drawing process and thermal setting process are applied as appropriate to provide the phase film function for the purpose of improving the physical properties of the phase film and to increase the viewing angle in the liquid crystal display. When such a drawing process and thermal setting process are included, the heating and pressing process in the embodiment of the present invention should be performed prior to the drawing process and thermal setting process.

When a phase difference film is produced as a cellulose ester film, and the functions of the polarizing plate protective film are combined, control of the refractive index is essential. The refractive index control can be provided by the process of drawing. The process of drawing is preferred. The following describes the method for drawing:

In the phase difference film drawing process, required retardations Ro and Rth can be controlled by a drawing magnification of 1.0 through 2.0 in one direction of the cellulose resin, and a drawing magnification of 1.01 through 2.5 times in the direction perpendicular to the inner surface of the film. Here Ro denotes an in-plane retardation. It represents the thickness multiplied by the difference between the refractive index in the longitudinal direction MD in the same plane and that across the width TD. Rth denotes the retardation along the thickness, and represents the thickness multiplied by the difference between the refractive index (an average of the values in the longitudinal direction MD and across the width TD) in the same plane and that along the thickness.

Drawing can be performed sequentially or simultaneously, for example, in the longitudinal direction of the film and in the direction perpendicular in the same plane of the film, namely, across the width. In this case, if the drawing magnification at least in one direction is insufficient, sufficient phase difference cannot be obtained. If it is excessive, drawing difficulties may occur and the film may break.

Drawing in the biaxial directions perpendicular to each other is an effectively way for keeping the film refractive indexes nx, ny and nz within a predetermined range. Here nx denotes a refractive index in the longitudinal direction MD, ny indicates that across the width TD, and nz represents that along the thickness.

When the material is drawn in the melt-casting direction, the nz value will be excessive if there is excessive shrinkage across the width. This can be improved by controlling the shrinkage of the film across the width or by drawing across the width. In the case of drawing across the width, distribution may occur to the refractive index across the width. This distribution may appear when a tenter method is utilized. Drawing of the film across the width causes shrinkage force to appear at the center of the film because the ends are fixed in position. This is considered to be what is called “bowing”. In this case, bowing can be controlled by drawing in the casting direction, and the distribution of he phase difference across the width can be reduced.

Drawing in the biaxial directions perpendicular to each other reduces the fluctuation in the thickness of the obtained film. Excessive fluctuation in the thickness of the phase difference film will cause irregularity in phase difference. When used for liquid crystal display, irregularity in coloring or the like will occur.

The fluctuation in the thickness of the cellulose ester film is preferably kept within the range of ±3%, further down to ±1 W. To achieve the aforementioned object, it is effective to use the method of drawing in the biaxial directions perpendicular to each other. In the final phase, the magnification rate of drawing in the biaxial directions perpendicular to each other is preferably 1.0 through 2.0 in the casting direction, and 1.01 through 2.5 across the width. Drawing in the range of 1.01 through 1.5 in the casting direction and in the range of 1.05 through 2.0 across the width will be more preferred to get a retardation value.

When the absorption axis of the polarizer is present in the longitudinal direction, matching of the transmission axis of the polarizer is found across the width. To get a longer polarizing plate, the phase difference film is preferably drawn so as to get a low axis across the width.

When using the cellulose ester to get positive double refraction with respect to stress, drawing across the width will provide the low axis of the phase difference film across the width because of the aforementioned arrangement. In this case, to improve display quality, the low axis of the phase difference film is preferably located across the width. To get the target retardation value, it is necessary to meet the following relationship:

(Drawing magnification across the width)>(drawing magnification in casting direction)

After drawing, the end of the film is trimmed off by a slitter 13 to a width predetermined for the product. Then both ends of the film are knurled (embossed) by a knurling apparatus made up of an emboss ring 14 and back roll 15, and the film is wound by a winder 16. This arrangement prevents sticking in the cellulose ester film F (master winding) or scratch. Knurling can be provided by heating and pressing a metallic ring having a pattern of projections and depressions on the lateral surface. The gripping portions of the clips on both ends of the film are normally deformed and cannot be used as a film product. They are therefore cut out and are recycled as a material.

Next, in a film winding process, a film is wound around a winding roll, while the shortest distance between the outer circumferential surface of the film wound in a cylindrical form and the outer circumferential surface of a movable conveyance roll immediately before the film is kept constant. And also, before the winding roll, a member such as an electricity removing blower to remove or reduce the surface potential of the film is provided.

As a winder relating to the method for manufacturing a polarizing plate protective film of the present invention, any appropriate winder commonly used may be employed. Winding can be carried out via a winding method such as a constant tension method, a constant torque method, a taper tension method, or a program tension control method of fixed internal stress. Incidentally, the initial winding tension during winding of the polarizing plate protective film is preferably 90.2-300.8 N/m.

In the film winding process of the method of the present invention, a film is preferably wound under ambient conditions of a temperature of 20-30° C. and a humidity of 20-60% RH. By specifying the temperature and humidity in the film winding process in this manner, resistance of the retardation in the thickness direction (Rₜ) to humidity variations is enhanced.

It is not preferable that the temperature in the winding process be less than 20° C., since wrinkles occur and the winding quality of the film is deteriorated, resulting in no practical use. Further, it is not preferable that the temperature in the winding process exceed 30° C., since wrinkles occur and the winding quality of the film is deteriorated, leading to no practical use.

Further, it is not preferable that the humidity in the film winding process be less than 20% RH, since a film is easily charged and the winding quality of the film is deteriorated, resulting in no practical use. It is not preferable that the humidity in the film winding process exceed 60% RH, since conveyance properties are deteriorated, with poor winding quality and adhesion defects.

For a winding core used during winding of a polarizing plate protective film in the roll form, any appropriate material may be employed provided that the winding core is a cylindrical core. A hollow plastic core is preferable, and any type of heat resistant plastic, withstanding the heat treatment temperature, may be used as the plastic material, including a phenol resin, a xylene resin, a melamine resin, a polyester resin, and an epoxy resin. Further, a thermally curable resin, which is reinforced with a filler such as glass fiber, is preferable. For example, a winding core, featuring a hollow plastic core made from FRP having an outer diameter of 6 inches (hereinafter one inch represents 2.54 cm) and an inner diameter of 5 inches, is used.

The number of times of winding the film around such a winding core is preferably at least 100, more preferably at least 500. The winding thickness is preferably at least 5 cm and the width of the film substrate is preferably at least 80 cm, specifically preferably at least 1 m.

When the phase difference film is used as a polarizing plate protective film, the thickness of the aforementioned protective film is preferably 10 through 500 μm. Particularly, the lower limit is 20 μm or more, preferably 35 μm or more. The upper limit is 150 μm or less, preferably 120 μm or less. A particularly preferred range is 25 through 90 μm. If the phase difference film is too thick, the polarizing plate subsequent to machining will be too thick. This fails to meet low-profile light weight requirements when employed in the liquid crystal display for a notebook PC or mobile type electronic equipment. Conversely, if the phase difference film is too thin, retardation as a phase difference film cannot occur easily. Further, the film moisture permeability will be increased, with the result that the polarizer cannot be effectively protected from moisture. This must be avoided.

The low axis or high axis of the phase difference film is present in the same plane of the film. Assume that the angle with respect to the direction of film formation is θ1. Then the θ1 should be −1 degrees or more without exceeding +1 degrees, preferably −0.5 degrees or more without exceeding +0.5 degrees.

This θ1 can be defined as an orientation angle. It can be measured by an automatic double refractometer KOERA-21ADH (by Oji Scientific Instruments).

If θ1 meets the aforementioned relationship, a high degree of brightness is ensured in the display image and a leakage of light is reduced or prevented, with the result that faithful color representation is provided in the color liquid crystal display.

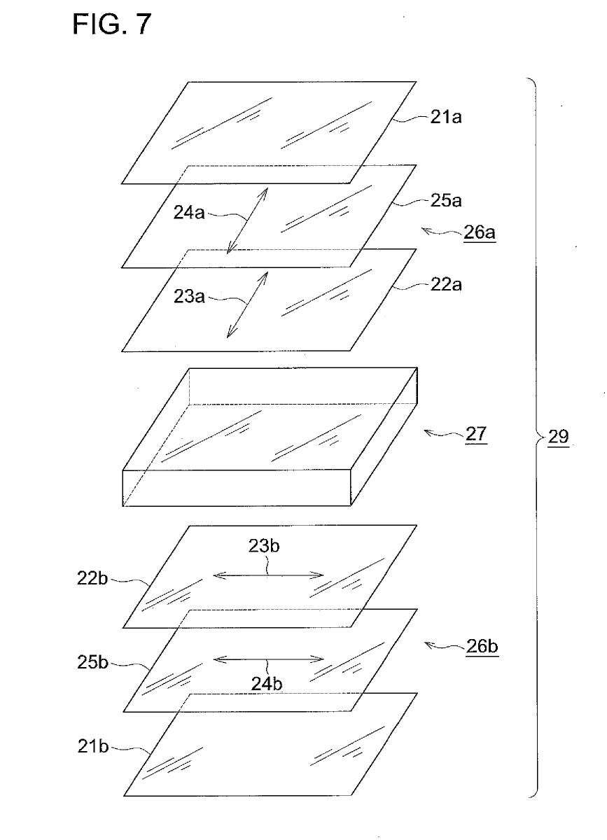

When the phase difference film as an embodiment of the present invention is used in the multiple-domain VA mode, the arrangement of the phase difference film improves the display quality of the image if the high axis of the phase difference film is θ1, and the film is arranged in the aforementioned area. When the polarizing plate and liquid crystal display apparatus are set to MVA mode, a structure shown in FIG. 7 can be used, for example.

In FIG. 7, the reference numerals 21a and 21b indicate protective films, 22a and 22b represent phase difference films, 25a and 25b show polarizers, 23a and 23b indicate the low-axis directions of the film, 24a and 24b show the directions of the polarizer transmission axis, 26a and 26b denote polarizing plates, 27 shows a liquid crystal cell, and 29 denotes a liquid crystal display.

The distribution of the retardation Ro in the in-plane direction of the cellulose ester film is adjusted to preferably 5% or less, more preferably 2% or less, still more preferably 1.5° or less. Further, the distribution of retardation Rt along the thickness of the film is adjusted to preferably 10% or less, more preferably 2% or less, still more preferably 1.5% or less.

In the phase difference film, the fluctuation in the distribution of the retardation value is preferred to be as small as possible. When a polarizing plate containing the phase difference film is used in the liquid crystal display apparatus, a smaller fluctuation in the distribution of the aforementioned retardation is preferred for the purpose of preventing color irregularity.

In order to adjust the phase difference film so as to provide the retardation value suited for improvement of the display quality of the liquid crystal cell in the VA mode or TN mode and to divide the aforementioned multi-domain especially in the VA mode for preferable use in the MVA mode, adjustment must be made to ensure that the in-plane retardation Ro is greater than 30 nm without exceeding 95 nm, and retardation Rt along the thickness is greater than 70 nm without exceeding 400 nm.

In the configuration shown in FIG. 7 wherein two polarizing plates are arranged in a crossed-Nicols configuration and a liquid crystal cell is arranged between the polarizing plates, assuming a crossed-Nicols configuration with respect to the standard wherein observation is made from the direction normal to the display surface. When viewed from the direction away from the line normal to the display surface, a deviation occurs from the crossed-Nicols arrangement of the polarizing plate, and causes the leakage of light. This leakage is mainly compensated for by the aforementioned in-plane retardation Ro. In the aforementioned TN mode and VA mode, particularly in the MVA mode, when the liquid crystal cell is set to the black-and-white display mode, the retardation along the thickness mainly compensates for the double refraction of the liquid crystal cell recognized when viewed in a slanting direction in the same manner.

As shown in FIG. 7, when two polarizing plates are arranged on the upper and lower portions of the liquid crystal cell in the liquid crystal display, the reference numerals 22a and 22b in FIG. 7 are capable of selecting the distribution of retardation Rt along the thickness. It is preferred to ensure that the requirements of the aforementioned range are met, and the total of both of the retardations Rt along the thickness is greater than 140 nm without exceeding 500 nm. In this case, both the in-plane retardation Ro of the 22a and 22b and retardation Rt along the thickness retardation Rt are the same for improving the productivity of industrial polarizing plates. It is particularly preferred that the in-plane retardation Ro is greater than 35 nm without exceeding 65 nm, the retardation Rt along the thickness retardation Rt is greater than 90 nm without exceeding 180 nm, and the structure shown in FIG. 7 is applied to the liquid crystal cell in the MVA mode.

In the liquid crystal display apparatus, assuming that the TAC film having an in-plane retardation Ro of 0 through 4 nm, a retardation Rt along the thickness of 20 through 50 nm and a thickness of 35 through 85 μm is used at the position 22b in FIG. 7 as one of the polarizing plates, for example, as a commercially available polarizing plate protective film, the polarizing film arranged on the other polarizing plate, for example, the polarizing film arranged in 22a of FIG. 7 is preferred to have an in-plane retardation Ro of greater than 30 nm without exceeding 95 nm, and the retardation Rt along the thickness of greater than 140 nm without exceeding 400 nm. This arrangement improves the display quality and film productivity.

### <Liquid Crystal Display>

The polarizing plate including the polarizing plate protective film (combining phase difference film) in the embodiment of the present invention provides higher display quality than the normal polarizing plate. This is particularly suited for use in a multi-domain type liquid crystal display, more preferably to the multi-domain type liquid crystal display in the double refraction mode.

The polarizing plate of the present invention can be used in the MVA (Multi-domain Vertical Alignment) mode, PVA (Patterned Vertical Alignment) mode, CPA (Continuous Pinwheel Alignment) mode and OCB (Optical Compensated Bend) mode, without being restricted to a specific liquid crystal mode or polarizing plate arrangement.

The liquid crystal display is coming into practical use as a colored and animation display. The display quality is improved by the embodiment of the present invention. The improved contrast and enhanced polarizing plate durability ensure faithful animation image display without easy fatigue.

In the liquid crystal display containing at least the polarizing plate incorporating a phase difference film in the embodiment of the present invention, one polarizing plate containing the phase difference film in the embodiment of the present invention is arranged on the liquid crystal cell, or two polarizing plates are arranged on both sides of the liquid crystal cell. In these cases, the display quality is improved when means are provided to ensure that the side of the polarizing plate protective film in the embodiment of the present invention contained in the polarizing plate faces the liquid crystal cell of the liquid crystal display. Then the films 22a and 22b of FIG. 7 face the liquid crystal cell of the liquid crystal display.

In the aforementioned structure, the polarizing plate protective film in the embodiment of the present invention provides optical compensation of the liquid crystal cell. When the polarizing plate in the embodiment of the present invention is used in the liquid crystal display, at least one of the polarizing plates of the liquid crystal display should be used as a polarizing plate in the embodiment of the present invention. Use of the polarizing plate in the embodiment of the present invention improves the display quality and provides a liquid crystal display having excellent viewing angle.

In the polarizing plate of the embodiment of the present invention, a polarizing plate protective film of cellulose derivative is used on the surface opposite the polarizing plate protective film as viewed from the polarizer. A general-purpose TAC film or the like can be employed as the protective film. The polarizing plate protective film, which is located far from the liquid crystal cell, can be provided with another functional layer for the purpose of improving the quality of the display apparatus.

For example, in order to avoid reflection, glare, scratch and dust, and to improve brightness, it is possible to bond the aforementioned functional layer onto the film containing a known functional layer for a display or polarizing plate surface in the embodiment of the present invention, without being restricted thereto.

Generally, to ensure stable optical characteristics, the aforementioned retardation value Ro or Rth are required to be small for the phase difference film. Especially, these fluctuations may cause irregularities of an image in the liquid crystal display in the double refraction mode.

In the embodiment of the present invention, a longer the polarizing plate protective film produced by the melt-casting film forming method is mainly made of a cellulose ester. This arrangement makes it possible to use the process of alkaline treatment based on the saponification inherent to the cellulose ester. Similarly to the case of the conventional polarizing plate protective film, this can be bonded with the polarizing plate protective film in the embodiment of the present invention using an aqueous solution containing a completely saponified polyvinyl alcohol, when the resin constituting the polarizer is polyvinyl alcohol. Thus, the embodiment of the present invention is superior in that the method for manufacturing the conventional polarizing plate can be applied. It is especially advantageous in that a longer roll polarizing plate can be obtained. In the present invention, the polarizing plate protective film, wherein a long cellulose ester film is subjected to film formation and wound in the roll form, refers to a polarizing plate protective film wherein a cellulose ester film, having been formed via a melt casting method, is rewound, using a winding core (cylindrical core) as an axis, as a long cellulose ester film of at least 10 m around the outer circumferential surface of the winding core to form a cellulose ester film wound in the roll form.

The advantage in production of the embodiment of the present invention is more remarkable especially in the production of a longer product in excess of 100 meters. Greater advantages are observed in the production of a polarizing plate when it is longer, for example, in the order of 1500 m, 2500 m and 5000 m.

For example, in the production of a polarizing plate protective film, roll length is 10 m or more without exceeding 5000 m, preferably 50 m or more without exceeding 4500 m when the productivity and transportability are taken into account. The width of a polarizer can be selected being suitable for the width of the polarizer and the production line in this case. A film having a width of 0.5 m or more without exceeding 4.0 m, preferably 0.6 m or more without exceeding 3.0 m can be produced, wound in a form of a roll, and used to process a polarizing plate. A film having a width twice or more as great as the intended width also can be produced, wound in a form of a roll, and cut to get the roll of an intended width, and used to process the polarizing plate.

When manufacturing the polarizing plate protective film as the embodiment of the present invention, a functional layer such as antistatic layer, hard coated layer, easy glidability layer, adhesive layer, antiglare layer and barrier layer can be coated before and/or after drawing. In this case, various forms of surface treatment such as corona discharging, plasma processing, chemical solution treatment can be provided as appropriate.

In the film making process, the gripping portions of the clips on both ends of the film having been cut can be recycled as the material of the same type or different type of films, after having been pulverized, or after having been pelletized as required.

A cellulose ester film of lamination structure can be produced by co-extrusion of the compositions containing cellulose esters having different concentrations of additives such as the aforementioned plasticizer, ultraviolet absorber and matting agent. For example, a cellulose ester film made up of a skin layer, core layer and skin layer can be produced. For example, a large quantity of matting agent can be put into the skin layer or the matting agent can be put only into the skin layer. Larger amounts of plasticizer and ultraviolet absorber can be put into the core layer than the skin layer. They can be put only in the core layer. Further, the types of the plasticizer and ultraviolet absorber can be changed in the core layer and skin layer. For example, it is also possible to make such arrangements that the skin layer contains a plasticizer and/or ultraviolet absorber of lower volatility, and that the core layer contains a plasticizer of excellent plasticity or an ultraviolet absorber of excellent ultraviolet absorbing performance. The glass transition temperatures between the skin layer and core layer can be different from each other. The glass transition temperature of the core layer is preferably lower than that of the skin layer. In this case, the glass transition temperatures of both the skin and core are measured, and the average value obtained by calculation from the volume fraction thereof is defined as the aforementioned glass transition temperature Tg so that it is handled in the same manner. Further, the viscosity of the melt including the cellulose ester at the time of melt-casting can be different in the skin layer and core layer. The viscosity of the skin layer can be greater than that of the core layer. Alternatively, the viscosity of the core layer can be equal to or greater than that of the skin layer.

Assuming that the dimension of the film is the standard when left to stand for 24 hours at a temperature of 23° C. with a relative humidity of 55% RH. On this assumption, the dimensional stability of the cellulose ester film of the present embodiment is such that the fluctuation of the dimension at 80° C. and 90% RH is within ±2.0% (excl.), preferably within ±1.0% (excl.), more preferably within ±0.5% (excl.).

When the cellulose ester film of the present embodiment is used as a polarizing plate protective film as the phase difference film, if the phase difference film has a fluctuation in excess of the aforementioned range, the absolute value of the retardation and the orientation angle as a polarizing plate will deviate from the initial setting. This may cause reduction in the capability of improving the display quality, or may result in deterioration of the display quality.

The cellulose ester film of the present invention can be used for the polarizing plate protective film. When used as a polarizing plate protective film, there is no restriction to the method of producing the polarizing plate. The polarizing plate can be manufactured by a commonly used method. The cellulose ester film having been obtained is subjected to alkaline treatment. Using an aqueous solution of completely saponified polyvinyl alcohol, the polarizing plate protective films can be bonded on the both surfaces of the polarizer manufactured by immersing the polyvinyl alcohol film in an iodonium solution and by drawing the same. When this method is used, the phase difference film as the polarizing plate protective film in the embodiment of the present invention is directly bonded to at least one of the surfaces of the polarizer.

Instead of the aforementioned alkaline treatment, the film can be provided with simplified adhesion as disclosed in the Japanese Laid-Open Patent Publication No. H06-94915 and Japanese Laid-Open Patent Publication No. H06-118232.

The polarizing plate is made up of a polarizer and protective films for covering both surfaces thereof. Further, a film for protecting can be bonded onto one of the surfaces of the aforementioned polarizing plate and a release sheet can be bonded on the opposite surface. The film for protecting and the release sheet are used to protect the polarizing plate at the time of product inspection before shipment of the polarizing plate. In this case, the film for protecting is bonded to protect the surface of the polarizing plate, and is used on the surface opposite to the surface wherein the polarizing plate is bonded to the liquid crystal. Further, the release sheet is used to cover the adhesive layer to be bonded to the liquid crystal substrate, and is used on the surface wherein the polarizing plate is bonded to the liquid crystal cell.

Incidentally, a polarizer which is a main constituent element of a polarizing plate refers to an element passing only light of a polarized wave plane from a predetermined direction. A typical polarizer conventionally known is a polyvinyl alcohol-based polarizing film, including those prepared by dyeing a polyvinyl alcohol-based film with iodine and those dyed with a dichroic dye. As a polarizer, those prepared in such a manner that a polyvinyl alcohol aqueous solution is subjected to film formation, and then the resulting product is uniaxially stretched and then dyed, or is dyed and then uniaxially stretched; and thereafter, durability treatment is preferably carried out using a boron compound. One side of the polarizing plate protective film of the present invention is bonded to the surface of the polarizer to form a polarizing plate. Bonding is preferably conducted using a water-based adhesive containing a completely saponified polyvinyl alcohol as a main component. Those featuring a film thickness of 10-30 μm are preferably used as the polarizer.

### EXAMPLES

The present invention will now specifically be described with reference to examples that by no means limit the scope of the present invention.

Cellulose esters C-1-C-7, plasticizers, and additives to be used in Examples 1-4 were synthesized based on the following synthesis examples 1-14.

### Synthesis Example 1

### Cellulose Ester C-1

Synthesis was carried out based on Example B described in Japanese Translation of PCT International Application No. 6-501040.

Solutions A-E as described below were prepared.

A: Propionic acid:concentrated sulfuric acid=5:3 (mass ratio)

B: Acetic acid:purified water=3:1 (mass ratio)

C: Acetic acid:purified water=1:1 (mass ratio)

D: Acetic acid:purified water magnesium carbonate=12:11:1 (mass ratio)

E: Solution prepared by dissolving 0.5 mol of potassium carbonate and 1.0 mol of citric acid in 14.6 kg of purified water

In a reaction container fitted with a mechanical stirrer, 100 parts by mass of cellulose purified from cotton, 317 parts by mass of acetic acid, and 67 parts by mass of propionic acid were added, followed by being stirred at 55° C. for 30 minutes. The temperature of the reaction container was decreased to 30° C. and 2.3 parts by mass of solution A was added, followed by being stirred for 30 minutes. The temperature of the reaction container was cooled to −20° C., and 100 parts by mass of acetic anhydride and 250 parts by mass of propionic anhydride were added, followed by being stirred for 1 hour. The temperature of the reaction container was raised to 10° C. and 4.5 parts by mass of solution A was added, followed by being raised to 60° C. to stir for 3 hours. Further, 533 parts by mass of solution B was added to stir for 17 hours. Then, 333 parts by mass of solution C and 730 parts by mass of solution D were added to stir for 15 minutes. Insoluble materials were filtered and water was added to the resulting solution while stirring until precipitate formation was terminated, followed by filtration of the thus-produced white precipitates. The isolated white solid was washed until the washing liquid became neutralized. To obtain cellulose ester (cellulose acetate propionate) C-1, 1.8 parts by mass of solution E was added to this wet resulting product, followed by drying at 70° C. for 3 hours under vacuum.

When the substitution degree of the thus-obtained cellulose ester was calculated based on ASTM-D817-96, the acetyl group substitution degree was 2.08 and the propionyl group substitution degree was 0.72. The total carbon number of the acyl groups is 6.32. Further, when GPC measurement was carried out under the following conditions, the weight average molecular weight was 200000.

### <GPC Measurement Conditions>

Solvent: Methylene chloride

Column: Shodex K806, K805, and K803 (these three columns used were connected; produced by Showa Denko K.K.)

Column temperature: 25° C.

Sample concentration: 0.1° by mass

Detector: RI Model 504 (produced by GL sciences Inc.)

Pump: L6000 (produced by Hitachi, Ltd.)

Flow rate: 1.0 ml/minute

### Synthesis Example 2

### Cellulose Ester C-2

Seventy grams of acetic acid (corresponding to aliphatic acid I), 20 g of propionic acid (corresponding to aliphatic acid IT) were added to 30 g of cellulose (dissolved pulp produced by Nippon Paper Group, Inc.), followed by being stirred at 54° C. for 30 minutes. The resulting mixture was cooled, and then 8 g of acetic anhydride (corresponding to aliphatic acid anhydride I), 125 g of propionic anhydride (corresponding to aliphatic acid anhydride II), and 1.2 g of sulfuric acid, having been cooled in an ice bath, were added for esterification. Esterification was carried out by stirring for 150 minutes while the temperature was controlled at most 40° C. After reaction, a liquid mixture of 30 g of acetic acid and 10 g of water was dripped over 20 minutes to hydrolyze excessive anhydrides. While the temperature of the reaction liquid was kept at 40° C., 90 g of acetic acid and 30 g of water were added to stir for 1 hour. The resulting mixture was poured into an aqueous solution containing 2 g of magnesium acetate and stirred for a while, followed by filtration and then drying to obtain cellulose ester C-2. The acetyl substitution degree, the propionyl substitution degree, and the weight average molecular weight of the thus-obtained cellulose ester were 1.45, 1.27, and 211000, respectively. The total carbon number of the acyl groups is 6.71.

### Synthesis Examples 37

### Cellulose Esters C-3-C-7

Using acetic acid, acetic anhydride, propionic acid, propionic anhydride, butyric acid, and butyric anhydride listed in Table 1, cellulose esters C-3-C-7 were obtained in the same manner as in Synthesis Example 2.

TABLE 1

| | Acyl Group Substitution | | | Aliphatic | | Aliphatic Acid | | Total Carbon | |
|---|---|---|---|---|---|---|---|---|---|
| Cellulose | Degree | | | Acid | | Anhydride | | Number of | |
| Ester No. | Ac | Pr | Bu | I | II | I | II | Acyl Group | Mw |
| C-3 | 2.45 | 0.43 | — | 87 | 20 | 51 | 50 | 6.19 | 211000 |
| C-4 | 0.65 | 1.73 | — | 10 | 100 | 10 | 100 | 6.49 | 201000 |
| C-5 | 2.20 | — | 0.63 | 87 | 20 | 43 | 62 | 6.92 | 198000 |
| C-6 | 1.65 | 1.27 | — | 90 | 20 | 8 | 125 | 7.11 | 238000 |
| C-7 | 1.45 | 1.43 | — | 70 | 40 | 8 | 125 | 7.19 | 241000 |

Acyl group substitution degree
Ac: acetyl group
Pr: propionyl group
Bu: butyryl group
Aliphatic acid
I: acetic acid
II: propionic acid or butyric acid
Aliphatic acid anhydride
I: acetic anhydride
II: propionic anhydride or n-butyric acid
Mw Weight average molecular weight

### Synthesis Example 8

### Synthesis of a Plasticizer, Trimethylolpropane Tribenzoate (TMPTB)

While stirring, 71 parts by mass of benzoyl chloride was dripped, over 30 minutes, in a mixed solution of 45 parts by mass of trimethylolpropane and 101 parts by mass of triethylamine kept at 100° C., followed by stirring for another 30 minutes. After reaction, the resulting product was cooled to room temperature, and precipitates were filtered and isolated. Thereafter, the filtrate was washed by addition of ethyl acetate-purified water. The resulting organic phase was isolated and ethyl acetate was distilled away under reduced pressure, followed by purification to obtain a white crystal of 126 parts by mass (yield: 85%). Incidentally, the molecular weight of this compound is 446.

### Synthesis Example 9

### A Plasticizer, Compound Example 48

While stirring, a solution prepared by dissolving 250 parts by mass of 3,4,5-trimethoxybenzoyl chloride in 300 parts by mass of ethyl acetate was dripped, over 30 minutes, in a mixed solution of 36 parts by mass of trimethylolpropane, 107 parts by mass of pyridine, and 300 parts by mass of ethyl acetate kept at 10° C., and then the resulting mixture was heated to 80° C., followed by being stirred for 5 hours. After reaction, the resulting product was cooled to room temperature, and precipitates were filtered and isolated. Thereafter, the filtrate was washed by addition of an HCl aqueous solution of 1 mol/l and further by addition of an Na₂CO₃ aqueous solution of 1% by mass. The resulting organic phase was isolated and ethyl acetate was distilled away under reduced pressure, followed by purification to obtain a white crystal of 153 parts by mass (yield: 80%). Incidentally, the molecular weight of this compound was 717.

### Synthesis Example 10

### A Plasticizer, Compound Example 5S

While stirring, 210 parts by mass of 3,4,5-trimethoxybenzoyl chloride was dripped, over 30 minutes, in a mixed solution of 28 parts by mass of glycerin, 83 parts by mass of pyridine, and 500 parts by mass of toluene kept at 10° C., and then the resulting mixture was heated to 80° C., followed by being stirred for 3 hours. After reaction, the resulting product was cooled to room temperature, and precipitates were filtered and isolated. Thereafter, the filtrate was washed by addition of an HCl aqueous solution of 1 mol/l and further by addition of an Na₂CO₃ aqueous solution of 1% by mass. The resulting organic phase was isolated and ethyl acetate was distilled away under reduced pressure; followed by purification to obtain the targeted compound. Incidentally, the molecular weight of this compound was 675.

### Synthesis Example 11

### A Plasticizer, Compound Example 61

While stirring, 210 parts by mass of benzoyl chloride was dripped, over 30 minutes, in a mixed solution of 60 parts by mass of 2-hydroxymethyl-2-methylpropane-1,3-diol, 140 parts by mass of pyridine, and 500 parts by mass of ethyl acetate kept at 10° C., and then the resulting mixture was heated to 100° C., followed by being stirred for 5 hours After reaction, the resulting product was cooled to room temperature, and precipitates were filtered and isolated. Thereafter, the filtrate was washed by addition of an HCl aqueous solution of 1 mol/l and further by addition of an Na₂CO₃ aqueous solution of 1% by mass. The resulting organic phase was isolated and ethyl acetate was distilled away under reduced pressure, followed by purification to obtain a white solid of 193 parts by mass (yield: 90%). Incidentally, the molecular weight of this compound was 433.

### Synthesis Example 12

### A Plasticizer, Compound Example 62

While stirring, 210 parts by mass of p-methoxybenzoyl chloride was dripped, over 30 minutes, in a mixed solution of 45 parts by mass of glycerin, 190 parts by mass of pyridine, and 450 parts by mass of ethyl acetate kept at 10° C., and then the resulting mixture was heated to 80° C., followed by being stirred for 3 hours. After reaction, the resulting product was cooled to room temperature, and precipitates were filtered and isolated. Thereafter, the filtrate was washed by addition of an HCl aqueous solution of 1 mol/l and further by addition of an Na₂CO₃ aqueous solution of 1% by mass. The resulting organic phase was isolated and ethyl acetate was distilled away under reduced pressure, followed by purification to obtain the targeted compound. Incidentally, the molecular weight of this compound was 494.

### Synthesis Example 13

### A Plasticizer, Aliphatic-Aromatic Copolyester Compound A1

A reaction container fitted with a cooling condenser was charged with 648 parts by mass of ethylene glycol, 58 parts by mass of diethylene glycol, 1121 parts by mass of succinic acid, 83 parts by mass of terephthalic acid, and 0.03 part by mass of tetrabutyl titanate, and then dehydration condensation reaction was carried out at 140° C. for 2 hours; then at 220 CC for 2 hours; and further at 220° C. for 20 hours without the cooling condenser to obtain aliphatic-aromatic copolyester compound A1 featuring a number average molecular weight of 1500. The average carbon numbers of the diols and the dicarboxylic acids used for this case were 2.1 and 4, respectively.

### Synthesis Example 14

### A Plasticizer, Aliphatic Polyester Compound A2

A reaction container fitted with a cooling condenser was charged with 699 parts by mass of ethylene glycol, 1180 parts by mass of succinic acid, and 0.03 part by mass of tetrabutyl titanate, and then dehydration condensation reaction was carried out at 140° C. for 2 hours; then at 220° C. for 2 hours; and further at 220° C. for 20 hours without the cooling condenser to obtain aliphatic polyester compound A2 featuring a number average molecular weight of 2000. The average carbon numbers of the diols and the dicarboxylic acids used for this case were 2 and 4, respectively.

### Example 1

### Preparation of Cellulose Ester Film Master Roll Sample 1-1

Using various compounds prepared in the synthesis examples and commercially available compounds as additives, cellulose ester film 1-1 was prepared via melt casting.

| | | |
|---|---|---|
| Cellulose ester C-1 | 100 | parts by mass |
| Additive 1: exemplified compound 1-1 | 1 | part by mass |
| Additive 2: GTB (glyceryl tribenzoate, | 10 | parts by mass |
| produced by Aldrich Co.) | | |
| Additive 3: IRGANOX-1010 (produced by | 0.5 | part by mass |
| Ciba Specialty Chemicals, Ltd.) | | |
| Following compound A (a mixture of compound | 0.3 | part by mass |
| a1 and compound a2 at a ratio of 85:15) | | |
| TINUVIN928 (produced by Ciba Specialty | 1.8 | parts by mass |
| Chemicals, Ltd.) | | |

A mixture of the above compounds was melt mixed into a pellet at 230° C. using a biaxial extruder. Incidentally, the glass transition point Tg of this pellet was 136° C.

This pellet was melted at 250° C. and extruded from casting die 4 onto first cooling roll 5, followed by being pressure-sandwiched between first cooling roll 5 and touch roll 6 for film formation. Further, silica particles (produced by Nihon Aerosil Co., Ltd.) were added, as a slipping agent, from the hopper orifice in the intermediate portion of extruder 1 so as for the silica particles to be 0.05 part by mass and 0.5 part by mass.

A heat bolt was adjusted so as to allow the gap width of casting die 4 to be 0.5 mm within 30 mm from the film end portions in the transverse direction, and to be 1 mm at the other portion. As a touch roll, touch roll A was used, and water of 80° C. was passed in the interior thereof as cooling water.

There was set, to 20 mm, length L along the circumference surface of first cooling roll S from position P1 where a resin extruded from casting die 4 contacts first cooling roll 5 to position P2 at the upstream end of the nip between first cooling roll 5 and touch roll 6 in the rotational direction of first cooling roll 5. Thereafter, touch roll 6 was withdrawn from first cooling roll 5, and there was measured temperature T of the melt portion immediately before press-sandwiched by the nip between first cooling roll 5 and touch roll 6. In this example and all of the examples and the comparative examples to be described later, temperature T of the melt portion immediately before press-sandwiched by the nip between first cooling roll 5 and touch roll 6 was measured at the position of a further upstream side by 1 mm from nip upstream end P2 using a thermometer (HA-200E, produced by Anritsu Instruments Co., Ltd.). In this example, as a result of measurement, temperature T was 141° C. The line pressure of touch roll 6 against first cooling roll 5 was set to 14.7 N/cm. Further, the film was introduced into a tenter and stretched at 160° C. by a factor of 0.3 in the transverse direction, and thereafter cooled to 30° C. while being relaxed by 3% in the transverse direction. Then, the film was released from the clips to cut off the clipped portions, and slit into a width of 1430 mm, followed by knurling of 10 am wide and 5 μm high for both film ends to wind the resulting film around a core at a winding tension of 220 N/m and a taper of 40%. The core had an inner diameter of 152 mm, an outer diameter of 165-180 mm, and a length of 1550 mm. As a base material of this core, used was a prepreg resin in which an epoxy resin was impregnated in glass fiber or carbon fiber. A conductive epoxy resin was coated on the surface of the core, and the surface was subjected to polish finishing to allow the surface roughness Ra to be 0.3 μm. Herein, the extruding amount and the draw rate were controlled so that the film might have a thickness of 80 μm, and the wound length thereof was 2500 m. This cellulose ester film master roll sample is designated as No. 1-1.

Compound A (Ratio of Compound a1 to Compound a2 is a Mixture Ratio of 85:15)

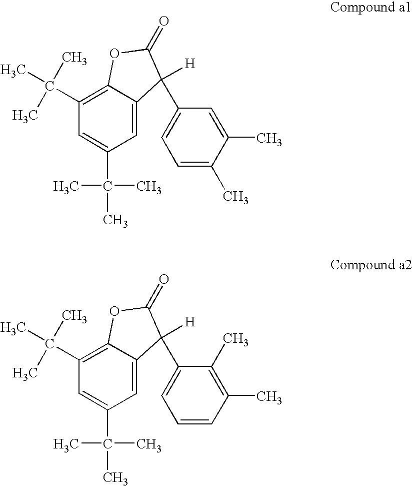

### (Preparation of Cellulose Ester Film Master Roll Samples 1-2-1-29)

Further, cellulose ester film master roll samples 1-2-1-27 of the present invention and comparative cellulose ester film master roll samples 1-28 and 1-29 were prepared in the same manner as for cellulose ester film master roll sample 1-1 except that the additives were exchanged to additives 1-5 listed in Table 2. Herein, compound A and TINUVIN928 were added to all the samples.

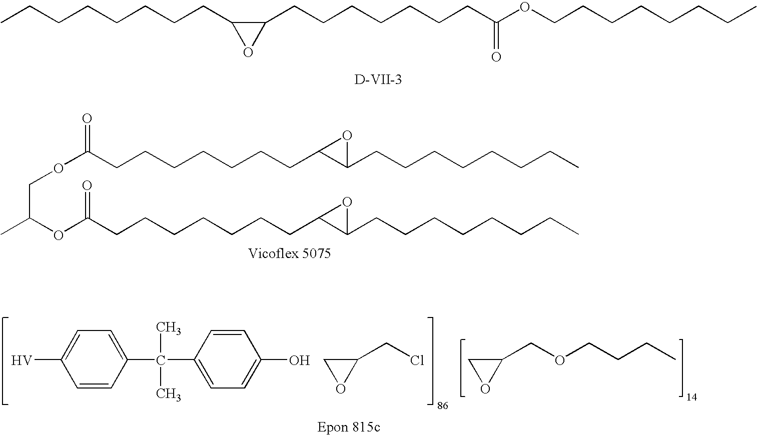

However, additives, being liquid at room temperature, were added using a feeder immediately before entering into the biaxial extruder.

TABLE 2

| Sam- | Additive 1 | | Additive 2 | | Additive 3 | | Additive 4 | | Additive 5 | | |
|---|---|---|---|---|---|---|---|---|---|---|---|
| ple | | Added | | Added | | Added | | Added | | Added | |
| No. | Type | Amount | Type | Amount | Type | Amount | Type | Amount | Type | Amount | Remarks |
| 1-1 | 1-1 | 1 | GTB | 10 | Irganox1010 | 0.5 | | | | | Inventive |
| 1-2 | 2-1 | 1 | GTTB | 10 | Irganox1010 | 0.5 | | | | | Inventive |
| 1-3 | 3-1 | 1 | 51 | 10 | Tinuvin120 | 0.5 | | | | | Inventive |
| 1-4 | 3-9 | 1 | 61 | 8 | SumilizerGA-80 | 0.5 | | | | | Inventive |
| 1-5 | 3-8 | 1 | 62 | 10 | Irganox1010 | 0.5 | | | | | Inventive |
| 1-6 | 2-1 | 1 | GTB | 10 | Irganox1010 | 0.5 | GSY-P101 | 0.25 | | | Inventive |
| 1-7 | 2-1 | 0.5 | GTB | 10 | Irganox1010 | 0.5 | GSY-P101 | 0.25 | | | Inventive |
| 1-8 | 2-1 | 2 | GTB | 10 | Irganox1010 | 0.5 | GSY-P101 | 0.25 | | | Inventive |
| 1-9 | 2-2 | 1 | GTB | 10 | Irganox1010 | 0.5 | GSY-P101 | 0.25 | | | Inventive |
| 1-10 | 2-5 | 1 | GTB | 10 | Irganox1010 | 0.5 | GSY-P101 | 0.25 | | | Inventive |
| 1-11 | 1-1 | 1 | GTB | 10 | Irganox1010 | 0.5 | IrgafosP-EPQ | 0.25 | | | Inventive |
| 1-12 | 1-2 | 1 | GTB | 10 | Irganox1010 | 0.5 | IrgafosP-EPQ | 0.25 | | | Inventive |
| 1-13 | 1-3 | 1 | GTB | 10 | Irganox1010 | 0.5 | IrgafosP-EPQ | 0.25 | | | Inventive |
| 1-14 | 1-6 | 1 | TMPTB | 10 | Irganox1010 | 0.5 | ADKSTABPEP-36 | 0.25 | | | Inventive |
| 1-15 | 1-7 | 1 | 48 | 10 | SumilizerGA-80 | 0.5 | GSY-P101 | 0.25 | | | Inventive |
| 1-16 | 3-1 | 1 | 61 | 10 | SumilizerBp-76 | 0.5 | IrgafosP-EPQ | 0.25 | | | Inventive |
| 1-17 | 3-9 | 1 | GTB | 10 | Irganox1010 | 0.5 | IrgafosP-EPQ | 0.25 | | | Inventive |
| 1-18 | 3-8 | 1 | TMPTB | 10 | Irganox1010 | 0.5 | IrgafosP-EPQ | 0.25 | | | Inventive |
| 1-19 | 2-1 | 1 | di-2- | 10 | Irganox1010 | 0.5 | GSY-P101 | 0.25 | | | Inventive |
| | | | ethyl- | | | | | | | | |
| | | | hexyl | | | | | | | | |
| | | | agipate | | | | | | | | |
| 1-20 | 2-1 | 1 | GTB | 7 | Irganox1010 | 0.5 | IrgafosP-EPQ | 0.25 | | | Inventive |
| | | 1 | A1 | 3 | | | | | | | |
| 1-21 | 2-1 | 1 | GTB | 7 | Irganox1010 | 0.5 | IrgafosP-EPQ | 0.25 | | | Inventive |
| | | 1 | A2 | 3 | | | | | | | |
| 1-22 | 2-1 | 1 | TMPTB | 10 | Irganox1010 | 0.5 | GSY-P101 | 0.25 | | | Inventive |
| 1-23 | 2-1 | 1 | GTB | 10 | Irganox1010 | 0.5 | GSY-P101 | 0.25 | Epon815C | 1 | Inventive |
| 1-24 | 2-1 | 1 | GTB | 10 | Irganox1010 | 0.5 | GSY-P101 | 0.25 | Vicoflex5075 | 1 | Inventive |
| 1-25 | 1-1 | 1 | GTB | 10 | Irganox1010 | 0.5 | GSY-P101 | 0.25 | D-VII-3 | 1 | Inventive |
| 1-26 | 1-3 | 1 | GTB | 10 | Irganox1010 | 0.5 | GSY-P101 | 0.25 | 1-dodecanol | 1 | Inventive |
| 1-27 | 2-5 | 1 | GTB | 10 | Irganox1010 | 0.5 | GSY-P101 | 0.25 | epoxidized | 1 | Inventive |
| | | | | | | | | | linseed oil | | |
| 1-28 | | | GTB | 10 | Irganox1010 | 0.5 | | | | | Comparative |
| 1-29 | | | GTB | 10 | Irganox1010 | 0.5 | GSY-P101 | 0.25 | | | Comparative |

### (Evaluation of Cellulose Ester Film Master Roll Samples)

The thus-obtained cellulose ester film master roll samples were evaluated via the methods described below.

### <Horseback Defect and Core Transfer>

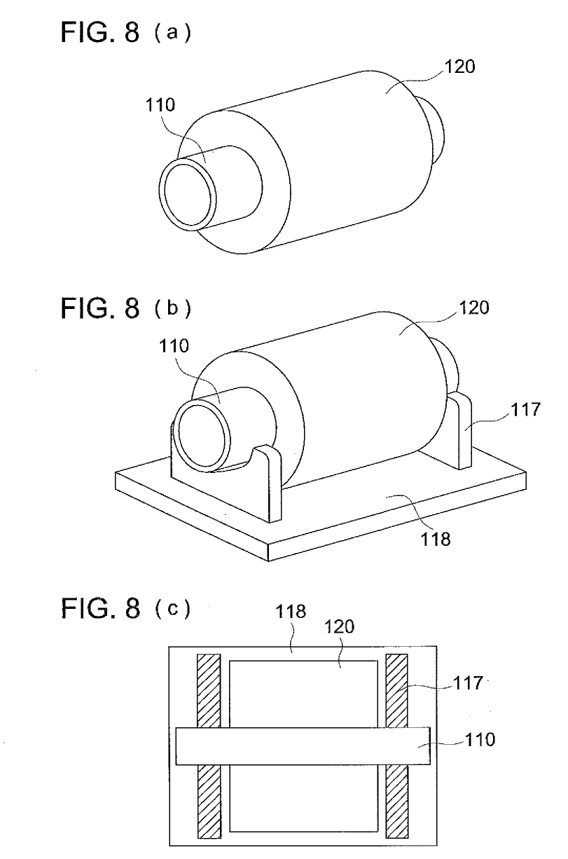

A wound cellulose ester film master roll sample was double-wrapped with a polyethylene sheet and stored in such a storage manner as shown in FIG. 8 under a condition of 25° C. and 50% RH for 33 days, and thereafter taken out of the box. Then, the polyethylene sheet was unwrapped. A lighted fluorescent tube was reflected on the surface of the film master roll sample and the resulting deformation or minute distortion was observed to rank the horse back defect at the following levels:

A: The fluorescent tube appears straight,

B: The fluorescent tube appears partially curved.

C: The fluorescent tube appears reflected in a mottled manner.

Further, the cellulose ester film master roll sample after storage was unwound. There was measured the distance in meters from the core portion where core transfer occurred, wherein deformation with spots of at least 50 μm or belt-like deformation in the transverse direction clearly appeared, to rank the core transfer at the following levels:

A: less than 15 m from the core portion

B: 15-less than 30 m from the core portion

C: 30-less than 50 m from the core portion

D: at least 50 m from the core portion

### <Winding Initiation Wrinkles>

When a master roll film was wound around a core and then became defective due to occurrence of wrinkles at winding initiation, the master roll film was removed from the core and wound again. The frequency of the defect in such a case was counted. This operation was carried out 10 times and the average value was calculated for ranking at the following levels.

A: 0-less than once

B. once-less than 3 times

C: 3 times-less than 5 times

D: at least 5 times

The evaluated results are shown in Table 3.

TABLE 3

| | | | Winding | |
|---|---|---|---|---|
| Sample | Horseback | Core | Initiation | |
| No. | Defect | Transfer | Wrinkles | Remarks |
| 1-1 | A | C | B | Inventive |
| 1-2 | A | B | B | Inventive |
| 1-3 | A | B | B | Inventive |
| 1-4 | A | B | B | Inventive |
| 1-5 | A | B | B | Inventive |
| 1-6 | A | A | A | Inventive |
| 1-7 | A | A | A | Inventive |
| 1-8 | A | A | A | Inventive |
| 1-9 | A | A | A | Inventive |
| 1-10 | A | B | B | Inventive |
| 1-11 | A | A | B | Inventive |
| 1-12 | A | B | B | Inventive |
| 1-13 | A | B | A | Inventive |
| 1-14 | A | A | A | Inventive |
| 1-15 | A | A | A | Inventive |
| 1-16 | A | B | A | Inventive |
| 1-17 | A | B | A | Inventive |
| 1-18 | A | B | A | Inventive |
| 1-19 | A | A | A | Inventive |
| 1-20 | A | A | A | Inventive |
| 1-21 | A | A | A | Inventive |
| 1-22 | A | A | A | Inventive |
| 1-23 | A | A | A | Inventive |
| 1-24 | A | A | A | Inventive |
| 1-25 | A | A | B | Inventive |
| 1-26 | A | B | A | Inventive |
| 1-27 | A | A | A | Inventive |
| 1-28 | C | D | D | Comparative |
| 1-29 | C | D | C | Comparative |

The table shows that cellulose ester film master roll samples 1-1-1-27 containing any of the compounds of Formulas (1) (3) of the present invention are cellulose ester films wherein minimal horseback defects and core transfer are caused and deformation defects of the film master rolls such as winding initiation wrinkles tend not to occur.

### Example 2

Cellulose ester film master roll samples 2-1-2-12 of the present invention and comparative cellulose ester film master roll sample 2-13 were prepared in the same manner as for cellulose ester film master roll sample 1-1 of Example 1 except that the additives and the added amounts were changed to those listed in following Table 4.

TABLE 4

| Sam- | Additive 1 | | Additive 2 | | Additive 3 | | Additive 4 | | Additive 5 | | |
|---|---|---|---|---|---|---|---|---|---|---|---|
| ple | | Added | | Added | | Added | | Added | | Added | |
| No. | Type | Amount | Type | Amount | Type | Amount | Type | Amount | Type | Amount | Remarks |
| 2-1 | 2-1 | 1 | GTB | 10 | Irganox1010 | 1 | ADKSTABLA-52 | 0.25 | GSY-P101 | 0.5 | Inv. |
| 2-2 | 2-1 | 1 | GTB | 10 | Irganox1010 | 1 | Tinuvin-144 | 0.25 | GSY-P101 | 0.5 | Inv. |
| 2-3 | 1-1 | 1 | GTB | 10 | Irganox1010 | 1 | Tinuvin-144 | 0.25 | GSY-P101 | 0.5 | Inv. |
| 2-4 | 3-1 | 1 | GTB | 10 | Irganox1010 | 1 | ADKSTABLA-52 | 0.25 | IRGAFOSP-EPQ | 0.5 | Inv. |
| 2-5 | 3-9 | 1 | TMPTB | 10 | Irganox1010 | 1 | ADKSTABLA-63P | 0.25 | IRGAFOSP-EPQ | 0.5 | Inv. |
| 2-6 | 3-8 | 1 | TMPTB | 8 | Irganox1010 | 1 | ADKSTABLA-52 | 0.25 | IRGAFOSP-EPQ | 0.5 | Inv. |
| 2-7 | 1-2 | 1 | 48 | 12 | Irganox1010 | 1 | ADKSTABLA-63P | 0.25 | GSY-P101 | 0.5 | Inv. |
| 2-8 | 1-3 | 1 | 51 | 10 | SumilizerBP-76 | 1 | CHIMASSORB944LD | 0.25 | GSY-P101 | 0.5 | Inv. |
| 2-9 | 1-6 | 1 | 61 | 12 | Tinuvin120 | 1 | CHIMASSORB2020FDL | 0.25 | IRGAFOSP-EPQ | 0.5 | Inv. |
| 2-10 | 1-7 | 1 | 62 | 10 | SumilizerGA-80 | 1 | ADKSTABLA-63P | 0.25 | ADKSTABPEP-36 | 0.5 | Inv. |
| 2-11 | 2-2 | 1 | GTB | 10 | Irganox1010 | 1 | ADKSTABLA-52 | 0.25 | Sumilizer-GP | 0.5 | Inv. |
| 2-12 | 2-1 | 1 | TMPTB | 10 | Irganox1010 | 1 | Tinuvin-144 | 0.25 | IRGAFOSP-EPQ | 0.5 | Inv. |
| 2-13 | | | GTB | 10 | Irganox1010 | 1 | ADKSTABLA-52 | 0.25 | GSY-P101 | 0.5 | Comp. |

Inv.: Inventive, Comp.: Comparative

The prepared cellulose ester film master roll samples were evaluated in the same manner as in Example 1. The evaluated results are shown in Table 5.

TABLE 5

| | | | Winding | |
|---|---|---|---|---|
| Sample | Horseback | Core | Initiation | |
| No. | Defect | Transfer | Wrinkles | Remarks |
| 2-1 | A | A | A | Inventive |
| 2-2 | A | A | A | Inventive |
| 2-3 | A | B | A | Inventive |
| 2-4 | A | B | A | Inventive |
| 2-5 | A | B | A | Inventive |
| 2-6 | A | B | A | Inventive |
| 2-7 | A | B | A | Inventive |
| 2-8 | A | B | A | Inventive |
| 2-9 | A | A | A | Inventive |
| 2-10 | A | A | A | Inventive |
| 2-11 | A | A | A | Inventive |
| 2-12 | A | A | A | Inventive |
| 2-13 | C | D | C | Comparative |

The table shows that cellulose ester film master roll samples 2-1-2-12 containing any of the compounds of Formulas (1) (3) of the present invention together with a plasticizer and an antioxidant are cellulose ester films wherein minimal horseback defects and core transfer are caused even during long-term storage and deformation defects of the film master rolls such as winding initiation wrinkles tend not to occur.

### Example 3

Cellulose ester film master roll samples 3-1-3-6 of the present invention were prepared in the same manner as for cellulose ester film master roll sample 1-6 of Example 1 except that cellulose ester C-1 was exchanged to cellulose esters C-2-C-7, respectively.

The prepared cellulose ester film master roll samples were evaluated in the same manner as in Example 1. The evaluated results are shown in Table 6

TABLE 6

| | | | | Winding | |
|---|---|---|---|---|---|
| Sample | | Horseback | Core | Initiation | |
| No. | Cellulose Ester | Defect | Transfer | Wrinkles | Remarks |
| 3-1 | C-2 | A | A | A | Inventive |
| 3-2 | C-3 | A | B | B | Inventive |
| 3-3 | C-4 | A | B | B | Inventive |
| 3-4 | C-5 | A | A | A | Inventive |
| 3-5 | C-6 | A | B | A | Inventive |
| 3-6 | C-7 | A | B | A | Inventive |

The table shows that also in cellulose ester films with an acyl group substitution degree changed, cellulose ester film master roll samples 3-1-3-6 containing any of the compounds of Formulas (1) (3) of the present invention are cellulose ester films wherein minimal horseback defects and core transfer are caused even during long-term storage and deformation defects of the film master rolls such as winding initiation wrinkles tend not to occur.

### Example 4

The following composition was prepared.

(Antistatic Layer Coating Composition (1))

| | | |
|---|---|---|
| Polymethyl methacrylate (weight | 0.5 | part |
| average molecular | | |
| weight: 550000; Tg: 90° C.) | | |
| Propylene glycol monomethyl ether | 60 | parts |
| Methyl ethyl ketone | 16 | parts |
| Ethyl lactate | 5 | parts |
| Methanol | 8 | parts |
| Electrically conductive polymer resin P-1 | 0.5 | part |
| (0.1-0.3 μm particles) | | |

Electrically conductive polymer resin P-1

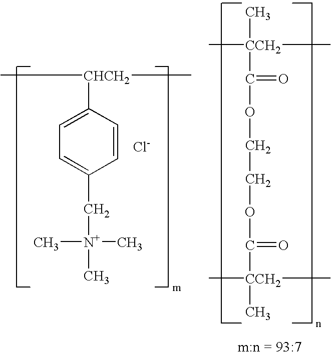

(Hard Coat Layer Coating Composition (2))

| | | |
|---|---|---|
| Dipentaerythritol hexaacrylate monomer | 60 | parts |
| Dipentaerythritol hexaacrylate dimer | 20 | parts |
| Components of at least a trimer of | 20 | parts |
| dipentaerythritol hexaacrylate | | |
| Diethoxybenzophenone radiation reaction initiator | 6 | parts |
| Silicone based surfactant | 1 | part |
| Propylene glycol monomethyl ether | 75 | parts |
| Methyl ethyl ketone | 75 | parts |

(Curl Preventive Layer Coating Composition (3))

| | | |
|---|---|---|
| Acetone | 35 | parts |
| Ethyl acetate | 45 | parts |
| Isopropyl alcohol | 5 | parts |
| Diacetyl cellulose | 0.5 | part |
| Acetone dispersion of 2% by mass of | 0.1 | part |
| ultrafine particle silica (AEOROSIL 200V, | | |
| produced by Nippon Aerosil Co., Ltd.) | | |

Polarizing plate protective films provided with functions were prepared in the following manner

### (Polarizing Plate Protective Film)

Cellulose ester film master roll sample 1-1, prepared in Example 1, was doublewrapped with a polyethylene sheet and stored in such a storage manner as shown in FIG. 8 under a condition of 25° C. and 50% RH for 30 days and further under a condition of 40° C. and 80% RH. Then, each of the polyethylene sheets was removed, and curl preventive layer coating composition (3) was gravure coated at a wet film thickness of 13 μm on one side of the cellulose ester film unwound form the master roll sample, followed by being dried at a drying temperature of 80±5° C. to obtain sample 1-1A.

Antistatic layer coating composition (1) was coated on the other side of this cellulose ester film under an ambience of 28° C. and 82% RH at a wet film thickness of 7 μm wherein the film conveyance rate was 30 m/minute and the coating width was 1 m. Subsequently, a resin layer of a dry film thickness of about 0.2 μm was provided by drying in a drying section set at 80±5° C. to obtain a cellulose ester film provided with an antistatic layer, which is designated as sample 1-1B.

Further, hard coat layer coating composition (2) was coated at a wet film thickness of 13 μm on this antistatic layer and dried at a drying temperature of 90° C., followed by exposure to ultraviolet radiation with 150 mJ/m², and then a clear hard coat layer of a dry film thickness of 5 μm was provided. The resulting film was designated as sample 1-1C.

Thus-obtained cellulose ester film samples 1-1A, 1-1B, and 1-1C of the present invention exhibited excellent coatability with neither brushing nor occurrence of cracks after drying.

Coating was carried out in the same manner as described above except that instead of cellulose ester film master roll sample 1-1, cellulose ester film master roll samples 1-6, 1-11, 1-17, 1-20, 1-21, 1-22, 2-1, 2-3, 2-4, 2-8, 2-12, and 3-1-3-6 were used. As a result, excellent coatability was confirmed with respect to any of these samples.

For comparison, comparative cellulose ester film master roll sample 1-29 was coated in the same manner as described above.

A sample prepared by coating curl preventive payer coating composition (3) was designated as sample 1-29A. And sample 1-29B was prepared via further coating of antistatic layer coating composition (1), and then sample 1-29C was prepared by further coating hard coat layer coating composition (2) on this antistatic layer.

As a result, brushing occurred in sample 1-29A in the case of coating under a high humidity ambience. Further, in sample 1-29B, minute cracks happened to be noted after drying, while in sample 1-29C, minute cracks were clearly noted after drying.

### (Preparation and Evaluation of Polarizing Plates)

A polyvinyl alcohol film of a thickness of 120 μm was immersed in a solution containing 1 part by mass of iodine, 2 parts by mass of potassium iodide, and 4 parts by mass of boric acid, and then stretched by a factor of 4 at 50° C. to prepare a polarizer.

Cellulose ester film master roll samples 1-6, 1-11, 1-17, 1-20, 1-21, 1-22, 2-1, 2-3, 2-4, 2-8, 2-12, and 3-1-3-6 of the present invention, as well as comparative cellulose ester film master roll sample 1-29, prepared in Examples 1-3, were double-wrapped with a polyethylene sheet and stored in such a storage manner as shown in FIG. 8 under a condition of 25° C. and 50% RH for 30 days and further under a condition of 40° C. and 80% RH. Thereafter, each of the polyethylene sheets was removed, and a cellulose ester film unwound from each of the master roll samples was alkali treated with a 2.5 mol/l sodium hydroxide of 40° C. for 60 seconds, and then washed and dried, followed by alkali treatment of the surface.

The alkali treated surface of samples 1-6, 1-11, 1-17, 1-20, 1-21, 1-22, 2-1, 2-3, 2-4, 2-8, 2-12, and 3-1-3-6 of the present invention, as well as comparative sample 1-29 were each bonded to both sides of the polarizer using an aqueous solution of 5% by mass of completely saponified polyvinyl alcohol as an adhesive to prepare protective film-formed polarizing plates 1-6, 1-11, 1-17, 1-20, 1-21, 1-22, 2-1, 2-3, 2-4, 2-8, 2-12, and 3-1-3-6 of the present invention, as well as comparative polarizing plate 1-29.

Each of thus-prepared polarizing plates 1-6, 1-11, 1-17, 1-20, 1-21, 1-22, 2-1, 2-3, 2-4, 2-8, 2-12, and 3-1-3-6 of the present invention has an extremely enhanced effect in that excellent characteristics of the polarizing plate is expressed, since both sides thereof are protected by a protective film exhibiting excellent flatness and physical properties, compared to comparative polarizing plate 1-29.

### (Characteristic Evaluation as a Liquid Crystal Display Device)

The polarizing plate was removed from 15-inch TFT type color liquid crystal display LAW1529HM (produced by NEC Corp.), and each of the prepared polarizing plates was cut out to fit the size of the liquid crystal cell. So as to sandwich the liquid crystal cell, 2 sheets of the prepared polarizing plate were bonded at right angles to each other so that the polarizing axis of the polarizing plate might not be changed from the original condition to prepare a 15-inch TFT type color liquid crystal display. Then, characteristics of each of the cellulose ester films for the polarizing plate were evaluated. As a result, polarizing plates 1-6, 1-11, 1-17, 1-20, 1-21, 1-22, 2-1, 2-3, 2-4, 2-8, 2-12, and 3-1-3-6 of the present invention exhibited enhanced contrast, as well as excellent display performance, compared to comparative polarizing plate 1-29, and were accordingly confirmed as excellent polarizing plates employable for image display devices such as liquid crystal display devices.

1-8. (canceled)

9. A method for manufacturing a polarizing plate protective film comprising steps of:
casting a melted composition so as to form a long cellulose ester film by a melt casting methods and
winding the long cellulose ester film to form a roll, wherein the melted composition contains a cellulose ester and at least one compound represented by any one of Formulas (1) to (3): 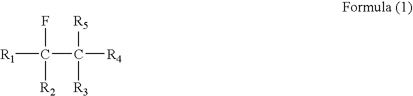
wherein R₁ to R₅ each represents a substituent, 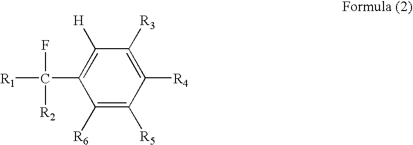
wherein R₁ to R₆ each represents a substituent, 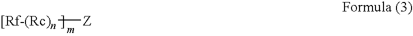
wherein Rf represents a perfluoroalkyl group□ Rc represents an alkylene group□ Z represents a nonionic polar group; and n represents 0 or 1, and m represents an integer of 1 to 3.

10. The method for manufacturing a polarizing plate protective film of claim 9, wherein at least one of the substituents represented by R₃ to R₅ in Formula (1) is a hydrogen atom.

11. The method for manufacturing a polarizing plate protective film of claim 9, wherein at least one of the substituents represented by R₁ to R₅ in Formula (1) and at least one of the substituents represented by R₃ to R₆ in Formula (2) is a hydroxy group or a substituent substituted by a hydroxy group.

12. The method for manufacturing a polarizing plate protective film of claim 9,
comprising steps of:
pressing the cellulose ester film extruded from a casting die during a melt casting film formation between an elastically deformable touch roll and a cooling roll, and
winding the cellulose ester film to form a roll.

13. A polarizing plate protective film produced by the method of claim 9.

14. A polarizing plate comprising the polarizing plate protective film of claim 5 on at least one side of a polarizer.

15. A method for manufacturing a polarizing plate, comprising a step of:
bonding the polarizing plate protective film of claim to a polarizer, by unwinding from a wound state.

16. A liquid crystal display device, wherein the polarizing plate of claim 14 is provided on at least one side of a liquid crystal cell.

17. A liquid crystal display device, wherein the polarizing plate produced by the method of claim 15 is provided on at least one of a liquid crystal cell.
